(19) United States
(12) Patent Application Publication
(10) Pub. No.: US 2026/0258858 A1
(43) Pub. Date: Sep. 3, 2026

(54) SLEW DRIVE SYSTEMS FOR ACTUATING SOLAR TRACKERS AND METHODS OF USE THEREOF

(71) Applicant: Kinematics, LLC, Phoenix, AZ (US)

(72) Inventors: Adam PLESNIAK, Huntington Beach, CA (US); Peter HRUBY, Scottsdale, AZ (US); Brandon LARSON, Lakewood, CA (US); Kenneth D. MILLER, Statesville, NC (US); Kyle ZECH, Phoenix, AZ (US); Mark HENDERSON, La Verne, CA (US)

(73) Assignee: Kinematics, LLC, Phoenix, AZ (US)

(21) Appl. No.: 19/654,453

(22) Filed: Apr. 22, 2026

Related U.S. Application Data
(63) Continuation-in-part of application No. 19/319,558, filed on Sep. 4, 2025.
Application No. 19/319,558 is a continuation-in-part of application No. 19/022,007, filed on Jan. 15, 2025, now abandoned.
Application No. 19/022,007 is a continuation of application No. 17/733,725, filed on Apr. 29, 2022, now Pat. No. 12,253,157.
(63) Continuation-in-part of application No. 17/402,365, filed on Aug. 13, 2021.
Application No. 17/402,365 is a continuation-in-part of application No. 17/344,806, filed on Jun. 10, 2021, now abandoned.
Application No. 17/344,806 is a continuation of application No. 16/133,375, filed on Sep. 17, 2018, now abandoned.
(60) Provisional application No. 62/565,513, filed on Sep. 29, 2017.
(60) Provisional application No. 63/182,400, filed on Apr. 30, 2021.

(51) Int. Cl. F16H 57/01; F16H 57/021; F16H 57/029; F16H 57/039

(52) U.S. Cl. CPC F16H 57/01; F16H 57/021; F16H 57/029; F16H 57/039; F16H 2057/012; F16H 2057/0213

(57) ABSTRACT

Disclosed herein are slew drive components, methods, and systems for rotational and axial load bearing. In some cases, slew drive systems disclosed herein can improve efficiency, accuracy, and/or reliability of solar tracking systems while reducing the cost and complexity of manufacture. For example, a slew drive system can comprise a threaded plug in addition to a worm gear, tapered roller bearings, and a worm wheel, allowing a significant reduction in material and labor costs of slew drive manufacture, which is important in the manufacture of expensive solar tracker system actuator assemblies.

### CROSS-REFERENCE

This application is a continuation-in-part of U.S. patent application Ser. No. 19/319,558, filed Sep. 4, 2025 (Attorney Docket No. 53079-705.501), which is a continuation-in-part of U.S. patent application Ser. No. 19/022,007, filed Jan. 15, 2025, (Attorney Docket No. 53079-705.301); which is a continuation application of U.S. patent application Ser. No. 17/733,725, filed Apr. 29, 2022, (Attorney Docket No. 53079-705.201), now U.S. Pat. No. 12,253,157, issued Mar. 18, 2025; which claims the benefit of U.S. Provisional Application No. 63/182,400, filed Apr. 30, 2021, (Attorney Docket No. 53079-705.101); this application is also a continuation-in-part of U.S. patent application Ser. No. 17/402,365, filed Aug. 13, 2021, (Attorney Docket No. 53079-704.501), which is a continuation-in-part of U.S. patent application Ser. No. 17/344,806, filed Jun. 10, 2021, (Attorney Docket No. 53079-704.301), which is a continuation of U.S. patent application Ser. No. 16/133,375, filed Sep. 17, 2018, (Attorney Docket No. 53079-704.201), which claims the benefit of U.S. Provisional Application No. 62/565,513, filed Sep. 29, 2017, (Attorney Docket No. 53079-704.101); all of which are hereby incorporated by reference in their entirety herein.

### BACKGROUND

A slew drive is a type of gearbox which can withstand axial and radial loads while transmitting torque to drive an external unit. Applications where a slew drive is utilized include solar trackers, wind turbines, lifts, and cranes, to name a few. Slew drives generally include a threaded shaft having a threaded section, commonly referred to as the worm gear and a geared wheel having teeth, commonly referred to as the worm wheel. The threaded section of the worm gear engages the teeth of the worm wheel thereby rotating the worm wheel. The worm gear rotates along its own axial axis at a rotational speed causing the worm wheel to rotate along its axial axis at a different rotational speed. The axes of rotation of the worm gear and worm wheel are, in general, perpendicular, although they can be at a different angle. Displacement of a worm gear in an axial direction relative to the worm gear can impact performance and safety of the slew drive. Therefore, it can be important to develop systems capable of precise measurement of axial worm gear displacement.

### SUMMARY

This application relates to improved slew drive devices and systems.

Provided herein is an actuation system comprising a solar tracker operably coupled to a slew drive. In some cases, the slew drive is configured to sustain a torque ranging from about 3.5 kN-m to about 40 kN-m without failing or overturning. In some cases, the slew drive comprises a threaded plug. In some cases, the slew drive comprises a housing comprising a first distal housing section and a second distal housing section. In some cases, the first distal housing section includes a threaded section operative to receive the threaded plug. In some cases, the second distal housing section includes an oil seal. In some cases, the slew drive comprises a worm gear comprising a central threaded section, a first distal shaft section including a first shoulder, and a second distal shaft section including a second shoulder. In some cases, the second distal shaft section comprises a bore with internal splines extending longitudinally along the bore. In some cases, the bore is disposed between the second shoulder and a distal end of the second distal shaft section. In some cases, the slew drive comprises a first bearing seated on the first distal shaft section and abutting the first shoulder and the threaded plug. In some cases, the slew drive comprises a second bearing seated on the second distal shaft section and abutting the second shoulder. In some cases, the slew drive comprises a worm wheel coupled to the solar tracker. In some cases, the worm wheel comprises worm wheel teeth operative to engage the central threaded section of the worm gear. In some cases, upon rotating the threaded plug in engagement with the threaded section, a compressive force is exerted upon the worm gear.

Disclosed herein is an actuation system comprising a slew drive that is configured to sustain a torque ranging from about 3.5 kN-m to about 40 kN-m without failing or overturning and further configured to be operably coupled to a component selected from the group consisting of a telecommunication dish, a radar dish, a solar array, and a solar tracker. In some cases, the slew drive comprises a threaded plug. In some cases, the slew drive comprises a housing comprising a first distal housing section and a second distal housing section. In some cases, the first distal housing section includes a threaded section operative to receive the threaded plug. In some cases, the second distal housing section includes an oil seal. In some cases, the slew drive comprises a worm gear comprising a central threaded section, a first distal shaft section including a first shoulder, and a second distal shaft section including a second shoulder. In some cases, the second distal shaft section comprises a bore with internal splines extending longitudinally along the bore. In some cases, the bore is disposed between the second shoulder and a distal end of the second distal shaft section. In some cases, the slew drive comprises a first bearing seated on the first distal shaft section and abutting the first shoulder and the threaded plug. In some cases, the slew drive comprises a second bearing seated on the second distal shaft section and abutting the second shoulder. In some cases, the slew drive comprises a worm wheel coupled to the component. In some cases, the worm wheel comprises worm wheel teeth operative to engage the central threaded section of the worm gear. In some cases, upon rotating the threaded plug in engagement with the threaded section, a compressive force is exerted upon the worm gear.

In some cases, the slew drive is configured to rotate the component at a speed of 0.05 degrees per second to 0.5 degrees per second. In some cases, the component has a weight ranging from 1 kg to 3,000 kg. In some cases, the component is rotated along a plane that is perpendicular to an axial axis of the worm gear. In some cases, at least one of the first bearing and the second bearing comprises one of a roller bearing or a ball bearing. In some cases, the roller bearing comprises one of a tapered roller bearing, a cylindrical roller bearing, a spherical roller bearing, and a needle roller bearing. In some cases, the ball bearing comprises one of a deep groove ball bearing, an angular ball bearing, and a thrust ball bearing. In some cases, the first bearing is seated on the first distal shaft section via one of a clearance fit, a transition fit, and an interference fit.

The system can further comprise at least one of thread lock and sealant applied on the threaded section of the first distal housing section. The system can further comprise a first wheel ball bearing disposed at a first axial end of the worm wheel. In some cases, the worm wheel comprises a first race of the first wheel ball bearing and the housing comprises a second race of the first wheel ball bearing. The system can further comprise a second wheel ball bearing disposed at a second axial end of the worm wheel. In some cases, the worm wheel comprises a first race of the second wheel ball bearing and the housing comprises a second race of the second wheel ball bearing.

In some cases, the first wheel ball bearing is disposed on a first side of the worm wheel and the second wheel ball bearing is disposed on a second side of the worm wheel. In some cases, the first wheel ball bearing comprises a grease shield.

In some cases, the housing comprises a hole configured to receive oil lubricant to lubricate the worm wheel and roller bearings. In some cases, the hole is located directly below the worm wheel and faces a same direction as a bore of the worm wheel.

In some cases, the second distal shaft section further comprises an interior hollow section adjacent to the bore with internal splines. In some cases, the bore with internal splines comprises a first opening extending to the interior hollow section and a second opening at a distal end of the second distal shaft section. In some cases, the internal splines of the bore do not extend into the interior hollow section.

In some cases, the slew drive is configured to support an axial load ranging from about 1 kN to about 30 kN. In some cases, the slew drive is configured to support an axial load greater than about 30 kN and sustain a tilting torque greater than about 3500 N-m. In some cases, one or more of the first bearing or the second bearing are configured to survive an overturning moment ranging from 13.5 kN-m to about 457.5 kN-m. In some cases, one or more of the first bearing or the second bearing have a raceway with a diameter ranging from about 187 mm to about 711 mm. In some cases, one or more of the first bearing or the second bearing have a survivability torque ranging from about 7 kN-m to about 180 kN-m. In some cases, the slew drive is configured to sustain a tilting torque ranging from about 500 N-m to about 3500 N-m.

Disclosed herein is a method comprising providing a slew drive. The slew drive can comprise a threaded plug. The slew drive can comprise a housing comprising a first distal housing section and a second distal housing section. In some cases, the first distal housing section includes a threaded section operative to receive the threaded plug, wherein the second distal housing section includes an oil seal. The slew drive can comprise a worm gear comprising a central threaded section, a first distal shaft section including a first shoulder, and a second distal shaft section including a second shoulder. In some cases, the second distal shaft section comprises a bore with internal splines extending longitudinally along the bore. In some cases, the bore is disposed between the second shoulder and a distal end of the second distal shaft section. The slew drive can comprise a first bearing seated on the first distal shaft section and abutting the first shoulder and the threaded plug. The slew drive can comprise a second bearing seated on the second distal shaft section and abutting the second shoulder. The slew drive can comprise a worm wheel comprising worm-wheel teeth operative to engage the central threaded section of the worm gear. In some cases, the slew drive is configured to sustain a torque ranging from about 3.5 kN-m to about 40 kN-m without failing or overturning. The method can comprise coupling the worm wheel of the slew drive to the component. The method can comprise rotating the threaded plug in engagement with the threaded section to thereby exert a compressive force upon the worm gear.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

A better understanding of the features and advantages of the present disclosure will be obtained by reference to the following detailed description that sets forth illustrative embodiments, in which the principles of the disclosure are utilized, and the accompanying drawings of which:

FIG. 1 shows an exploded view schematic of a slew drive system comprising a proximal end plate, in accordance with embodiments.

FIG. 2 shows a reverse view of the schematic of the slew drive system shown in FIG. 1, in accordance with embodiments.

FIG. 3 shows an exploded view schematic of a slew drive system comprising a plug, in accordance with embodiments.

FIG. 4 shows a reverse view of the schematic of the slew drive system shown in FIG. 3, in accordance with embodiments.

FIG. 5A shows a schematic of a slew drive system, in accordance with embodiments.

FIG. 5B shows a schematic of a slew drive system, in accordance with embodiments.

FIG. 5C shows a proximal end plate and distal end cap of a slew drive system, in accordance with embodiments.

FIG. 5D shows a schematic of an undeformed sensor of a slew drive system, in accordance with embodiments.

FIG. 5E shows a schematic of a slew drive sensor deflected by a worm interface pin, in accordance with embodiments.

FIG. 6A shows a schematic of a sensor carrier, in accordance with embodiments.

FIG. 6B shows a schematic of a sensor carrier, in accordance with embodiments.

FIG. 6C shows a schematic of a sensor carrier comprising a plurality of sensors, in accordance with embodiments.

FIG. 6D shows a schematic of a sensor carrier comprising a plurality of sensors, in accordance with embodiments.

FIG. 7A shows a schematic of a sensor carrier and a strain relationship for a sensor carrier, in accordance with embodiments.

FIG. 7B shows a schematic of a sensor carrier and a strain relationship for a sensor carrier, in accordance with embodiments.

FIG. 8 shows a sensor carrier comprising a plurality of sensors, in accordance with embodiments.

FIG. 9A shows a schematic of a proximal end plate and a sensor carrier, in accordance with embodiments.

FIG. 9B shows a schematic of a sensor carrier and a sensor carrier fastener, in accordance with embodiments.

FIG. 9C shows a schematic of a system comprising a worm gear, a worm gear interface pin, and a sensor carrier, in accordance with embodiments.

FIG. 10 shows a proximal end plate comprising a sensor and sensor carrier, in accordance with embodiments.

FIG. 11A shows a schematic of a plug comprising a sensor carrier, in accordance with embodiments.

FIG. 11B shows a schematic of a worm interface pin and a plug comprising a sensor carrier, in accordance with embodiments.

FIG. 12 shows loading of a sensor carrier, in accordance with embodiments.

FIG. 13A shows a schematic of a sensor deflection testing apparatus, in accordance with embodiments.

FIG. 13B shows an enlarged view of the sensor deflection testing apparatus, in accordance with embodiments.

FIG. 13C shows data illustrating a relationship between torque and deflection in a sensor carrier, in accordance with embodiments.

FIG. 14A shows data illustrating a relationship between applied torque and worm displacement in a slew drive system, in accordance with embodiments.

FIG. 14B shows data illustrating a relationship between applied torque and absolute worm displacement in a slew drive system, in accordance with embodiments.

FIG. 15A shows a slew drive torque testing rig, in accordance with embodiments.

FIG. 15B shows torque values detected by a slew drive system sensor, in accordance with embodiments.

FIG. 16 shows strain gauge sensor data and temperature data during oscillatory displacement testing, in accordance with embodiments.

FIG. 17 shows sensor data during oscillatory displacement testing, in accordance with embodiments.

FIG. 18A shows a worm interface pin of a slew drive system, in accordance with embodiments.

FIG. 18B shows a worm interface pin, in accordance with embodiments.

FIG. 18C shows a reverse view of the worm interface pin shown in FIG. 18B.

FIG. 18D shows a schematic of a worm interface pin, in accordance with embodiments.

FIG. 18E shows a schematic of a worm interface pin, in accordance with embodiments.

FIG. 18F shows a schematic of a worm interface pin and a worm gear, in accordance with embodiments.

FIG. 18G shows a graph of slew drive sensor data, in accordance with embodiments.

FIG. 18H shows a graph of slew drive sensor data, in accordance with embodiments.

FIG. 18-I shows a schematic of a worm gear interface pin and a worm gear end surface, in accordance with embodiments.

FIG. 18J shows a schematic of a worm gear end surface, in accordance with embodiments.

FIG. 19A shows a distal end of a worm interface pin, in accordance with embodiments.

FIG. 19B shows a proximal end of a worm interface pin, in accordance with embodiments.

FIG. 19C shows a distal end of worm interface pin, in accordance with embodiments.

FIG. 19D shows a proximal end of a worm interface pin, in accordance with embodiments.

FIG. 19E shows a sensor carrier and proximal end plate of a slew drive system, in accordance with embodiments.

FIG. 20A shows a worm and a worm interface pin of a slew drive system, in accordance with embodiments.

FIG. 20B shows a sensor and sensor carrier of a slew drive system, in accordance with embodiments.

FIG. 20C shows a sensor and sensor carrier of a slew drive system, in accordance with embodiments.

FIG. 21 shows a worm and a sensor carrier of a slew drive system, in accordance with embodiments.

FIG. 22A is a schematic showing a distal end cap comprising a seal and a controller, in accordance with embodiments.

FIG. 22B is a schematic showing a distal end cap comprising a seal, a controller, and a connector port, in accordance with embodiments.

FIG. 23A shows a proximal end plate and a distal end cap, in accordance with embodiments.

FIG. 23B shows a plug and a distal end cap, in accordance with embodiments.

FIG. 24A shows a schematic of a portion of a slew drive system with a sensor carrier coupled to an end wall of a worm shaft housing, in accordance with embodiments.

FIG. 24B shows a schematic of a portion of a slew drive system comprising a sensor carrier coupled to an end wall of a worm shaft housing, in accordance with embodiments.

FIG. 24C shows a schematic of a portion of a slew drive system comprising a sensor carrier coupled to an end wall of a worm shaft housing, in accordance with embodiments.

FIG. 25 shows a schematic of a worm gear interfacing with a sensor carrier, in accordance with embodiments.

FIG. 26 shows a schematic cutaway view of a housing of a slew drive system comprising a sensor carrier coupled to an end wall of a worm shaft housing, in accordance with embodiments.

FIG. 27A shows a schematic of a slew drive system comprising a protrusion cup, in accordance with embodiments.

FIG. 27B shows a schematic of a cross-sectional view of a portion of a slew drive system comprising a protrusion cup, in accordance with embodiments.

FIG. 27C shows a cross-sectional view of a section of a portion of a slew drive system comprising a protrusion cup, in accordance with embodiments.

FIG. 28 shows a schematic of a controller and a sensor carrier, in accordance with embodiments.

FIG. 29 shows a diagram of a controller, in accordance with embodiments.

FIG. 30 shows a diagram of electronics of a slew drive system, in accordance with embodiments.

FIGS. 31A-31C show left perspective (FIG. 31A), right perspective (FIG. 31B), and cross-sectional (FIG. 31C) front views of a slew drive with an end plate secured to the housing using one or more bolts, in accordance with example embodiments described herein.

FIGS. 32A-32B show front left perspective (FIG. 32A) and rear right perspective (FIG. 32B) views of an example slew drive in accordance with example embodiments described herein.

FIGS. 33A-33B show left perspective (FIG. 33A) and front (FIG. 33B) cross-sectional views of an example slew drive with a threaded plug in accordance with example embodiments described herein.

FIGS. 33C-33D show close up views of a bore with splines as shown in FIGS. 33A-33B in accordance with example embodiments described herein.

FIGS. 34A-34B show an exploded cross-sectional view (FIG. 34A) and a close-up view (FIG. 34B) of an example slew drive with a threaded plug in accordance with example embodiments described herein.

FIG. 35A shows a slew drive comprising a single ball bearing, in accordance with embodiments.

FIG. 35B shows a slew drive comprising a hole, in accordance with embodiments.

FIG. 36 shows a slew drive comprising a plurality of ball bearings, in accordance with embodiments.

FIG. 37 shows a ball bearing grease shield of a slew drive, in accordance with embodiments.

FIG. 38 shows a slew drive comprising dry bearings, in accordance with embodiments.

FIG. 39 shows drive efficiency of slew drives comprising SHC 100 grease or grade #0 synthetic grease during accelerate pendulum testing, in accordance with embodiments.

FIG. 40 shows slew drive tooth wear during accelerate pendulum testing in slew drives comprising SHC 100 grease or grade #0 synthetic grease, according to embodiments.

FIG. 41 shows a front view of an example location of a sensor on the rear side of a slew drive in accordance with example embodiments described herein.

FIGS. 42A-42B show perspective views of example enclosed sensors coupled to a slew drive in accordance with example embodiments described herein.

FIGS. 43A-43B show perspective (FIG. 43A) and front (FIG. 43B) views of an example sensor in a sensor carrier coupled to a slew drive in accordance with example embodiments described herein.

FIG. 44A shows an example graph of worm pin wobble in accordance with example embodiments described herein.

FIG. 44B shows an example graph of applying an example sensor via adhesion in accordance with example embodiments described herein.

FIG. 45 shows a graph plotting the relationship between torque and temperature recorded from an example slew drive in accordance with example embodiments described herein.

FIG. 46 shows a graph plotting the relationship between torque and temperature recorded from another example slew drive constructed in accordance with example embodiments described herein.

FIG. 47 shows a graph plotting the relationship between torque and temperature recorded from example slew drives equipped with a torque sensor in accordance with example embodiments described herein.

FIGS. 48A-48B show front view images of clockwise (FIG. 48A) and counterclockwise (FIG. 48B) finite elemental analyses (FEA) of the strain on the drive housing in the X-direction in accordance with example embodiments described herein.

FIGS. 48C-48D show front view images of clockwise (FIG. 48C) and counterclockwise (FIG. 48D) finite elemental analyses (FEA) of the strain on the drive housing in the Y-direction in accordance with example embodiments described herein.

FIGS. 49A-49B show images of the drive housing (FIG. 49A) and a finite elemental analysis (FEA) of the drive housing (FIG. 49B) in accordance with example embodiments described herein.

### DETAILED DESCRIPTION

Disclosed herein are improved slew drive systems and improved slew drive components. A slew drive can comprise bearings, seals, and other components which are secured within a housing. The housing can comprise two ends where two bearings, such as two tapered roller bearings, are positioned. In some cases, the worm gear is secured to the housing via the two bearings. The seals operate to maintain the lubricants within the housing. The housing of a conventional slew drive includes two end caps and a number of bolts, for example 4 on each side, in order to exert an axial compressive force on the worm gear which in turn exerts the axial force on the teeth of the work wheel. This configuration ensures improved engagement between the threads of the worm gear and the teeth of the worm wheel and reduces costs in material and labor. Specifically, the number of components used in the slew drive can be reduced thereby lowering the cost of material, and at the same time making the assembly of the slew drive easier and less labor intensive thereby lowering the cost of labor.

In some embodiments, improved control and precision of a slew drive system's motion, monitoring, and/or safety can be achieved by positioning a sensor carrier 1010 comprising one or more sensors 1013 such that displacement of a worm gear 1006 of the slew drive system 1000 causes compressive and/or tensile deformation the one or more sensors 1013, e.g., by deformation of a portion of the sensor carrier 1010.

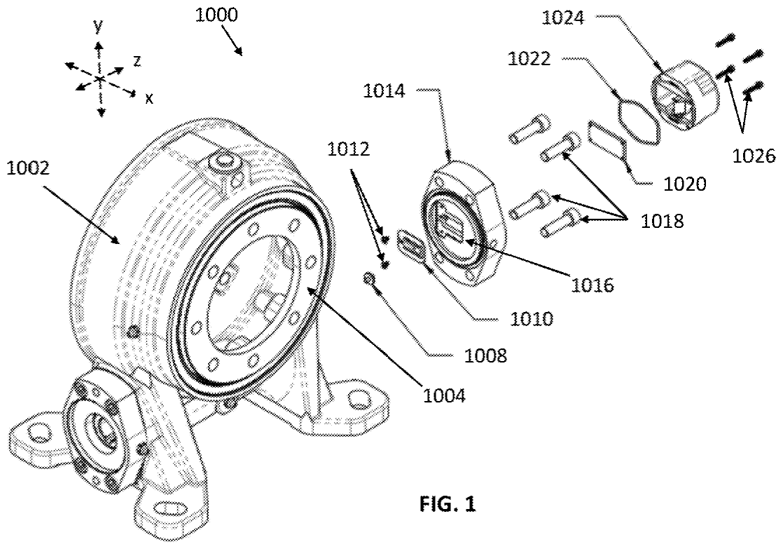

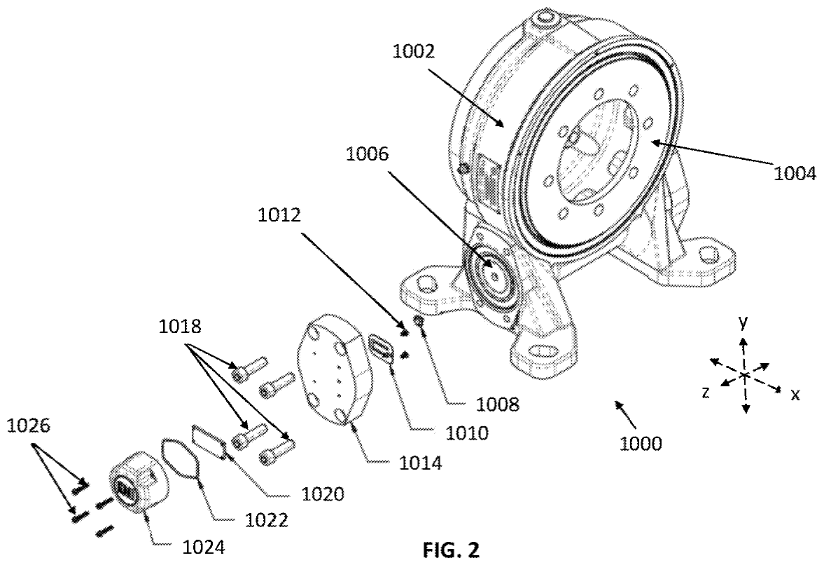

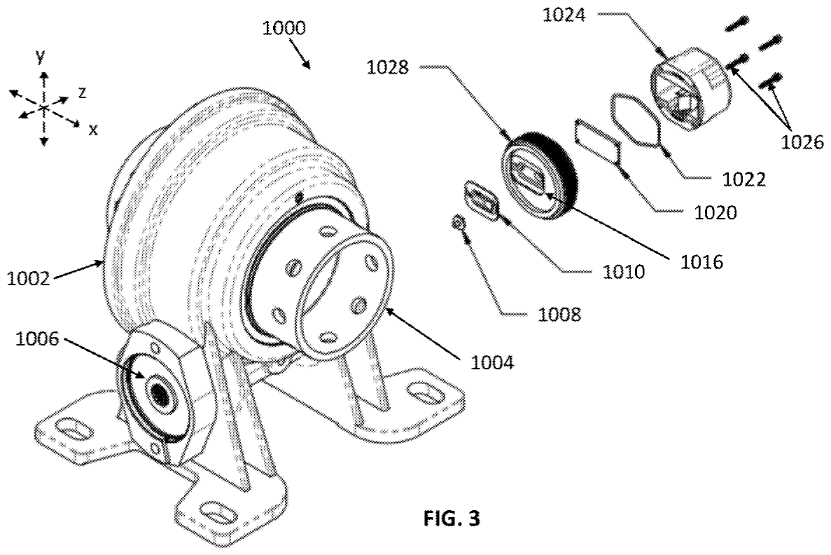

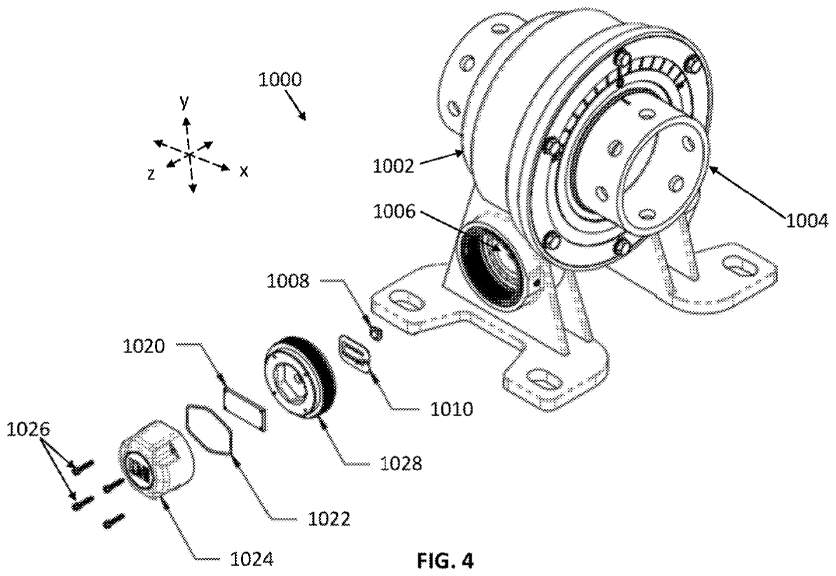

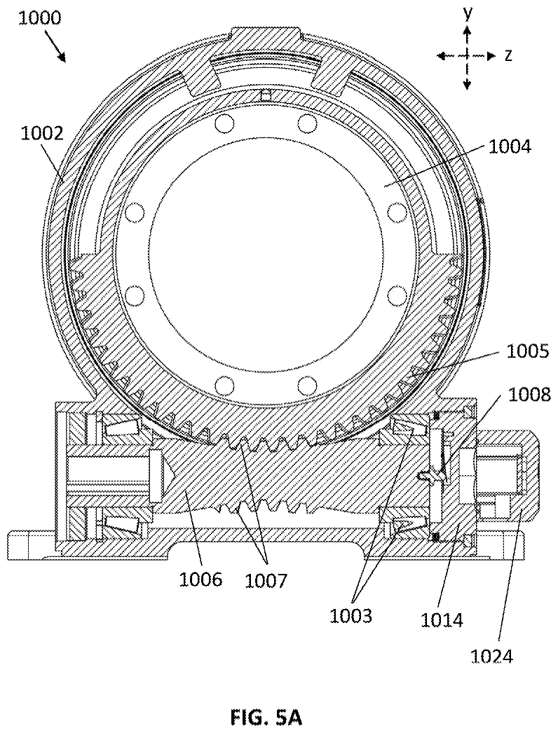

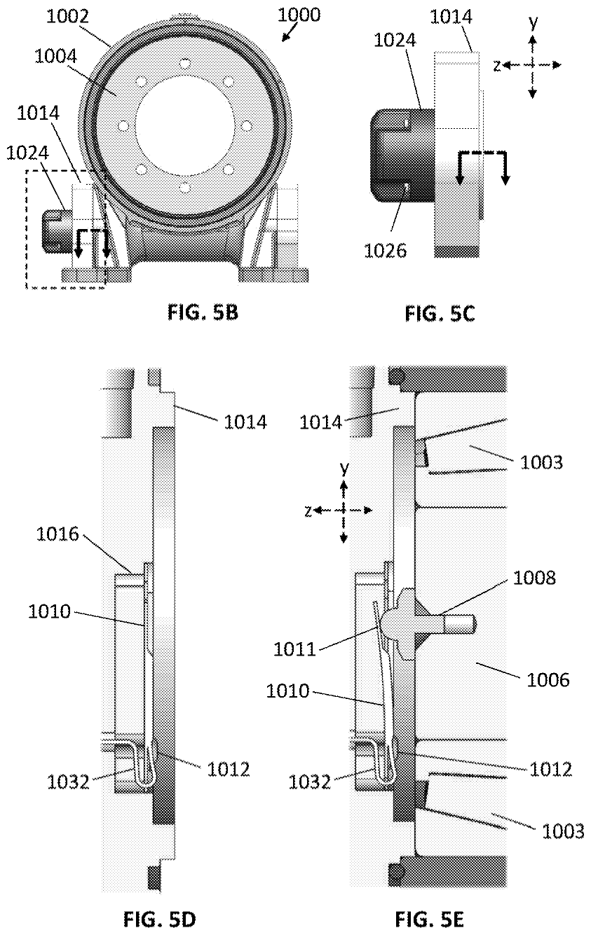

FIG. 1, FIG. 2, FIG. 3, and FIG. 4 show exploded views of slew drive systems 1000 from opposite angles. FIG. 1 shows a slew drive housing 1002 comprising a worm wheel 1004 and worm gear 1006. Worm wheel 1004 can interface with a worm gear 1006 via a mechanism capable of transmitting rotational force about a rotational axis of worm wheel 1004 (e.g., direction “x” as shown in FIGS. 1-2) to axial force along an axial direction of worm gear 1006 (e.g., direction “z” as shown in FIGS. 1-2). Such a mechanism can comprise gear threads (or teeth) disposed on an outer circumference of worm wheel 1004 contacting (e.g., engaging) threads disposed on a portion (e.g., a surface or edge) of worm gear 1006, for example, as shown in FIG. 5A. In some cases, rotation of worm wheel 1004 can cause a force (e.g., a torque) to be applied to a portion of worm gear 1006 (e.g., to gear threads or teeth disposed on the portion of worm gear 1006). In some cases, a force applied to worm gear 1006 (e.g., torque exerted upon worm gear 1006 by worm wheel 1004) can cause axial displacement of worm gear 1006 (e.g., along axial direction “z”).

A slew drive system 1000 can comprise one or more sensors 1013. In some cases, a slew drive system can comprise a plurality of sensors. One or more sensors 1013 of slew drive system 1000 can be used to measure the displacement of worm gear 1006 (e.g., displacement along axial direction “z”, for example, relative to slew drive housing 1002). In some cases, a strain gauge or a force sensor can be used to measure displacement of a worm gear 1006 (e.g., along axial direction “z”, e.g., relative to slew drive housing 1002), for example, as a result of torque applied to the worm gear 1006 by worm wheel 1004. Precise measurement of worm gear displacement (e.g., along axial direction “z”) can allow for improved precision in control of slew drive function (e.g., rotation of worm wheel 1004 about worm wheel axial direction “x” and/or displacement of worm gear 1006). Improved control of slew drive function can improve the precision and safety of the slew drive's operation.

A slew drive sensor 1013 can comprise a force sensor or a strain gauge sensor. In some cases, a slew drive system 1000 can comprise a plurality of sensors 1013. In some cases, a sensor 1013 of a slew drive system 1000 can be disposed on a sensor carrier 1010 of slew drive system 1000. A sensor carrier 1010 can aid in maintaining the position of a sensor 1013 (e.g., relative to a slew drive housing 1002 and/or a worm gear 1006 (e.g., serving as a means to couple one or more sensors 1013 to one or more of a sensor carrier mount 1016, a proximal end plate 1014, and/or a slew drive housing 1002).

A sensor carrier 1010 or a portion thereof can serve as a sensor measurement substrate. For example, a sensor 1013 may be configured (e.g., positioned or oriented on (or within) the sensor carrier 1010) to measure a deformation in the sensor carrier 1010. In some cases, deformation of a sensor 1013 may be mediated by a sensor carrier 1010 or a portion thereof. For example, a sensor carrier 1010 can comprise a deformation element 1011. In some cases, deformation of a deformation element 1011 of a sensor carrier 1013 can result from a worm gear 1006 or worm interface pin 1009 impinging on the sensor carrier or a portion thereof (e.g., as a result of displacement of the worm gear 1006 in an axial direction “z” of the worm gear). In some cases, deformation of a deformation element 1011 of a sensor carrier 1013 can be measured or detected by a sensor 1013 (e.g., a strain gauge sensor). In some embodiments, the magnitude and/or rate (e.g., over time) of a measured or detected deformation of a deformation element 1011 of a sensor carrier 1013 can be used to calculate a displacement of a worm gear 1006 (e.g., in an axial direction “z” of the worm gear) and/or a rotation or torque of a worm wheel 1004 (e.g., around an axial direction “x” of the worm wheel) with great precision. In some cases, deformation of a deformation element 1011 of a sensor carrier 1013 (e.g., as a result of a worm gear 1006 or worm interface pin 1009 impinging on the sensor carrier 1013 or a portion thereof) can cause the deformation element 1011 or a portion thereof to impinge upon a sensor 1013 (e.g., a force sensor), which may be coupled to the sensor carrier. In some cases, a deformation element 1011 or a portion thereof impinging upon a sensor 1013 (e.g., a force sensor) can facilitate measurement of worm gear 1006 displacement (e.g., relative to slew drive housing 1002).

A slew drive system 1000 can comprise a sensor carrier 1010. A sensor carrier 1010 can comprise one or more sensors 1013. In some cases, a sensor carrier 1010 can comprise a plurality of sensors 1013. For example, a sensor carrier 1010 can comprise 1, 2, 3, 4, 5, 6, 7, 8, 9, 10, 11-19, 20, 21-49, 50, or more than 50 sensors. In some cases, one or more sensors 1013 can be coupled to a sensor carrier by one or more fasteners. Fasteners can include a screw, a rivet, a grommet a hook, a threaded nut (and, optionally, a nut), a pin, a nail, a latch, a clamp, a staple, a strap or tie, a tape, a clamp, a button, a flange, a retainer such as a retaining ring, or a biasing element such as a clip. In some cases, one or more sensors 1013 can be coupled to a sensor carrier 1010 by an adhesive. Adhesives can include a glue, a cement, a putty, a paste, or an epoxy. In some cases, two or more components of a slew drive system can be coupled to one another by welding or soldering the components together.

A sensor carrier 1010 can comprise one or more force sensors 1013 and/or one or more strain gauge sensors 1013. In some cases, a slew drive sensor carrier 1010 comprises a strain gauge sensor. In some cases, a sensor 1013 comprising a force sensor comprises a piezoelectric load cell, an inductive load cell, or a capacitive load cell.

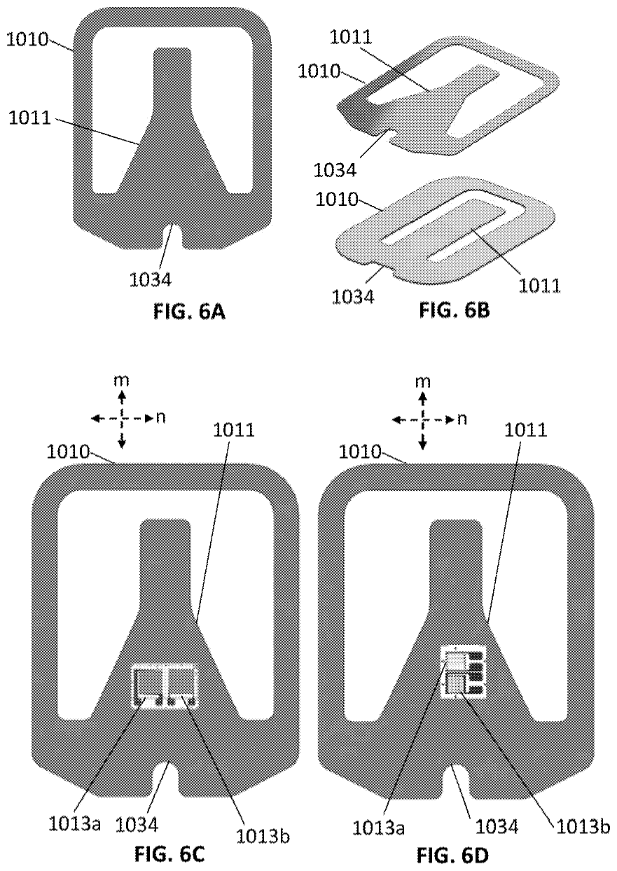

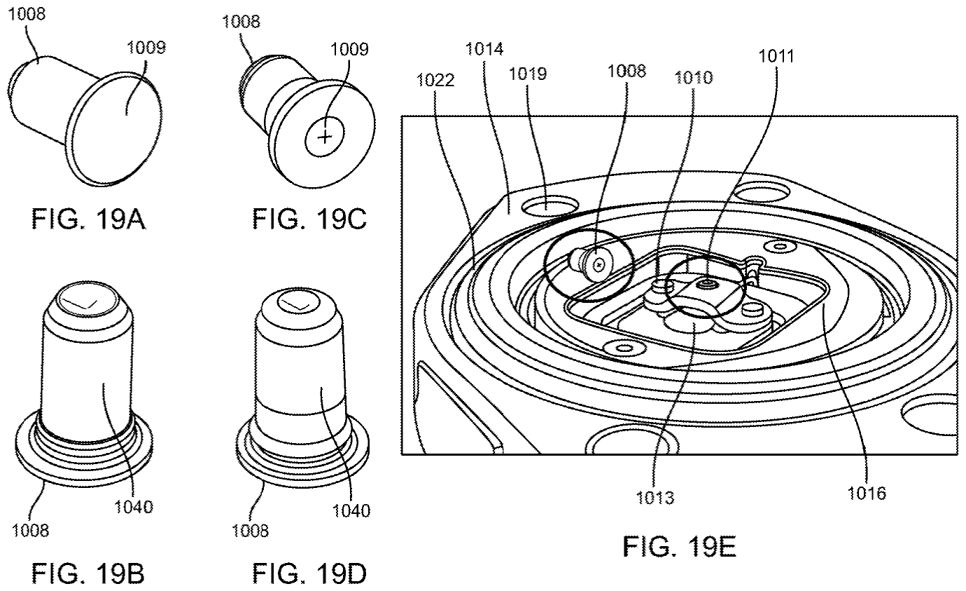

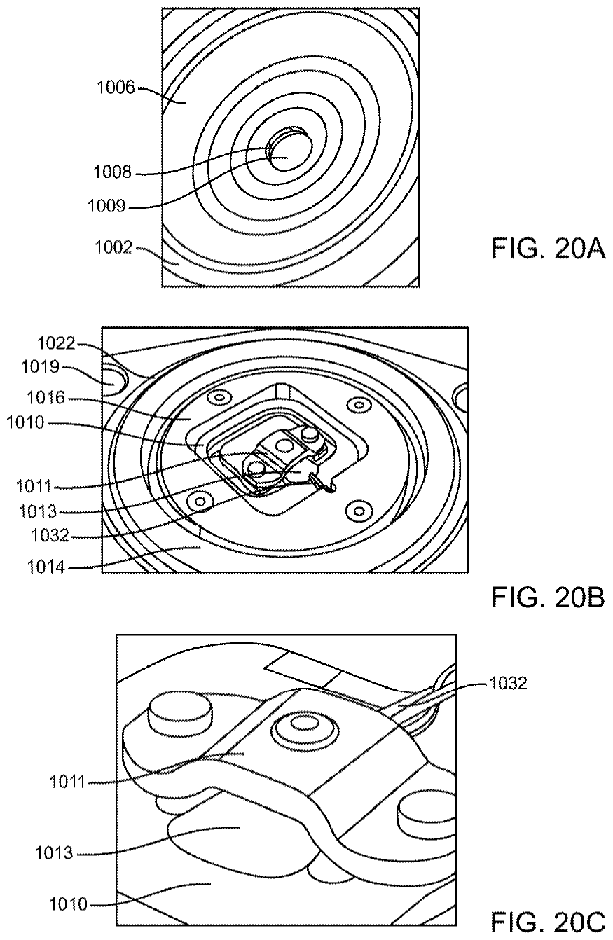

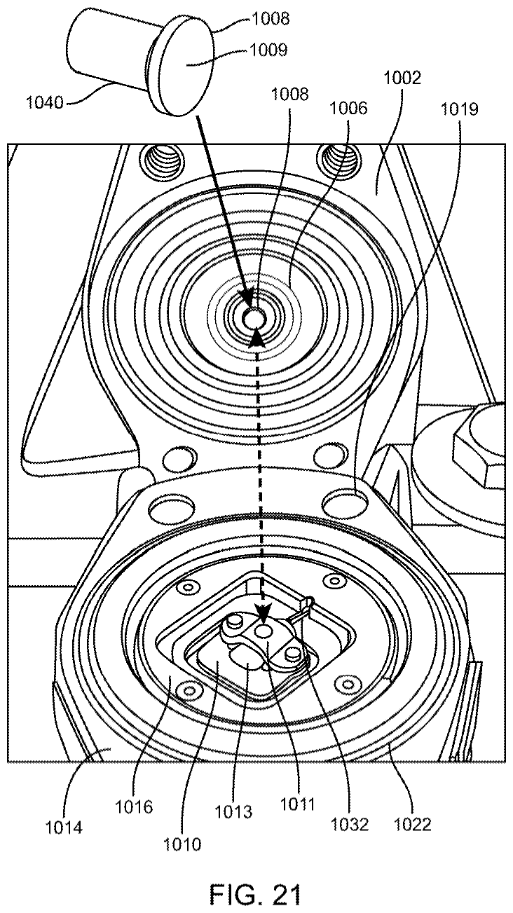

The location and/or orientation of a sensor 1013 relative to a sensor carrier 1010 (e.g., on which the sensor is disposed) and/or a slew gear 1006 of slew drive system 1000 can affect the performance of the sensor 1013. In many cases, one or more sensors 1013 of a slew drive system 1000 can be coupled to a sensor carrier 1010. For example, one or more sensors 1013 can be integrated into or affixed upon a sensor carrier 1010. In some cases, coupling one or more sensors 1013 to a sensor carrier 1010 can improve the positioning of the sensor 1013 in a slew drive system 1000 and/or the sensitivity of the sensor 1013 in measuring a displacement (e.g., axial displacement) of a worm gear 1006 in a slew drive system 1000. One or more sensors 1013 can be disposed in contact with a deformation element 1011 of a sensor carrier 1010. In some cases (e.g., wherein the one or more sensors 1013 comprises a strain gauge). In some cases, one or more sensors 1013 can be disposed on a surface of a deformation element 1011 of a sensor carrier 1010 (e.g., as shown in FIGS. 6C-6D). In some cases, a sensor 1013 (e.g., one or more force sensors 1013) can be disposed in line (e.g., along the same axial line) with a contact point such as a portion of worm gear 1006 or worm interface pin 1008 (e.g., wherein the worm gear 1006 or worm interface pin 1008 contacts a deformation element 1011 of sensor carrier 1010, which can contact sensor 1013, e.g., as shown in FIG. 19 and FIGS. 20A-20C). In some cases, a sensor 1013 (e.g., one or more strain gauge sensors 1013) are not disposed in line with (e.g., along the same axial line) a contact point such as a portion of worm gear 1006 or worm interface pin 1008 (e.g., wherein worm gear 1006 or worm interface pin 1008 contacts a deformation element 1011 of sensor carrier 1010, which can deform the sensor 1013 without impinging upon it, for example, by causing the sensor 1013 to stretch).

A sensor carrier 1010 (e.g., comprising one or more sensors 1013) can be in contact with (e.g., fastened to or affixed to) a proximal end plate 1014 or a plug 1028. In some cases, a proximal end plate 1014 or a plug 1028 can comprise a sensor carrier mount 1016. A sensor carrier mount 1016 (e.g., in concert with the proximal end plate 1014) can aid in maintaining the position of a sensor carrier 1010 (e.g., relative to a slew drive housing 1002 and/or a worm gear 1006 of slew drive system 1000, or a portion thereof). For example, a sensor carrier 1010 comprising one or more sensors 1013 can be coupled to a sensor carrier mount 1016 (e.g., via one or more sensor carrier fasteners 1012), which can in turn be coupled to a plug 1028 or a proximal end plate 1018, the plug 1028 or proximal end plate 1018 being coupled in some cases to a slew drive housing 1002 of the slew drive system 1000 (e.g., via proximal end cap fasteners 1018 and/or threading 1030). In some embodiments, a plug 1028 (or a portion thereof) or a proximal end plate 1014 (or a portion thereof) comprises a sensor carrier mount 1016. Maintaining the position of sensor carrier (e.g., relative to a slew drive housing 1002 and/or worm gear 1006) can improve the performance (e.g., precision and/or accuracy) of one or more sensors 1013 positioned on sensor carrier 1010. In some cases, a sensor 1013 (e.g., a temperature sensor 1048) of slew drive system 1000 can be disposed on controller 1020. In some cases, a sensor carrier mount 1016 can be coupled to (e.g., fastened to or affixed to) a proximal end plate 1014 or a plug 1028. A proximal end plate 1014 can be coupled to (e.g., fastened to or affixed to) a slew drive housing 1002 of a slew drive system 1000 (e.g., via proximal end plate fasteners 1018, which may be passed through proximal end plate fastener holes 1019 in the proximal end plate 1014). A plug 1028 can be coupled to a slew drive housing 1002, for example, via screw threading 1030 on the plug 1028, which may correspond to threading on the slew drive housing 1002.

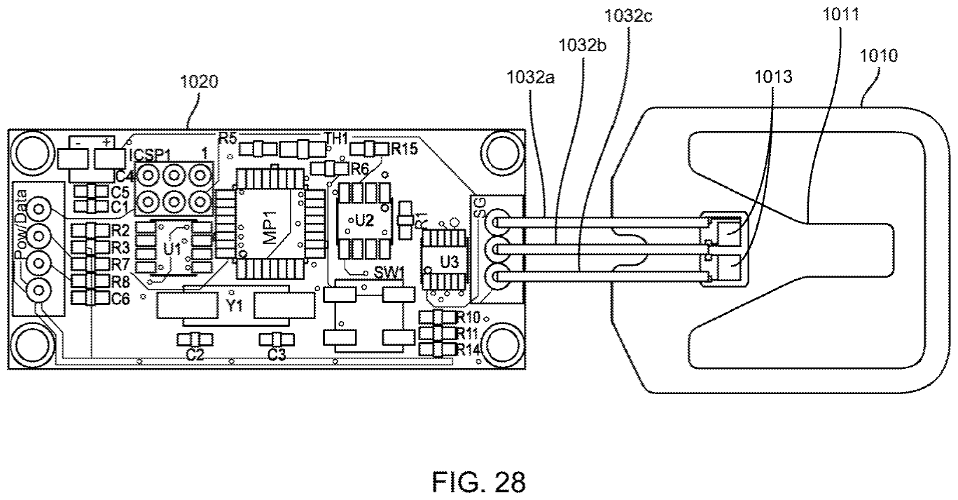

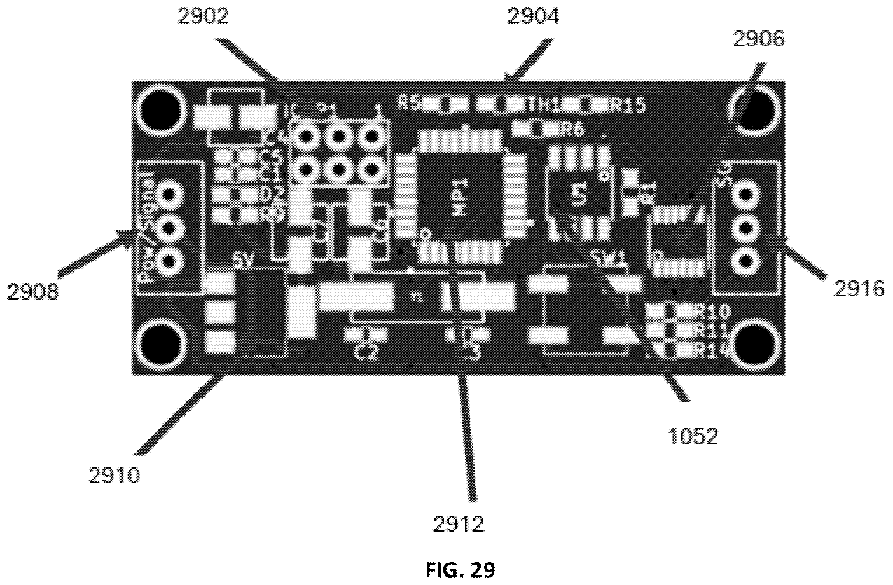

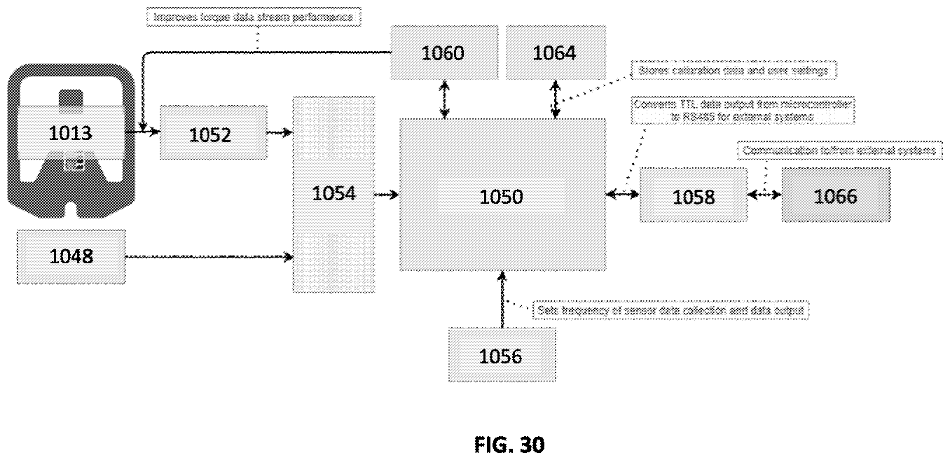

One or more signals from a sensor 1013 (e.g., a strain gauge sensor or a force sensor) of a slew drive system 1000 can be transmitted to a controller 1020 for processing and/or analysis. In some cases, one or more signals from a sensor 1013 are transmitted to a controller 1020 of a slew drive system 1000 via a wired connection 1032. In some cases, one or more signals from a sensor 1013 are transmitted to a controller 1020 of a slew drive system 1000 via a wireless connection 1032. In some cases, a controller 1020 (e.g., an “internal” controller) of a slew drive system 1000 is “on board” or “local” relative to one or more mechanical components of the slew drive mechanism (e.g., physically coupled to or affixed to one or more components within or directly coupled to the slew drive housing 1002 or any of the slew drive plates, plugs, or end caps). For example, a controller 1020 can be coupled to (e.g., fastened to) a distal end cap 1024 of the slew drive system 1000 (e.g., which can be coupled to one or more components of the slew drive system 1000, such as proximal end plate 1014 and/or slew drive housing 1002 by distal end cap fasteners 1026). In many cases, a seal 1022 (e.g., a rubber or plastic O-ring) is disposed between (e.g., sandwiched between) the distal end cap 1024 and a proximal end plate 1014 or between a distal end cap 1024 and a plug 1028, e.g., to prevent fluids (e.g., lubricants 1021) from contacting an “on-board” controller during or between uses of the slew drive system. In some cases, a controller 1020 (e.g., an external controller 1066) is “remote” relative to one or more mechanical components of the slew drive mechanism (e.g., not housed within (or in some cases coupled to) the slew drive housing 1002 or any of the slew drive plates, plugs, or end caps). For example, an external controller 1020 can be wirelessly connected to one or more “on board” or “local” sensors 1013 of the slew drive system. In some cases, an “on board” controller 1020 can be connected (e.g., via a wired or wireless connection) to an external controller 1066 (e.g., as illustrated in FIG. 28, FIG. 29, and FIG. 30)

Turning to FIG. 5A, a slew drive system 1000 can comprise a worm wheel 1004 and a worm gear 1006 housed inside of a slew drive housing 1002. A slew drive system 1000 can further include bearings, seals, and other components which can be secured within slew drive housing 1002. The slew drive housing 1002 can include a shaft, which can comprise one or more housing bearings 1003 (e.g., a pair of tapered roller bearings 1003) at either end. A worm gear 1006 can be secured to the slew drive housing 1002 via housing bearings 1003. A slew drive system 1000 can comprise one or more seals 1022, which can operate to maintain the lubricants within the housing 1002. A seal 1022 can comprise neoprene, fluorinated ethylene, fluorinated ethylene-propylene (FEP), fluorosilicone (FVMQ), polytetrafluoroethylene (PTFE), carboxylated nitrile, hydrogenated nitrile (HNBR), highly saturated nitrile (HSN), or polyacrylate (ACM). A slew drive system 1000 can comprise one or more end plates and/or end caps (e.g., proximal end plates 1014 or distal end caps 1024) and a plurality of end plate and/or end cap fasteners, such as bolts (e.g., four distal end cap fasteners per distal end cap). In some cases, fastening one or more proximal end plates 1014 and/or one or more distal end caps 1024 to a slew drive housing 1002 can exert an axial compressive force on the worm gear 1006 which in turn can exert a force on the teeth 1005 of the work wheel. In some cases, this configuration can improve engagement between the threads 1007 (or teeth) of the worm gear and the teeth 1005 of the worm wheel 1004.

FIG. 5B shows an external view of a slew drive system 1000 comprising a worm wheel 1004 and a slew drive housing 1002, wherein the slew drive housing 1002 is coupled to a proximal end plate 1014 and a distal end cap 1024 is coupled to the proximal end plate 1014. FIG. 5C shows a distal end cap 1024 coupled to a proximal end plate 1014 by a plurality of distal end cap fasteners 1026 (e.g., wherein the distal end cap fasteners 1026 are bolts), for example, such as a proximal end plate 1014 and a distal end cap 1024 as indicated by the dotted box of FIG. 5B that have been unfastened from the slew drive housing 1002. FIG. 5D shows a cross-sectional view of a proximal end plate 1014, e.g., along the cross-sectional cut indicated by the dotted line and arrows shown in FIGS. 5B and 5C. In some cases, a proximal end plate 1014 comprises a sensor carrier mount 1016, which can be coupled to a sensor carrier 1010 by one or more sensor carrier fasteners 1012. A sensor carrier 1010 can comprise (or be coupled to) one or more sensors 1013, which can be connected to (e.g., in communication with) a controller 1020 by wiring 1032. FIG. 5E shows a cross-section as shown in FIG. 5D, wherein the proximal end plate 1014 is coupled to a slew drive housing 1002 of a slew drive system 1000. As shown in FIG. 5E, a worm interface pin 1008 can impinge upon a portion of the sensor carrier 1010 (e.g., a deformation element 1011 of the sensor carrier 1010), for example, as a result of axial force in the “z” direction exerted by worm gear 1006 on worm interface pin 1008. In some cases, deformation of deformation element 1011 (e.g., as a result of axial force in the “z” direction exerted by worm interface pin 1008 on deformation element 1011) can be detected and/or measured by a sensor 1013 coupled to (e.g., fastened to or affixed to) sensor carrier 1010 and communicated to a controller 1020 via wiring 1032. In some cases, worm gear 1006 dimensions, worm interface pin 1008 dimensions, sensor carrier 1010 dimensions, and/or tensioning of proximal end plate fasteners can be adjusted such that a non-zero force (and, optionally, a non-zero deflection or deformation) is applied to sensor carrier 1010 or a portion thereof (e.g., to a deformation element 1011 of sensor carrier 1011), e.g., when the system is at rest. In some cases, adjusting such parameters of the system to achieve a non-zero force (and, optionally, a non-zero deflection or deformation) to a portion of sensor carrier 1010 can increase the sensitivity and/or dynamic range of sensor measurements.

FIG. 6A and FIG. 6B show sensor carriers 1010 comprising a deformation element 1011. In some cases, a portion of a deformation element can deform or displace, for example, as a result of impingement of one or more objects (e.g., a worm gear 1006 or a worm interface pin 1008) on the deformation element 1011). In some cases, deformation and/or displacement of a deformation element 1011 of a sensor carrier 1010 can cause a change (e.g., in a strain or force) experienced by one or more sensors (e.g., which may be coupled to the sensor carrier 1010, for instance at the deformation element 1011). In some cases, a deformation element 1011 (e.g., a cantilevered deformation element 1011) can comprise a cantilevered portion of a sensor carrier frame. In some cases, a cantilevered portion of a sensor carrier 1010 can be configured to deform and/or displace (e.g., elastically) in a predictable manner when subjected to a force from another object (e.g., a worm gear 1006 or worm interface pin 1008, which may impinge upon the deformation element, for instance, at a cantilevered portion of the deformation element). In some cases, a sensor carrier can comprise one or more sensor carrier notches 1034. In some cases, a sensor carrier notch 1034 can be used as a location for a fastener (e.g., a clip or flange of a screw head or bolt) to couple a sensor carrier 1010 to another structure (e.g., a sensor carrier mount or proximal end plate 1014) of a slew drive system 1000. In some cases, wiring 1032 coupled to one or more sensors 1013 can pass through a sensor carrier notch (and, optionally, through a sensor carrier mount and/or a proximal end plate 1014), for example, to decrease the length of wiring required to connect the sensor(s) 1013 to the controller 1020 and/or to decrease any impact the thickness of the wiring might have on the clearance or force between the sensor carrier 1010 and/or proximal end plate 1014 and the worm gear 1006 and/or the slew drive housing 1002.

FIG. 6C and FIG. 6D show sensor carriers 1010 comprising a plurality of strain gauge sensors (1013a and 1013b) coupled to a surface of the sensor carriers 1010. In some cases, one or more of the sensors of a system or device described herein can be a linear strain gauge sensor (1013a, 1013b). FIG. 6C shows sensors 1013a and 1013b disposed at the same position in direction “m” along the deformation element 1011 of the sensor carrier 1010. FIG. 6D shows a first sensor 1013a disposed further up a cantilevered deformation element 1011 than a second sensor 1013b. In FIG. 6D, the sensors 1013a and 1013b are depicted at the same lateral position along direction “n”. In some cases, a first sensor (e.g., strain gauge 1013a in FIG. 6D) can be oriented such that a directionality of sensor sensitivity (e.g., strain measurement direction) is at an angle (e.g., perpendicular to) a directionality of sensor sensitivity of a second sensor (e.g., strain gauge 1013b in FIG. 6D). In some cases, orienting a first sensor at an angle relative to a second sensor on a sensor carrier 1010 can allow for measurement of deformation in the deformation element 1011 (e.g., via a sensor oriented such that its directionality of sensor sensitivity is in line with an expected direction of deformation of the deformation element 1011, such as an expected bending of a cantilevered deformation element in direction “m”) and measurement of deformation of the sensor carrier 1010 or a portion thereof which may result from causes other than deformation induced by worm gear displacement, such as sensor carrier material expansion or contraction, e.g., due to changes in temperature. In some cases, a sensor carrier can comprise aluminum. In some cases, a sensor carrier material can have a thermal expansion of about 11 μm/m-° C. (micrometer per meter degree Celsius). In some cases, orienting a first sensor at an angle relative to a second sensor on a sensor carrier 1010 can allow for measurement of deformation in the deformation element 1011 in a first direction (e.g., via a sensor oriented such that its directionality of sensor sensitivity is in line with a first expected direction of deformation of the deformation element 1011, such as an expected bending of a cantilevered deformation element in direction “m”) and measurement of deformation of the sensor carrier 1010 or a portion thereof which may result from deformation in a second direction (e.g., via a sensor oriented such that its directionality of sensor sensitivity is not parallel to the first expected direction of deformation of the deformation element 1011). Such biaxial deformation measurement can be advantageous in determining whether one or more components of the system (e.g., a sensor 1013, sensor carrier 1010, worm interface pin 1008, or worm gear 1006) are properly aligned (e.g., during initial assembly and calibration) or have gone out of alignment (e.g., during use).

In some cases, a cross-sectional thickness of a sensor carrier 1010 or portion thereof (e.g., a deformation element 1011) is constant. A constant cross-sectional thickness in a sensor carrier 1010 (or a portion thereof) can simplify correction calculations for processing sensor 1013 signals. For example, deformation in a sensor carrier 1010 due to temperature changes may be easier to calculate and correct for in a sensor carrier 1010 having a constant cross-sectional thickness. In some cases, a cross-sectional thickness of a sensor carrier 1010 is not constant.

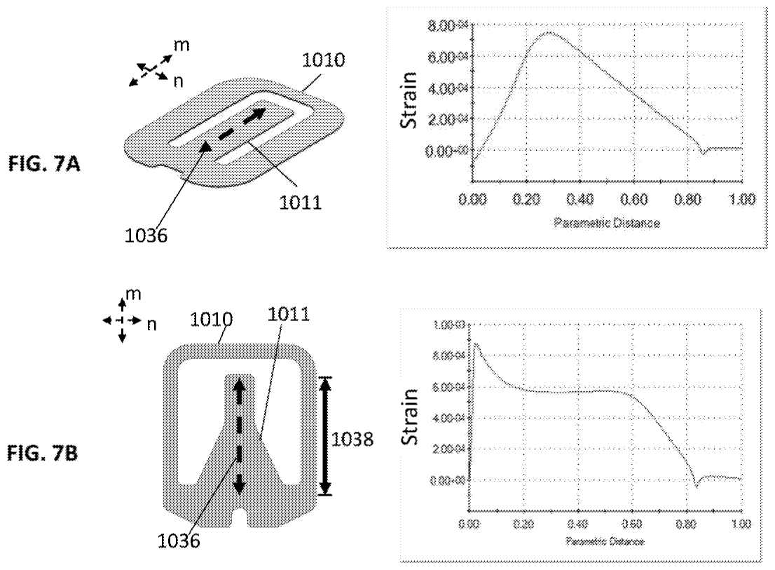

In some cases, a width of all or a portion of a sensor carrier 1010 is constant. For example, a width of a deformation element 1011 of a sensor carrier 1010 (e.g., in an “n” direction, as shown in FIG. 7A) may remain constant over the entirety of the length of the deformation element 1011 (e.g., in an “m” direction, as shown in FIG. 7A). In some cases, a width of all or a portion of a sensor carrier 1010 is not constant. For example, a width of a deformation element 1011 of a sensor carrier 1010 (e.g., in an “n” direction, as shown in FIG. 7B) may increase or decrease in width (e.g., in an “m” direction, as shown in FIG. 7B) over all or a portion of the length of the deformation element 1011. In some cases, a region of minimal strain difference due to deformation of a deformation element 1011 (e.g., bending in a cantilevered deformation element) can be created when width of the deformation element decreases over a portion of the deformation element (see plateau region in strain curve over parameterized distance 1038 for a centerline length 1036 of the cantilevered deformation element in FIG. 7B; compare to FIG. 7A). Placement of one or more sensors 1013 (e.g., strain gauge sensors) in or on a region of minimal strain difference in a deformation element (e.g., as formed by geometry of the deformation element) can be advantageous, for example, because strain of the deformation element remains constant or approximately constant over the region in which or on which the one or more sensors are placed, which can reduce the impact of sensor placement (e.g., on or near a deformation element) on sensor accuracy. In some cases, the formation of a region of minimal strain difference along a length and/or width of a deformation element 1011 (e.g., by controlling changes to one or more dimensions of the deformation element) can help to distribute stresses in the material of the deformation element, which can aid in mitigation of stresses on the carrier material (e.g., which can lead to failure of the material, such as fracture or plastic deformation) while allowing larger deformations (e.g., deflections) of the deformation element (e.g., which can increase sensitivity and/or dynamic range of the measurement system). This utilization of a sensor carrier 1010 and/or deformation element 1011 having a geometry and thickness that creates a minimal strain region can improve elastic deformation of the material without yield and can decrease fatigue failure of the sensor carrier and/or deformation element throughout the life of the component. In some cases, a thickness of a sensor carrier 1010 or portion thereof can be 0.10 mm to 0.40 mm. In some cases, a thickness of a sensor carrier 1010 or portion thereof can be 0.10 mm to 0.13 mm, 0.10 mm to 0.15 mm, 0.10 mm to 0.17 mm, 0.10 mm to 0.20 mm, 0.10 mm to 0.23 mm, 0.10 mm to 0.27 mm, 0.10 mm to 0.30 mm, 0.10 mm to 0.35 mm, 0.10 mm to 0.40 mm, 0.13 mm to 0.15 mm, 0.13 mm to 0.17 mm, 0.13 mm to 0.20 mm, 0.13 mm to 0.23 mm, 0.13 mm to 0.27 mm, 0.13 mm to 0.30 mm, 0.13 mm to 0.35 mm, 0.13 mm to 0.40 mm, 0.15 mm to 0.17 mm, 0.15 mm to 0.20 mm, 0.15 mm to 0.23 mm, 0.15 mm to 0.27 mm, 0.15 mm to 0.3 mm, 0.15 mm to 0.35 mm, 0.15 mm to 0.4 mm, 0.17 mm to 0.20 mm, 0.17 mm to 0.23 mm, 0.17 mm to 0.27 mm, 0.17 mm to 0.3 mm, 0.17 mm to 0.35 mm, 0.17 mm to 0.40 mm, 0.20 mm to 0.23 mm, 0.20 mm to 0.27 mm, 0.20 mm to 0.30 mm, 0.20 mm to 0.35 mm, 0.20 mm to 0.40 mm, 0.23 mm to 0.27 mm, 0.23 mm to 0.3 mm, 0.23 mm to 0.35 mm, 0.23 mm to 0.40 mm, 0.27 mm to 0.3 mm, 0.27 mm to 0.35 mm, 0.27 mm to 0.40 mm, 0.30 mm to 0.35 mm, 0.30 mm to 0.40 mm, or 0.35 mm to 0.40 mm. In some cases, a thickness of a sensor carrier 1010 or portion thereof can be 0.10 mm, 0.13 mm, 0.15 mm, 0.17 mm, 0.20 mm, 0.23 mm, 0.27 mm, 0.3 mm, 0.35 mm, or 0.40 mm. In some cases, a thickness of a sensor carrier 1010 or portion thereof can be at least 0.1 mm, 0.13 mm, 0.15 mm, 0.17 mm, 0.20 mm, 0.23 mm, 0.27 mm, 0.30 mm, 0.35 mm, or 0.40 mm. In some cases, a thickness of a sensor carrier 1010 or portion thereof can be at most 0.10 mm, 0.13 mm, 0.15 mm, 0.17 mm, 0.20 mm, 0.23 mm, 0.27 mm, 0.30 mm, 0.35 mm, or 0.40 mm. In some cases, a sensor carrier 1010 and/or a deformation element 1011 can comprise a metal, such as aluminum or steel. In some cases, a sensor carrier 1010 and/or a deformation 1011 can be formed by stamping sheet stock.

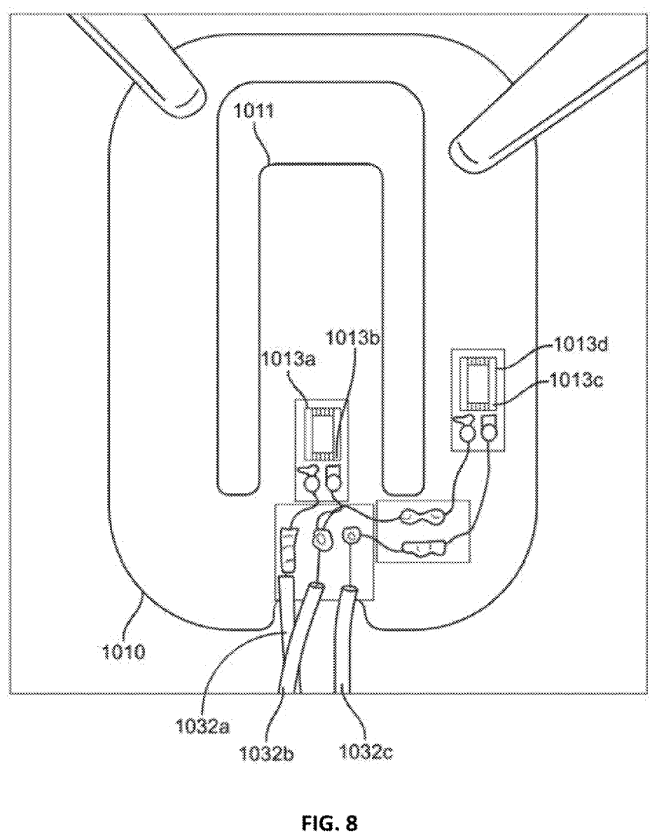

In some cases, one or more sensors (e.g., 1013a and 1013b, as shown in FIG. 8) can be coupled to a deformation element 1011 of a sensor carrier 1010. Optionally, one or more additional sensors (e.g., 1013c and 1013d, as shown in FIG. 8) can be coupled to the frame of the sensor carrier 1010, for instance, to serve as control measurement devices for one or more sensors positioned on the deformation element 1011 of the sensor carrier 1010. Wiring 1032 can be coupled to one or more sensors 1013 on a sensor carrier 1010. For example, one or more wires (e.g., wire(s) 1032b, as shown in FIG. 8, which can be used for transmitting sensor data) can provide electrical communication between one or more sensors 1013 (e.g., 1013a, 1013b, 1013c, and/or 1013d) and one or more controllers 1020. In some cases, wiring connected to one or more sensors 1013 on a sensor carrier 1010 can comprise a ground wire 1032c. In some cases, wiring connected to one or more sensors 1013 (e.g., 1013a, 1013b, 1013c, and/or 1013d) on a sensor carrier 1010 can comprise a wire for providing electrical current or voltage to the one or more sensors 1013 (e.g., wire 1032a, as shown in FIG. 8, which can be used to provide a voltage (for example a direct current (DC) voltage) of, for example, +5 volts DC, +7 volts DC, from +0.5 to +5 volts DC, or greater than +5 volts DC).

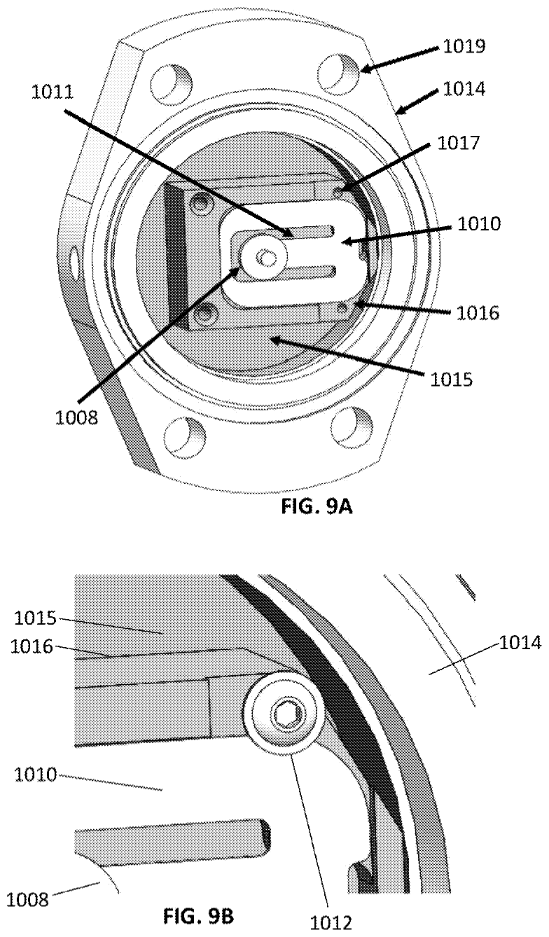

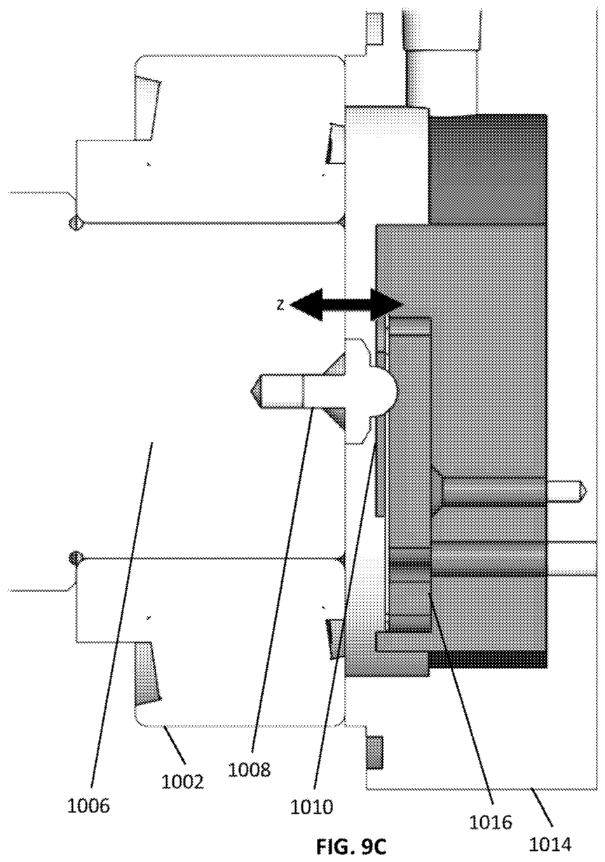

FIG. 9A shows a proximal end plate 1014 comprising a sensor carrier mount 1016 having sensor carrier mount holes 1017 and a sensor carrier 1010 mounted on the sensor carrier mount 1016. A worm interface pin 1008 is depicted in contact with a deformation element 1011 of the sensor carrier 1010. The proximal end plate 1014 shown in FIG. 9A comprises a machined surface 1015 and proximal end plate fastener holes 1019. FIG. 9B shows an enlarged view of FIG. 9A, wherein a sensor carrier fastener 1012 is shown coupling sensor carrier 1010 to sensor carrier mount 1016. In some embodiments, a worm gear 1006 can positively or negatively displace along an axial direction “z” during use of a slew drive system 1000 and cause worm interface pin 1008 to increase or decrease pressure exerted on sensor carrier 1010 (or a portion thereof, such as deformation element 1011), for example, due to sensor carrier 1010 being securely coupled to sensor carrier mount 1016 and sensor carrier mount 1016 being securely coupled to slew drive housing 1002, e.g., as shown in FIG. 9C.

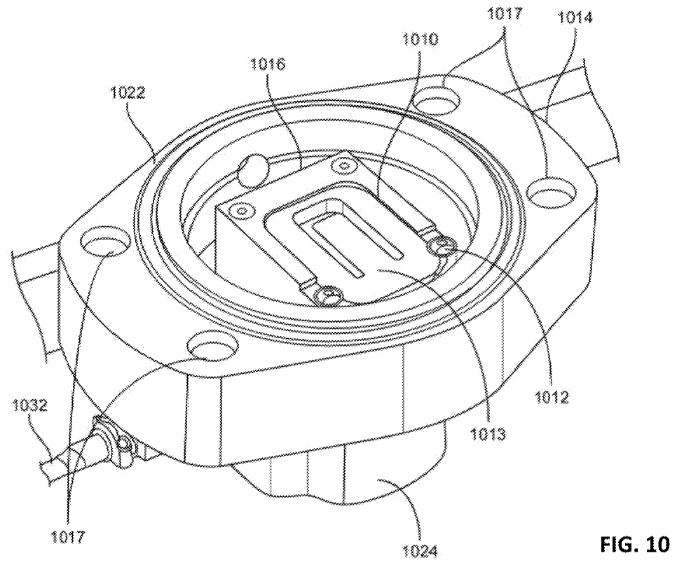

FIG. 10A shows an image of a proximal end plate 1014 comprising a sensor carrier mount 1016 coupled to a sensor carrier 1010 comprising a sensor 1013 via sensor carrier mount fasteners 1012. Wiring 1032 used to communicate data measured by sensor 1013 can pass through a connector port (e.g., a side connector port) in proximal end plate 1014, a connector port (e.g., a side connector port) in distal end cap 1024, or a gap between proximal end plate 1014 and distal end plate 1024. Proximal end plate fastener holes 1017 can be used to couple the assembly to slew drive housing 1002.

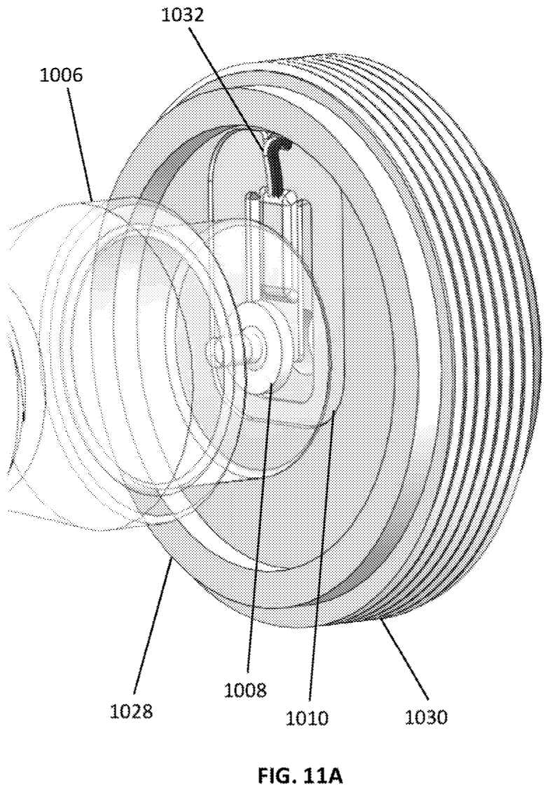

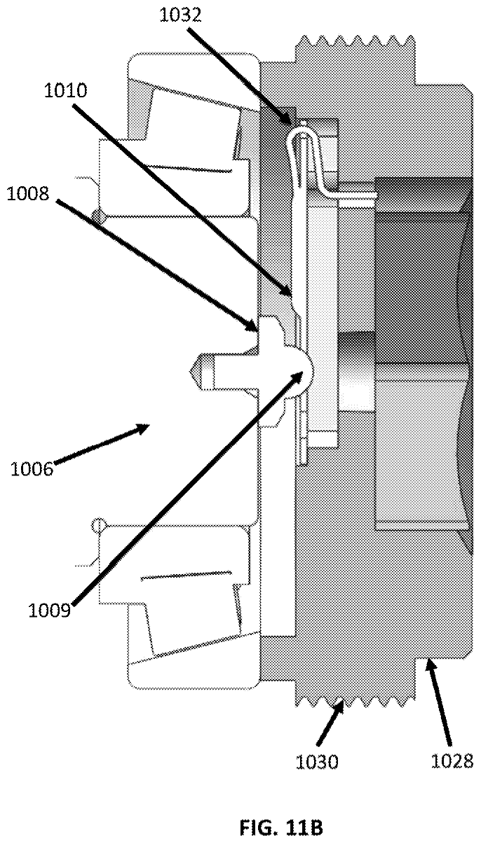

In some cases, a slew drive system 1000 can comprise a plug 1028, e.g., in place of or in addition to a proximal end plate 1014. A plug 1028 can be secured within a slew drive housing 1002 at an end of worm gear 1006, e.g., as shown in FIG. 11A. In some cases, plug 1028 can comprise threading 1030 along its outer edge(s), e.g., to couple plug 1028 to slew drive housing 1002. For example, a sensor carrier 1010 comprising one or more sensors 1013 can be secured to plug 1028 and screwed into slew drive housing 1002 using threading 1030 and corresponding threading in slew drive housing 1002 at an end of a chamber containing worm gear 1006. Optionally, wiring 1032 connecting sensor 1013 to controller 1020 can pass through all or a portion of plug 1028, e.g., as in some embodiments of slew drive system 1000 comprising a proximal end plate 1014 having a sensor carrier mount 1016. FIG. 11B shows a cross-sectional view of a plug 1028 coupled to a sensor carrier 1010 comprising one or more sensors 1013 that has been coupled to a slew drive housing 1002 such that worm interface pin 1008 impinges upon a deformation element of sensor carrier 1010 by contacting the deformation element 1011 at the interface surface 1009 of the worm interface pin 1008.

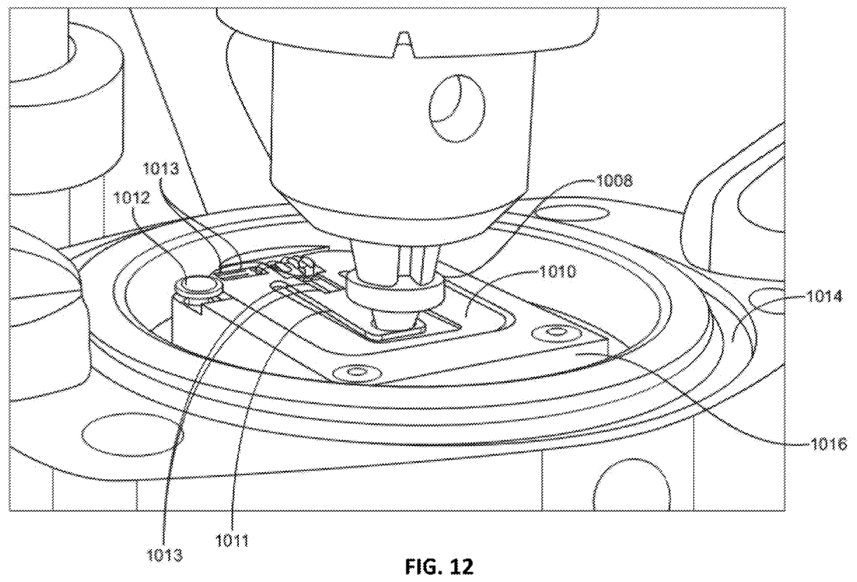

FIG. 12 shows an image of a first plurality of sensors 1013 coupled to the surface of a deformation element 1011 of a sensor carrier 1010 and a second plurality of sensors 1013 coupled to a portion of sensor carrier 1010 not located on the deformation element 1011. As shown in FIG. 12, deformation element 1011 can be pre-loaded by a worm interface pin 1008, e.g., to increase sensor dynamic range and measurement sensitivity. Sensor carrier 1010 can be coupled to a sensor carrier mount 1016 by one or more sensor carrier fasteners 1012, which can comprise, for example a bolt or screw and, optionally, a washer. A sensor carrier fastener 1012 can bias sensor carrier 1010 to sensor carrier mount 1016 or proximal end plate 1014, e.g., to secure the position of sensor carrier 1010 relative to worm interface pin 1008, for example, to maintain the position of contact between the worm interface pin 1008 and the deformation element 1011.

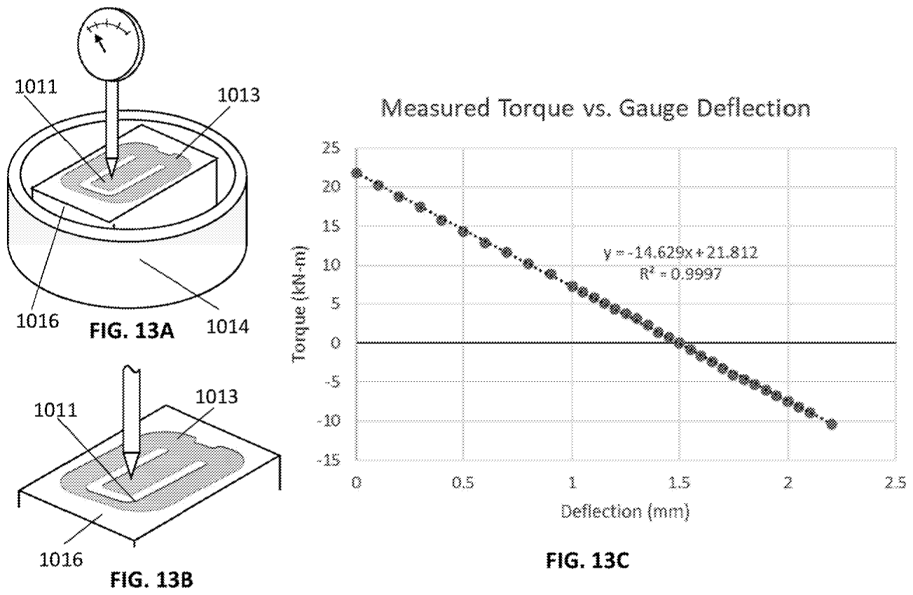

FIG. 13A shows a testing apparatus for applying precisely controlled deformations in a deformation element 1011 of a sensor carrier 1010 (e.g., by turning a threaded adapter coupled to a worm interface adapter contacting the deformation element 1011). FIG. 13C shows experimental data showing a linear relationship (r-squared value 0.9997) between torque (in kilonewton-meters, kNm) exerted on a deflection element 1011 by the worm interface pin shown in FIGS. 13A and 13B measured by strain gauge sensor 1013. In some cases, a sensor can be used to detect deformation forces (e.g., in a deformation element, sensor carrier or portion thereof) of −32 kNm to 32 kNm. In some cases, a sensor can be used to detect deformation forces (e.g., in a deformation element, sensor carrier or portion thereof) of −32 kNm to −16 kNm, −32 kNm to −8 kNm, −32 kNm to 4 kNm, −32 kNm to 0 kNm, −32 kNm to 4 kNm, −32 kNm to 8 kNm, −32 kNm to 16 kNm, −32 kNm to 32 kNm, −16 kNm to −8 kNm, −16 kNm to 4 kNm, −16 kNm to 0 kNm, −16 kNm to 4 kNm, −16 kNm to 8 kNm, −16 kNm to 16 kNm, −16 kNm to 32 kNm, −8 kNm to 4 kNm, −8 kNm to 0 kNm, −8 kNm to 4 kNm, −8 kNm to 8 kNm, −8 kNm to 16 kNm, −8 kNm to 32 kNm, 4 kNm to 0 kNm, 4 kNm to 4 kNm, 4 kNm to 8 kNm, 4 kNm to 16 kNm, 4 kNm to 32 kNm, 0 kNm to 4 kNm, 0 kNm to 8 kNm, 0 kNm to 16 kNm, 0 kNm to 32 kNm, 4 kNm to 8 kNm, 4 kNm to 16 kNm, 4 kNm to 32 kNm, 8 kNm to 16 kNm, 8 kNm to 32 kNm, or 16 kNm to 32 kNm. In some cases, a sensor can be used to detect deformation forces (e.g., in a deformation element, sensor carrier or portion thereof) of −32 kNm, −16 kNm, −8 kNm, 4 kNm, 0 kNm, 4 kNm, 8 kNm, 16 kNm, or 32 kNm. In some cases, a sensor can be used to detect deformation forces (e.g., in a deformation element, sensor carrier or portion thereof) of at least −32 kNm, −16 kNm, −8 kNm, 4 kNm, 0 kNm, 4 kNm, 8 kNm, 16 kNm, or 32 kNm. In some cases, a sensor can be used to detect deformation forces (e.g., in a deformation element, sensor carrier or portion thereof) of at most −32kNm, −16 kNm, −8 kNm, 4 kNm, 0 kNm, 4 kNm, 8 kNm, 16 kNm, or 32 kNm. In some cases, slew drive system 1000 can have a detection resolution of 10 Nm to 100 Nm. In some cases, slew drive system 1000 can have a detection resolution of 10 Nm to 20 Nm, 10 Nm to 30 Nm, 10 Nm to 40 Nm, 10 Nm to 50 Nm, 10 Nm to 60 Nm, 10 Nm to 65 Nm, 10 Nm to 70 Nm, 10 Nm to 80 Nm, 10 Nm to 90 Nm, 10 Nm to 100 Nm, 20 Nm to 30 Nm, 20 Nm to 40 Nm, 20 Nm to 50 Nm, 20 Nm to 60 Nm, 20 Nm to 65 Nm, 20 Nm to 70 Nm, 20 Nm to 80 Nm, 20 Nm to 90 Nm, 20 Nm to 100 Nm, 30 Nm to 40 Nm, 30 Nm to 50 Nm, 30 Nm to 60 Nm, 30 Nm to 65 Nm, 30 Nm to 70 Nm, 30 Nm to 80 Nm, 30 Nm to 90 Nm, 30 Nm to 100 Nm, 40 Nm to 50 Nm, 40 Nm to 60 Nm, 40 Nm to 65 Nm, 40 Nm to 70 Nm, 40 Nm to 80 Nm, 40 Nm to 90 Nm, 40 Nm to 100 Nm, 50 Nm to 60 Nm, 50 Nm to 65 Nm, 50 Nm to 70 Nm, 50 Nm to 80 Nm, 50 Nm to 90 Nm, 50 Nm to 100 Nm, 60 Nm to 65 Nm, 60 Nm to 70 Nm, 60 Nm to 80 Nm, 60 Nm to 90 Nm, 60 Nm to 100 Nm, 65 Nm to 70 Nm, 65 Nm to 80 Nm, 65 Nm to 90 Nm, 65 Nm to 100 Nm, 70 Nm to 80 Nm, 70 Nm to 90 Nm, 70 Nm to 100 Nm, 80 Nm to 90 Nm, 80 Nm to 100 Nm, or 90 Nm to 100 Nm. In some cases, slew drive system 1000 can have a detection resolution of 10 Nm, 20 Nm, 30 Nm, 40 Nm, 50 Nm, 60 Nm, 62.5 Nm, 65 Nm, 70 Nm, 80 Nm, 90 Nm, or 100 Nm. In some cases, slew drive system 1000 can have a detection resolution of at least 10 Nm, 20 Nm, 30 Nm, 40 Nm, 50 Nm, 60 Nm, 65 Nm, 70 Nm, 80 Nm, or 90 Nm. In some cases, resolution of force detection can be impacted by magnitude of force measured. In some cases, forces from 0 to 2 kNm can be detected with a resolution of from 5 Nm to 10 Nm, 10 Nm to 20 Nm, 20 Nm to 30 Nm, 30 Nm to 40 Nm, 40 Nm to 50 Nm, 50 Nm to 60 Nm, 57 Nm, 60 Nm to 70 Nm, 70 Nm to 80 Nm, or 80 Nm to 90 Nm. In some cases, forces from 2 to 5 kNm can be detected with a resolution of from 50 Nm to 60 Nm, 60 Nm to 70 Nm, 70 Nm to 80 Nm, 80 Nm to 90 Nm, 90.8 Nm, 100 Nm to 110 Nm, 110 Nm to 120 Nm, or 120 Nm to 130 Nm. In some cases, forces from greater than 5 kNm can be detected with a resolution of from 80 Nm to 90 Nm, 90 Nm to 100 Nm, 100 Nm to 110 Nm, 110 Nm to 125 Nm, 124.6 Nm, 125 Nm to 140 Nm, 140 Nm to 150 Nm, 150 Nm to 160 Nm, or 160 Nm to 170 Nm. In some cases, a slew drive system 1000 described herein can determine a worm gear displacement of 0.1 mm to 2 mm. In some cases, a slew drive system 1000 described herein can determine a worm gear displacement of 0.1 mm to 0.5 mm, 0.1 mm to 0.7 mm, 0.1 mm to 0.9 mm, 0.1 mm to 1 mm, 0.1 mm to 1.1 mm, 0.1 mm to 1.3 mm, 0.1 mm to 1.5 mm, 0.1 mm to 2 mm, 0.5 mm to 0.7 mm, 0.5 mm to 0.9 mm, 0.5 mm to 1 mm, 0.5 mm to 1.1 mm, 0.5 mm to 1.3 mm, 0.5 mm to 1.5 mm, 0.5 mm to 2 mm, 0.7 mm to 0.9 mm, 0.7 mm to 1 mm, 0.7 mm to 1.1 mm, 0.7 mm to 1.3 mm, 0.7 mm to 1.5 mm, 0.7 mm to 2 mm, 0.9 mm to 1 mm, 0.9 mm to 1.1 mm, 0.9 mm to 1.3 mm, 0.9 mm to 1.5 mm, 0.9 mm to 2 mm, 1 mm to 1.1 mm, 1 mm to 1.3 mm, 1 mm to 1.5 mm, 1 mm to 2 mm, 1.1 mm to 1.3 mm, 1.1 mm to 1.5 mm, 1.1 mm to 2 mm, 1.3 mm to 1.5 mm, 1.3 mm to 2 mm, or 1.5 mm to 2 mm. In some cases, a slew drive system 1000 described herein can determine a worm gear displacement of 0.1 mm, 0.5 mm, 0.7 mm, 0.9 mm, 1 mm, 1.1 mm, 1.3 mm, 1.5 mm, or 2 mm. In some cases, a slew drive system 1000 described herein can determine a worm gear displacement of at least 0.1 mm, 0.5 mm, 0.7 mm, 0.9 mm, 1 mm, 1.1 mm, 1.3 mm, 1.5 mm, or 2.0 mm. In some cases, a slew drive system 1000 described herein can determine a worm gear displacement of at most 0.1 mm, 0.5 mm, 0.7 mm, 0.9 mm, 1 mm, 1.1 mm, 1.3 mm, 1.5 mm, or 2 mm. In some cases, displacement of a worm gear 1006 by greater than 1.0 mm (e.g., in either direction) may indicate abnormal slew drive operation or an extreme load on the slew drive system 1000. In some cases, a warning of system error and/or unsafe loading may be issued as a result of worm gear displacements greater than from 0.7 mm to 1.3 mm (e.g., greater than 1.0 mm) in either direction. In some cases, a slew drive system 1000 described herein can determine a worm gear displacement of 10 percent to 100 percent of the slew drive's rated capacity. In some cases, a slew drive system 1000 described herein can determine a worm gear displacement of 10 percent to 20 percent, 10 percent to 30 percent, 10 percent to 40 percent, 10 percent to 50 percent, 10 percent to 60 percent, 10 percent to 70 percent, 10 percent to 80 percent, 10 percent to 90 percent, 10 percent to 100 percent, 20 percent to 30 percent, 20 percent to 40 percent, 20 percent to 50 percent, 20 percent to 60 percent, 20 percent to 70 percent, 20 percent to 80 percent, 20 percent to 90 percent, 20 percent to 100 percent, 30 percent to 40 percent, 30 percent to 50 percent, 30 percent to 60 percent, 30 percent to 70 percent, 30 percent to 80 percent, 30 percent to 90 percent, 30 percent to 100 percent, 40 percent to 50 percent, 40 percent to 60 percent, 40 percent to 70 percent, 40 percent to 80 percent, 40 percent to 90 percent, 40 percent to 100 percent, 50 percent to 60 percent, 50 percent to 70 percent, 50 percent to 80 percent, 50 percent to 90 percent, 50 percent to 100 percent, 60 percent to 70 percent, 60 percent to 80 percent, 60 percent to 90 percent, 60 percent to 100 percent, 70 percent to 80 percent, 70 percent to 90 percent, 70 percent to 100 percent, 80 percent to 90 percent, 80 percent to 100 percent, or 90 percent to 100 percent of the slew drive's rated capacity. In some cases, a slew drive system 1000 described herein can determine a worm gear displacement of 10 percent, 20 percent, 30 percent, 40 percent, 50 percent, 60 percent, 70 percent, 80 percent, 90 percent, or 100 percent of the slew drive's rated capacity. In some cases, a slew drive system 1000 described herein can determine a worm gear displacement of at least 10 percent, 20 percent, 30 percent, 40 percent, 50 percent, 60 percent, 70 percent, 80 percent, or 90 percent, or 100 percent of the slew drive's rated capacity. In some cases, a slew drive system 1000 described herein can determine a worm gear displacement of at most 10 percent, 20 percent, 30 percent, 40 percent, 50 percent, 60 percent, 70 percent, 80 percent, 90 percent, or 100 percent of the slew drive's rated capacity.

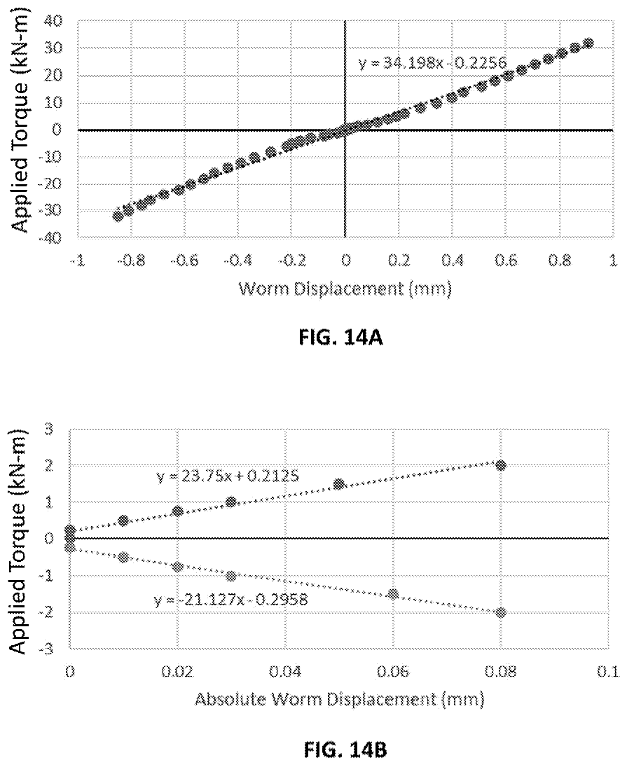

FIG. 14A shows experimental data showing a relationship between load (in kilonewton-meters, kN-m) and worm displacement. FIG. 14B shows a relationship between applied torque (in kilonewton-meters) and absolute displacement of a worm gear 1006, e.g., wherein the worm gear 1006 and worm interface pin 1008 are configured to induce an initial deformation on deformation element 1011 at zero additional applied torque. Experimental data show that the force-to −deformation relationship is linear when the deformation element is further deformed by additional positive displacement of the worm interface pin and when the initial deformation is relieved by negative displacement of the worm interface pin. In some cases, coupling, geometry, and/or dimensions of a worm interface pin 1008, a deformation element 1011, a sensor carrier 1010, a sensor carrier mount, and/or a proximal end plate 1014 can be adjusted to result in an initial deformation of a (e.g., cantilevered) deformation element 1011 of 1.50 mm, 1.25 mm to 1.75 mm, 1.00 mm to 2.00 mm, 0.75 mm to 2.25 mm, 0.5 mm to 2.5 mm, 0.25 mm to 2.75 mm, or larger than 2.75 mm (e.g., to improve dynamic range of sensor measurements, for example, in one or both direction(s) of worm gear displacement in and axial worm gear direction).

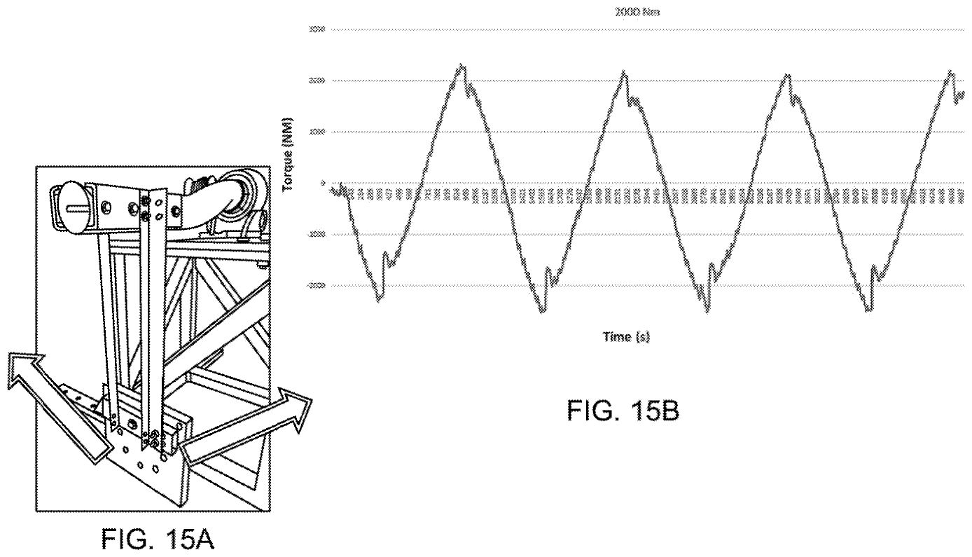

FIG. 15A shows a testing apparatus for applying an oscillatory torque load (max 2 kilonewton-meters) to a worm wheel via an accelerated pendulum weight (e.g., in directions indicated by arrows). FIG. 15B shows experimental data obtained from strain gauge sensors coupled to a deformation element of a slew drive system 1000, as described herein, wherein oscillatory torque applied to the worm wheel by the testing apparatus is translated into displacement of a worm gear in an axial direction of the worm gear and, in turn deformation of a deformation element of a sensor carrier to which the sensor is coupled.

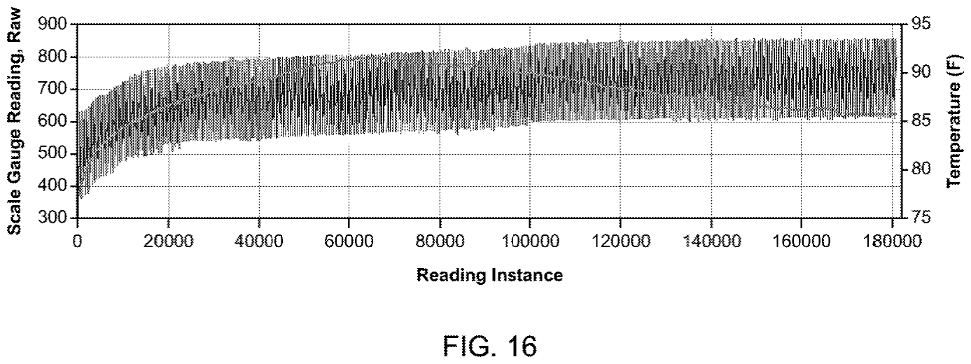

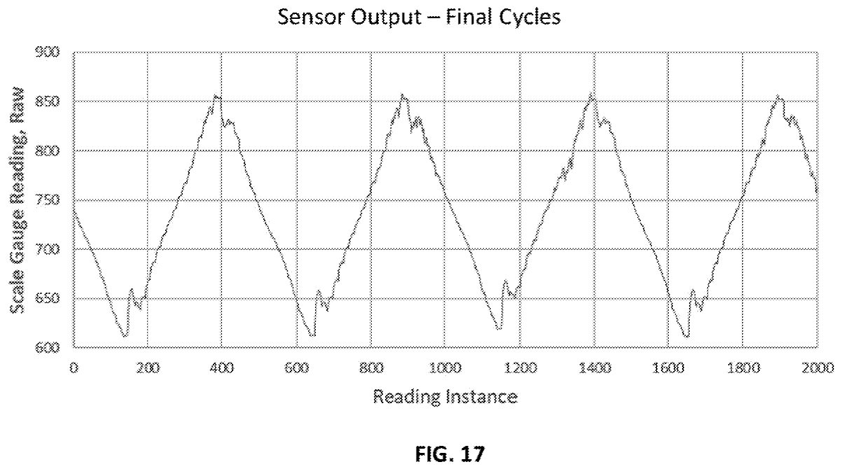

FIG. 16 shows raw strain gauge data and temperature sensor data from oscillatory torque testing over 359 total oscillatory cycles, in accordance with some embodiments. After an initial acclimation period, strain gauge readings are stable over extended oscillatory loading. Measured temperature varies during testing from a maximum of approximately 92 degrees Fahrenheit to approximately 86 degrees Fahrenheit at the conclusion of testing. FIG. 17 shows an enlarged view of raw strain gauge data obtained during the final four cycles of oscillatory testing. In some cases, periodic temperature measurements can be made, e.g., to correct for temperature-effects on sensor measurements, e.g., by evaluating changes in strain gauge sensors 1013 expansion or contraction in view of change(s) in temperature from a temperature at which the sensor(s) 1013 were initially zeroed. In some cases, such a relationship is approximately 15 to 25 Nm/C (newton-meters per degree Celsius), e.g., 23 Nm/C.

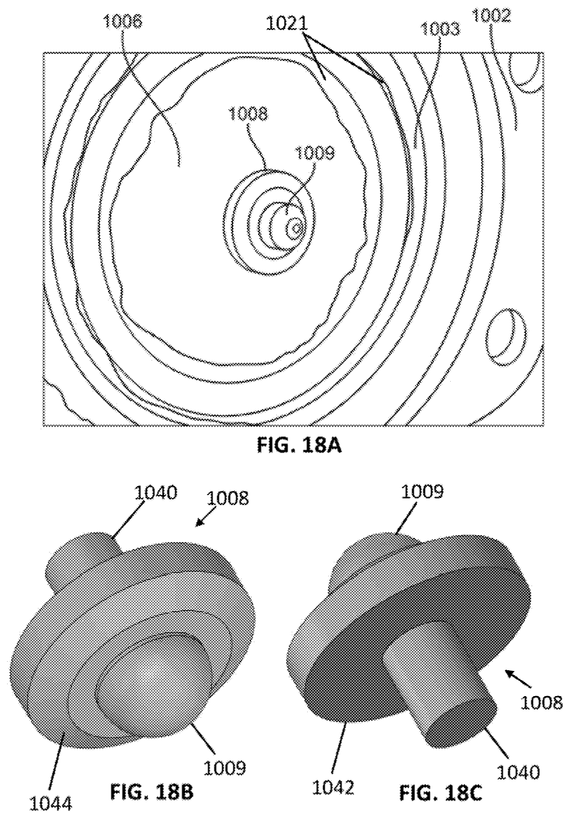

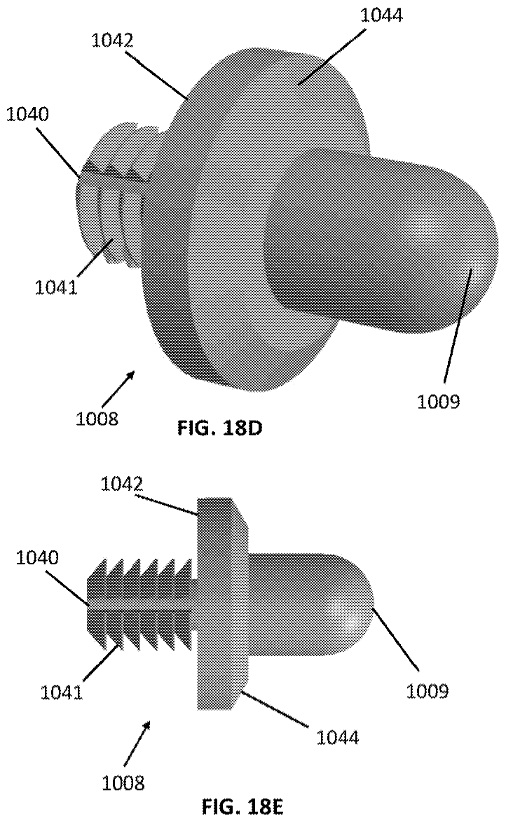

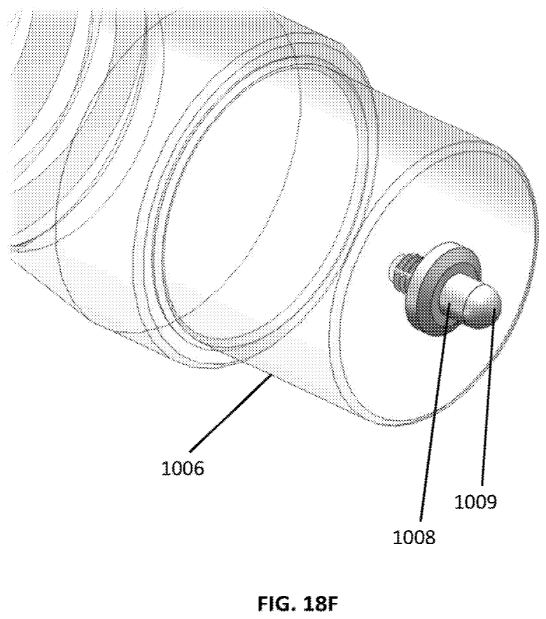

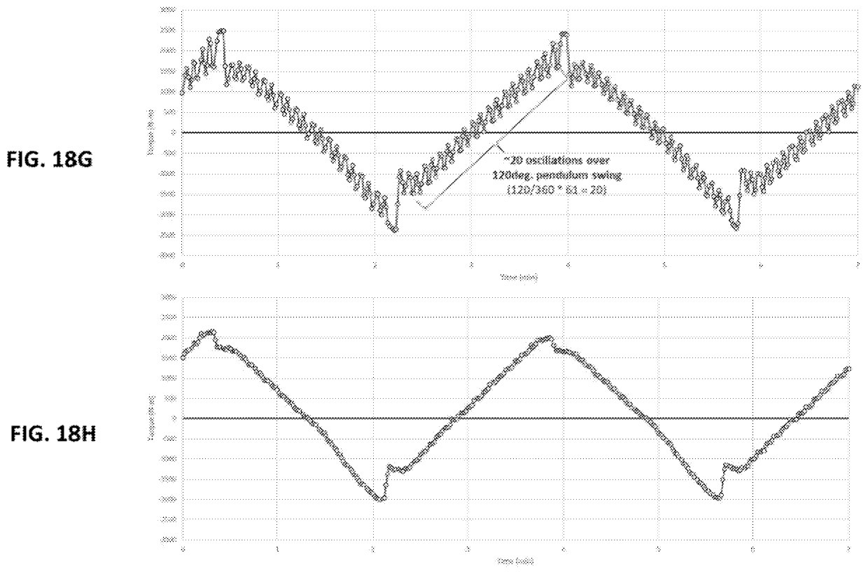

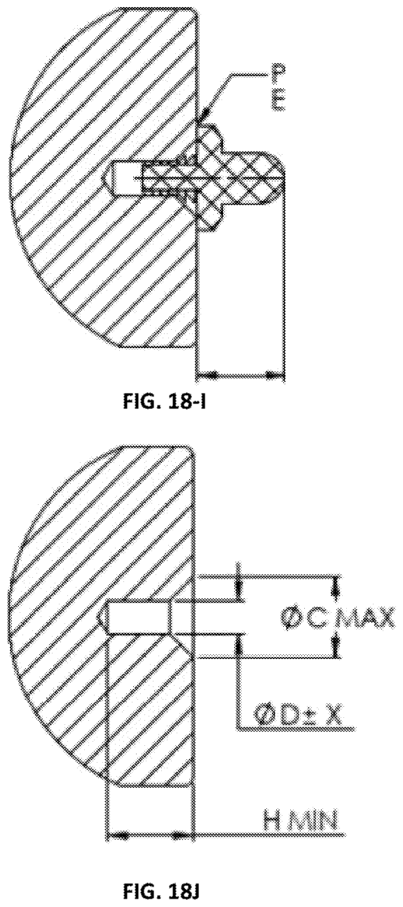

FIG. 18A shows a worm interface pin 1008 fitted to an end surface of a worm gear 1006. As shown in FIG. 18A, the end of worm gear 1006 can be housed within a housing bearing 1003 of slew drive housing 1002. One or more fluids, such as one or more lubricants 1021 can be used to decrease friction between two or more components of a slew drive system (e.g., between a worm gear 1006 and a slew drive housing bearing 10003. Worm interface pin 1008 can comprise a worm interface pin interface surface 1009, which can be used to contact a sensor carrier 1010, e.g., at a point on a deformation element 1011. In some cases, the geometry of a worm interface pin interface surface 1009 can be designed to reduce wear and fatigue in the worm interface pin and in the sensor carrier. For example, worm interface pin interface surface 1009 can have a round geometry (e.g., hemispherical, spherical, or other rounded shapes) or other geometry that minimizes contact area between the worm interface pin 1008 and the sensor carrier 1010, e.g., as shown in FIGS. 18B-18F. In some cases, minimizing contact area between the worm interface pin 1008 and the sensor carrier 1010 can decrease the amount of wear resulting from rotation of the worm gear 1006 (e.g., and in turn rotation of the worm interface pin 1008), for example, as the worm wheel applies a force against the threading of the worm gear. In some cases, a worm interface pin interface surface having a rounded geometry (e.g., spherical, hemispherical, or other rounded shape) can aid in maintaining a single point of contact on a sensor or sensor carrier (or portion thereof) over a wide range of deflections of the sensor or sensor carrier. In some cases, a worm interface pin interface surface 1009 can be flat (e.g., as shown in FIG. 19). In some cases, a longitudinal length of a worm interface pin 1008 can be from 1 mm to 12 mm. In some cases, a longitudinal length of a worm interface pin 1008 can be from 1 mm to 4 mm, 1 mm to 6 mm, 1 mm to 8 mm, 1 mm to 10 mm, 1 mm to 12 mm, 4 mm to 6 mm, 4 mm to 8 mm, 4 mm to 10 mm, 4 mm to 12 mm, 6 mm to 8 mm, 6 mm to 10 mm, 6 mm to 12 mm, 8 mm to 10 mm, 8 mm to 12 mm, or 10 mm to 12 mm. In some cases, a longitudinal length of a worm interface pin 1008 can be from 1 mm, 4 mm, 6 mm, 8 mm, 10 mm, or 12 mm. In some cases, a longitudinal length of a worm interface pin 1008 can be from at least 1 mm, 4 mm, 6 mm, 8 mm, or 10 mm. In some cases, a longitudinal length of a worm interface pin 1008 can be from at most 4 mm, 6 mm, 8 mm, 10 mm, or 12 mm. In some cases, a width, radius, or diameter of all or a portion of a worm interface pin 1008 (e.g., of an interface surface 1009 of worm interface pin 1008) can be from 0.5 mm to 6 mm. In some cases, a width, radius, or diameter of all or a portion of a worm interface pin 1008 (e.g., of an interface surface 1009 of worm interface pin 1008) can be from 0.5 mm to 1 mm, 0.5 mm to 2 mm, 0.5 mm to 3 mm, 0.5 mm to 4 mm, 0.5 mm to 5 mm, 0.5 mm to 6 mm, 1 mm to 2 mm, 1 mm to 3 mm, 1 mm to 4 mm, 1 mm to 5 mm, 1 mm to 6 mm, 2 mm to 3 mm, 2 mm to 4 mm, 2 mm to 5 mm, 2 mm to 6 mm, 3 mm to 4 mm, 3 mm to 5 mm, 3 mm to 6 mm, 4 mm to 5 mm, 4 mm to 6 mm, or 5 mm to 6 mm. In some cases, a width, radius, or diameter of all or a portion of a worm interface pin 1008 can be from 0.5 mm, 1 mm, 2 mm, 3 mm, 4 mm, 5 mm, or 6 mm. In some cases, a width, radius or diameter of all or a portion of a worm interface pin 1008 can be from at least 0.5 mm, 1 mm, 2 mm, 3 mm, 4 mm, or 5 mm. In some cases, a width or diameter of all or a portion of a worm interface pin 1008 can be from at most 1 mm, 2 mm, 3 mm, 4 mm, 5 mm, or 6 mm. In some cases, a worm interface pin can comprise steel (e.g., stainless steel, such as 400 series stainless steel). In some cases, a worm interface pin can comprise Inconel (e.g., Inconel 600).

In some cases, worm interface pin 1008 can comprise a worm interface pin post 1040 (e.g., as shown in FIGS. 18B-18F, and FIG. 19), which can be fitted into a hole on the end surface of worm gear 1006 (e.g., to aid in maintaining the positioning of the worm interface pin 1008 relative to worm gear 1006). In some cases, worm interface pin 1008 can comprise worm interface pin lip 1042 (e.g., to reduce bending of worm interface pin 1008 during use, for example, by contacting the end surface of worm gear 1006). In some cases, a worm interface pin lip 1042 can be increase the consistency of initial deflection (or deformation) of a slew drive system sensor 1013 or sensor carrier 1010 (or portion thereof). For example, inserting a worm interface pin post 1040 into a worm gear end surface hole until a worm interface pin lip 1042 of the worm interface pin 1040 contacts the worm gear end surface can aid in ensuring a consistent distance between the worm gear end surface and the contact point on the sensor 1013 or sensor carrier 1010 (or portion thereof). In some cases, worm interface pin 1008 can comprise bevel 1044 (e.g., to reduce the likelihood of worm interface pin lip 1042 inadvertently contacting sensor carrier 1010 or a component coupled to proximal end plate 1014 during use).

In some cases, a worm interface pin post 1040 can comprise one or more worm interface pin post flanges 1041 (e.g., as shown in FIGS. 18D-18F). In some cases, one or more worm interface pin post flanges 1041 can aid in maintaining the positioning of the worm interface pin 1008 relative to worm gear 1006 (e.g., by maintaining the positioning of worm interface pin post 1040 relative to (e.g., axially and/or in a direction perpendicular to a longitudinal axis of worm gear 1006)) worm gear 1006 (e.g., as shown in FIG. 18F). For instance, one or more worm interface pin post flanges 1041 can exert a biasing force against an inner surface of a worm gear end surface hole (e.g., to increase friction between the worm interface pin 1008 and the inner surface of the worm gear end surface hole), in some embodiments. In some cases, improving positioning of the worm interface pin 1008 relative to worm gear 1006 (e.g., by employing a worm interface pin 1008 comprising one or more worm interface pin post flanges 1041) can improve the accuracy and/or precision of slew drive system sensor 1013. For example, reducing variability in the position on a sensor carrier 1010 (e.g., a position on a deformation element of the sensor carrier) at which a worm interface pin interface surface 1009 contacts the sensor carrier 1010 (e.g., resulting from movement of the worm interface pin post 1040 within the worm gear end surface hole) can reduce or eliminate variability in deformation element deflection, variability in deformation element strain, and/or error in sensor measurements of worm gear position (e.g., as shown in FIG. 18G and FIG. 18H).

In some cases, a worm interface pin post 1040 can comprise a plurality of worm interface pin post flanges 1041. In some cases, the one or more worm interface pin post flanges 1041 of a worm interface pin can increase a radial dimension (e.g., diameter) of a worm interface pin post 1040 from less than or equal to a radial dimension (e.g., inner diameter) of a worm gear end surface hole to a length greater than the radial dimension (e.g., inner diameter) of the worm gear end surface hole (e.g., as shown in FIG. 18I). In some cases, a worm gear end surface hole comprises a bevel (e.g., as shown in FIG. 18J). In some cases, the axial length of a worm interface pin post is less than (e.g., as shown in FIG. 18I) or is equal to the axial length of a worm gear end surface hole. In some cases, all or portion of a worm interface pin post flange 1041 can be flexible (e.g., semi-rigid). A diameter of a worm gear end surface hole can vary between worm gears of individual slew drive systems (e.g., due to loose worm gear manufacturing control). In some cases, a worm interface pin 1008 comprising one or more worm interface pin post flanges 1041 can be properly fitted into worm gear end surface holes of different diameters. In some cases, this can reduce or eliminate the need to produce multiple sizes or styles of worm interface pins 1008 having different worm interface pin post diameters to ensure a proper fit in the worm gear of each slew drive system.

In some cases, a worm interface pin 1008 comprises a flat worm interface pin interface surface 1009, e.g., as shown in FIG. 19A (which shows an unused worm interface pin, in accordance with some embodiments) and FIG. 19C (which shows a worm interface pin that has been used in a slew drive system 1000, in accordance with embodiments). A worm interface pin 1008 comprising a flat worm interface pin interface surface 1009 can comprise a worm interface pin post 1040, e.g., as shown in FIG. 19B (which shows an unused worm interface pin, in accordance with some embodiments) and FIG. 19D (which shows a worm interface pin that has been used in a slew drive system 1000, in accordance with embodiments). FIG. 19E illustrates an example of a proximal end plate 1014 comprising a seal 1022 and four proximal end plate fastener holes 1019, which is coupled to a sensor carrier mount 1016 that is coupled to a sensor carrier frame 1010 and a deformation element 1011. A sensor 1013 (e.g., a force sensor) can be coupled to the sensor carrier 1010 between the sensor carrier frame 1010 and the deformation element 1011, for example, as shown in FIG. 19E. In some cases, deformation of deformation element 1011 (e.g., as configured in FIG. 19E) can compress a force sensor 1013 (e.g., as configured in FIG. 19E). In some cases, deformation element 1011, for example as configured in FIG. 19E, can be deformed as a result of displacement of a worm gear 1006 in a direction perpendicular to or substantially perpendicular to a plane of the sensor carrier 1010 and/or the deformation element 1011. In some cases, force resulting from worm gear displacement can be transmitted to a deformation element by a worm interface pin 1008. A worm interface pin 1008 (e.g., separate from worm gear 1006) is shown in FIG. 19E placed on top of the assembled proximal end plate apparatus.

FIG. 20A shows a worm interface pin 1008 placed in an end surface of a worm gear 1006. A worm interface pin 1008 can have a flat worm interface pin interface surface 1009 (e.g., as shown in FIG. 20A) or a non-flat worm interface pin interface surface 1009. A sensor 1013 can be disposed between a deformation element 1011 and a sensor carrier frame 1010, for example, as shown in FIG. 20B and FIG. 20C. As shown in FIGS. 20B and 20C, a deformation element 1011 can be coupled to a sensor carrier 1010 by fasteners, in some embodiments. As shown in FIG. 20B, a sensor carrier 1010 can be coupled to a sensor carrier mount 1016, which can in turn be coupled to a proximal end plate 1014. In some embodiments, a proximal end plate 1014 (e.g., that is coupled to a sensor carrier mount 1016, a sensor carrier 1010, and/or a sensor 1013) can comprise proximal end plate fastener holes 1019, e.g., for coupling the proximal end plate 1014 to a slew drive housing 1002 such that worm interface pin 1008 is aligned with and/or directly contacts deformation element 1011 (e.g., as shown in FIG. 21).

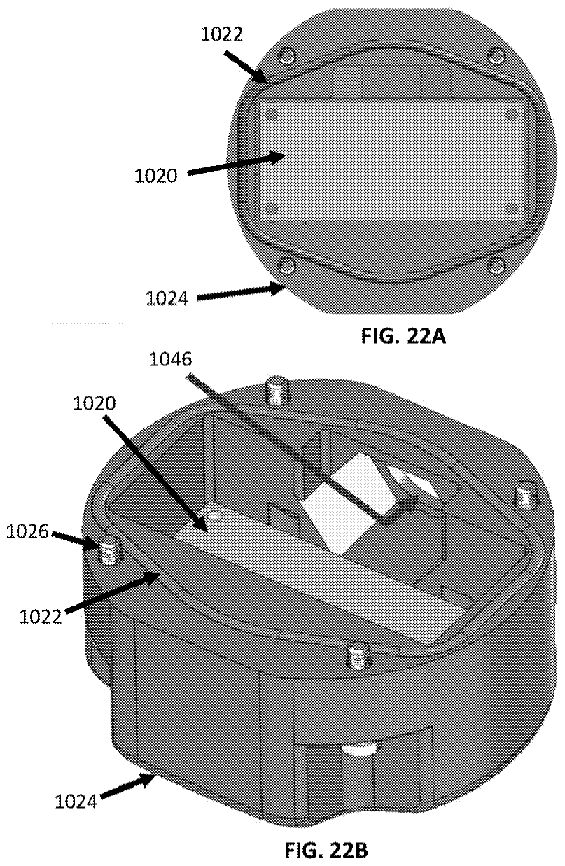

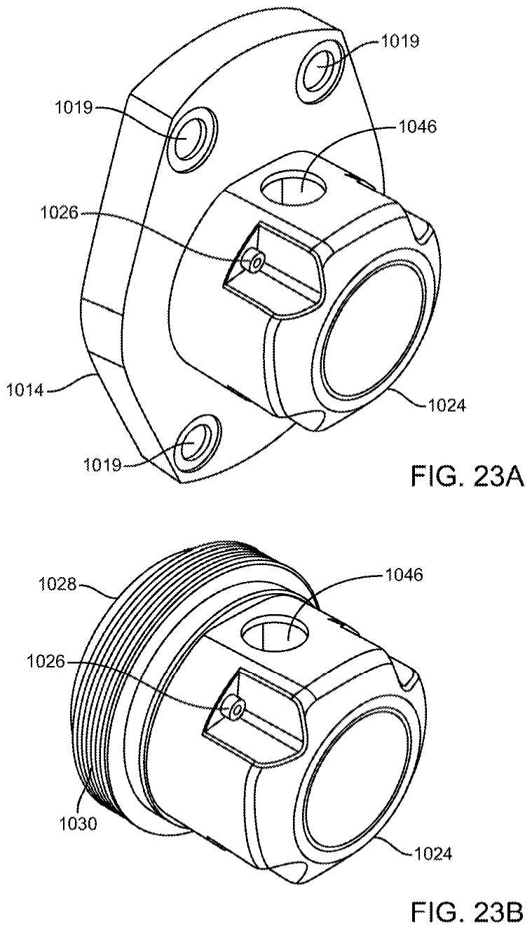

A slew drive system 1000 can comprise a distal end cap 1024. A distal end cap 1024 can be used to house a controller 1020 (e.g., as shown in FIG. 22A and FIG. 22B). In some cases, a controller 1020 is coupled to a distal end cap 1024. In some cases, a controller 1020 is coupled to an interior surface of a distal end cap 1024. While it is contemplated that a controller can be coupled to or housed within another portion of slew drive system 1000 (e.g., slew housing 1002, proximal end plate 1014, sensor carrier mount 1016, or sensor carrier 1010), housing controller 1020 within distal end cap 1024 can protect the controller 1020 from damage that may be sustained from moving components of the slew drive system 1000 and/or damage from lubricants of slew drive system 1000 in some cases. As shown in FIG. 22A and FIG. 22B, a distal end cap 1024 can comprise a seal 1022 (e.g., to reduce the likelihood of lubricants or other fluids contacting the controller 1020. In some cases, a distal end cap 1024 can be coupled to a proximal end plate 1014 and/or to a slew drive housing 1002, e.g., via distal end cap fasteners 1026. In some cases, a distal end cap 1024 (and/or a proximal end plate 1014) can comprise a connection port 1046. In some cases, a connection port comprises an aperture in a portion of distal end cap 1024 (e.g., through a side wall or end wall of distal end cap 1024, for example, to form a gap connecting an interior cavity or chamber of distal end cap 1024 with the space external to the slew drive system). In some cases, wiring 1032 connected to one or more sensors 1013 can run through a connection port 1046, e.g., to connect one or more sensors 1013 and/or controller 1020 to an external controller 1066 (e.g., an external programmable logic controller and/or a data acquisition processor). In some cases, a distal end cap 1024 can comprise a plastic material. In some cases, a distal end cap 1024 can be 3D printed (e.g., from plastic). In some cases, a distal end cap 1024 can be formed by injection molding (e.g., from plastic) In some cases, a distal end cap 1024 can comprise a metal material.

A distal end cap 1024 can be coupled to a proximal end plate 1014 (e.g., as shown in FIG. 23A) or to a plug 1028 (e.g., as shown in FIG. 23B), for example, to secure controller 1020 to the body of the slew drive mechanism and/or to prevent damage to wired connections 1032 between one or more sensors and controller 1020. Additionally, or alternatively, a distal end cap 1024 can be coupled to a slew drive housing 1002, e.g., via distal end cap fasteners 1026.

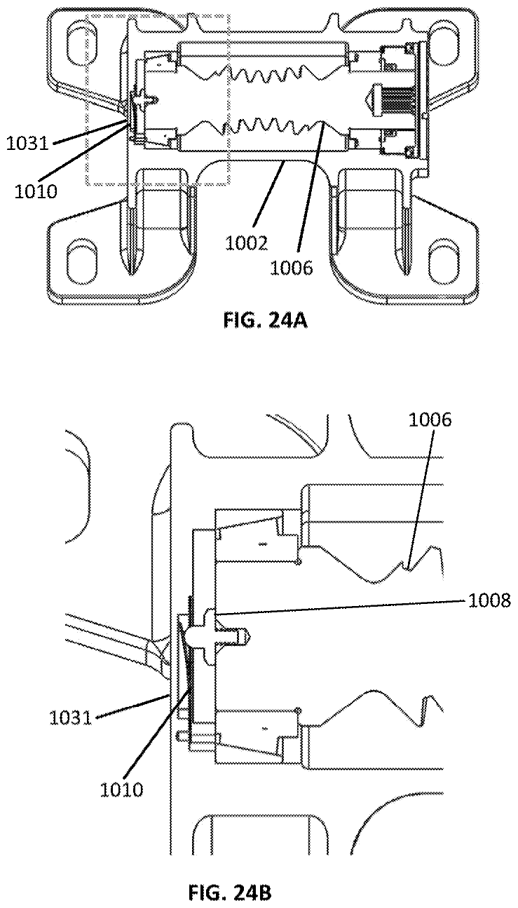

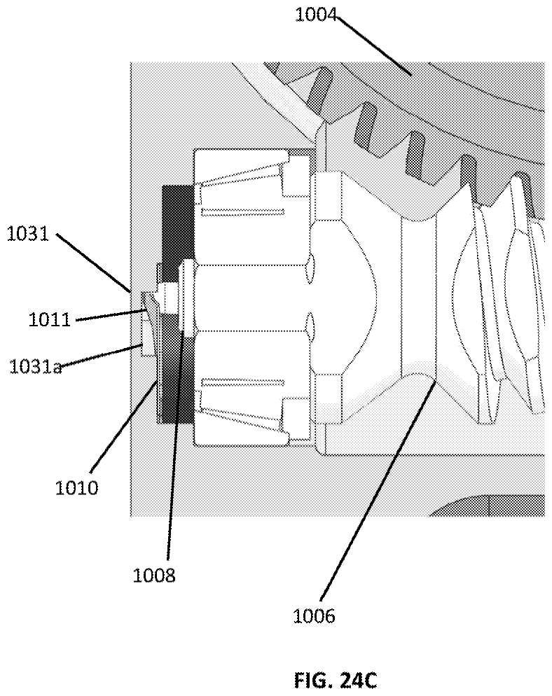

In some cases, a slew drive system 1000 can comprise a sensor carrier 1010 coupled to a housing 1002 of the slew drive system 1000, for example, as shown in FIG. 24A and FIG. 24B (FIG. 24B shows an enlarged view of some embodiments of the slew drive system 1000 represented in FIG. 24A, e.g., in a region indicated by the dotted line in FIG. 24A). In some cases, a housing 1002 of a slew drive system 1000 can extend partially or completely across a worm gear shaft of the slew drive system 1000. For instance, the housing 1002 of a slew drive system 1000 can form an end wall 1031 of the worm gear shaft, which can be a continuous portion of the housing 1002, e.g., as shown in FIG. 24A and FIG. 24B. In some cases, a sensor carrier 1010 can be coupled (e.g., directly) to the end wall 1031 of the worm gear shaft. A sensor carrier 1010 coupled to an end wall 1031 of a worm gear shaft can be aligned such that a deformation element 1011 can be impinged upon by the worm gear 1006 or a worm interface pin 1008, e.g., during operation of the slew drive system 1000, for example, to facilitate measurement of axial displacement of the worm gear 1006 within the worm gear shaft (for instance by detecting a signal or change in signal from one or more sensors (e.g., one or more strain gauge sensors) coupled to the deformation element 1011). In some cases, a slew drive system 1000 with a worm gear shaft that is sealed or partially sealed by an end wall 1031 and a sensor carrier coupled directly or indirectly to the (e.g., interior surface) of the end wall 1031 of the worm gear shaft does not require and a coupleable end plate, a coupleable plug, and/or a coupleable end cap (e.g., a “plateless,” “plugless,” and/or “capless” system), which can reduce the number of parts required to assemble the device and/or the cost of manufacture.

FIG. 24C shows a portion of a slew drive system 1000 with a sensor carrier 1010 coupled to an end wall 1031 of the worm gear shaft of the system, in accordance with some embodiments. In some cases, an end wall 1031 of a worm gear shaft can comprise a recess 1031a, e.g., to allow deformation (e.g., deflection) of a deformation element 1011 of a sensor carrier 1010 coupled to the end wall 1031 of the worm gear shaft, for example as a worm interface pin 1008 (e.g., coupled to an end surface of a worm gear 1006 or in registration with a hole in an end surface of the worm gear 1006) impinges upon the deformation element 1011 (for instance, wherein the impinging results from axial displacement of the worm gear 1006 within the worm gear shaft). In some cases, allowing space for the deformation element 1011 to move (e.g., deform or displace) without contacting the end wall 1031 of the worm gear shaft allows a greater dynamic range and/or fidelity of sensor data (e.g., strain gauge data) from one or more sensors coupled to the sensor carrier 1010.

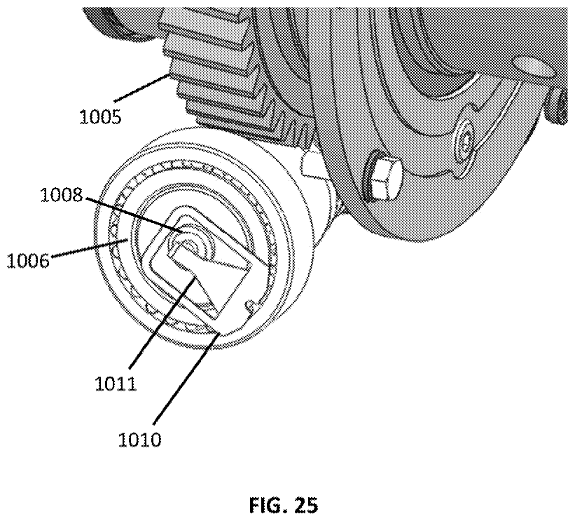

FIG. 25 shows an isolated view of a worm interface pin 1008 contacting a deformation element 1011 of a sensor carrier 1010, in accordance with some embodiments (e.g., wherein the sensor carrier is coupled to an end plate 1014 (e.g., proximal end cap 1014), a plug 1028, an end cap (e.g., a distal end cap 1024)), a protrusion cap 1027, or an end wall 1031 of a worm gear shaft). In some cases, rather than being coupled to the proximal end cap 1014), a plug 1028, an end cap (e.g., a distal end cap 1024)), a protrusion cap 1027, or an end wall 1031 of a worm gear shaft, the sensors and sensor carrier can be coupled to a center of a side wall of the housing of the worm gear shaft, as discussed below.

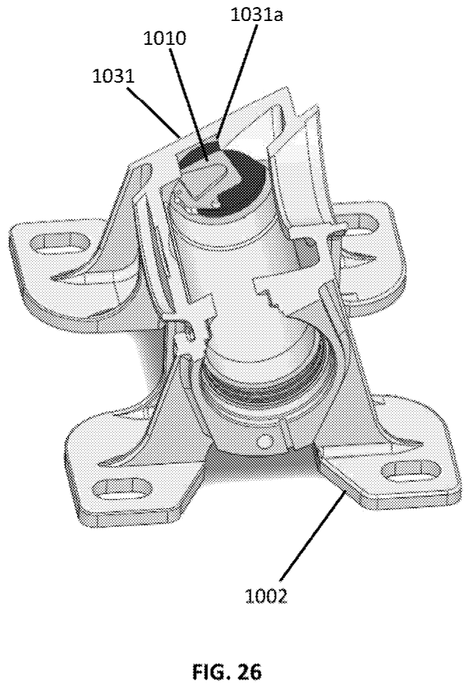

As shown in FIG. 25, the positioning of the sensor carrier relative to an end surface of the worm gear 1006 and/or a worm interface pin 1008 (or distal end 1009 thereof) and/or the shape of the sensor carrier 1010 can be adjusted (e.g., relative to the shape or size of the worm interface pin 1008) to avoid contact between the worm interface pin 1008 and/or the distal end surface of the worm gear 1006. FIG. 26 shows a cutaway view of a housing 1002 of a slew drive system 1000 wherein the sensor carrier 1010 is coupled to an end wall 1031 (e.g., a distal end wall 1031) of the worm gear shaft.

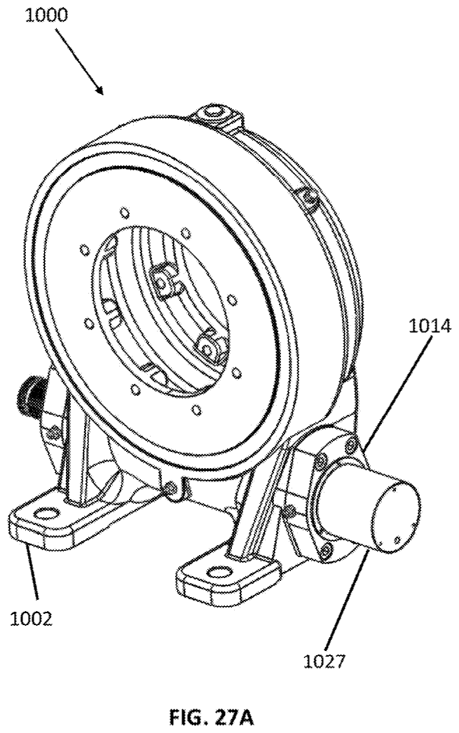

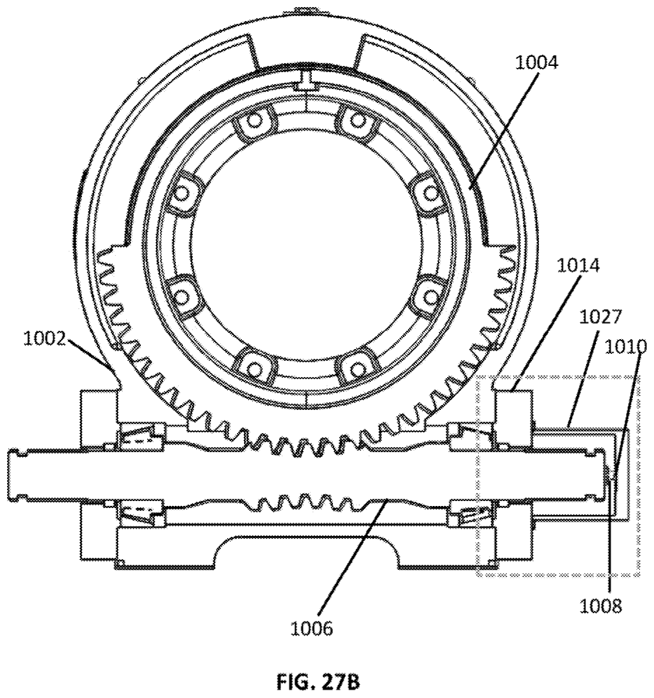

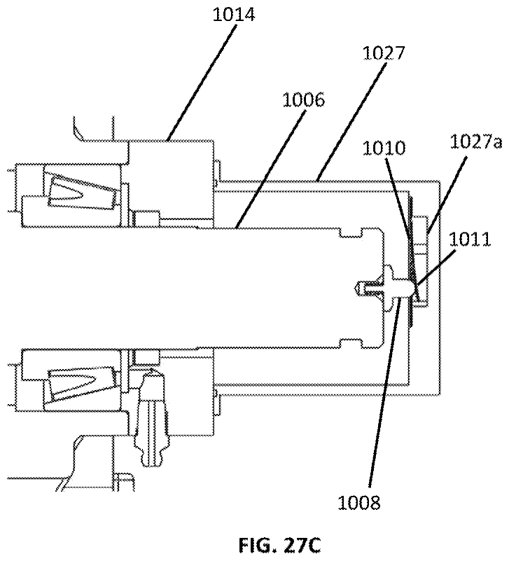

A slew drive system 1000 can comprise a protrusion cap 1027, for instance, as shown in FIG. 27A, FIG. 27B, and/or FIG. 27C. In some cases, it is desirable or necessary for a worm gear 1006 that extends beyond the housing 1002 or an end plate 1014 of the slew drive system 1000 to be used. In some cases, it is necessary or advantageous to provide a protrusion cap 1027, which may comprise a sensor carrier 1010 coupled to an interior surface of the protrusion cap 1027, for instance, so that the sensor carrier 1010 (or a deformation element 1011 thereof) can be positioned at a distal end of the worm gear 1006, for example, which may extend beyond the housing or end plate of the system. In some cases, switching from a standard or short worm gear 1006 to a long worm gear 1006 (e.g., which may extend beyond a housing or end plate of the system) can preclude the use of a sensor carrier coupled to an end plate 1014 or a plug 1024. In some cases, the protrusion cap 1027 (e.g., coupled to a sensor carrier 1010) can be coupled to the housing 1002 (e.g., in place of an end plate 1014 or a plug 1024) so that the housing 1002 and one or more components of the slew drive system 1000 can be used with the longer worm gear 1006. FIG. 27B shows a cutaway view of a slew drive system 1000 comprising a protrusion cap 1027 and a worm gear 1006 that extends beyond the housing 1002 and end plate 1014 of the system 1000. In some cases, a protrusion cap 1027 can comprise fasteners or threading, which can be used to couple the protrusion cap 1027 to the housing 1002 and/or to the end plate 1014. As shown in FIG. 27B, a sensor carrier 1010 can be coupled to (e.g., an interior surface of) a protrusion cap 1027, for example, to allow a worm gear 1006 and/or a worm interface pin 1008 to contact the sensor carrier 1010 (e.g., a deformation element 1011 of a sensor carrier 1010) properly, as described herein. FIG. 27C shows a configuration of a portion of a slew drive system 1000 comprising a protrusion cap 1027. As shown in FIG. 27C, a protrusion cap 1027 can comprise a recess 1027a, which can be useful in providing space for deformation and/or displacement of a deformation element 1011 of a sensor carrier 1010 coupled to the protrusion cap, e.g., during use of the system 1000. In some cases, providing space (e.g., recess 1027a) for the deformation and/or displacement of a deformation element 1011 in a protrusion cap 1027 can improve the dynamic range and/or fidelity of sensor data from one or more sensors coupled to the sensor carrier 1010.

A slew drive system 1000 can comprise a controller 1020. In some cases, a controller 1020 is “on-board” or “local” (e.g., housed within or coupled to one or more components of the mechanical slew drive system). A “local” controller 1020 can be in communication with one or more sensors 1013 (e.g., one or more strain gauge sensors and/or one or more force sensors) of the slew drive system via a wired connection 1032. In some cases, a “local” controller 1020 can be powered by a battery (e.g., a battery local to the controller 1020, such as a battery on-board the “local” controller 1020 or a battery coupled to one or more of the mechanical slew drive components), an RF signal (e.g., via an RF receiver), or via power wires connected to an external power source. In some cases, a “local” controller can provide power to one or more sensors 1013, e.g., via one or more wires (e.g., a ground wire 1032c and/or a live power wire 1032a), for example, as shown in FIG. 28. In some cases, a controller 1020 (or controller 1066) can be “remote” (e.g., housed outside of all mechanical slew drive system components). In some cases, a “remote” controller 1020 (e.g., an external controller 1066) can be in communication with one or more sensors 1013, one or more “local” controllers 1020, and/or one or more additional “remote” controllers (e.g., external controllers 1066) via a wireless connection.

As shown in FIG. 29, a controller 1020 (e.g., a “local” controller 1020) can comprise wiring posts or pins 2902 for connection to wiring coupled to one or more sensors 1013 (e.g., one or more strain gauge sensors and/or one or more force sensors). New code can be uploaded through pins 2902. In some cases, a controller 1020 (e.g., a “local” controller) can comprise a temperature sensor 2904, e.g., to monitor internal temperature of the slew drive system. In some cases, temperature data measured by a temperature sensor of a slew drive system can be used to estimate or determine the amount of deformation a deformation element 1011, worm interface pin 1008, worm gear 1006, and/or sensor 1013 experiences during a measured data point, for example, to aid in determining a correction factor for processing and analyzing sensor measurement data. There can be a PWM to analog voltage chip 2906 that allows software to automatically set a torque reading in the center of the microcontroller range. Optional connections can be included for analog voltage output. A controller 1020 can comprise a processor, e.g., for processing raw sensor data and/or for controlling sensor function. In some cases, a processor of a controller 1020 can be configured to process data input provided (e.g., by one or more sensors 1013) at a rate of at least 1 Hertz (Hz), at least 2 Hz, at least 5 Hz, at least 10 Hz, at least 15 Hz, at least 20 Hz, at least 25 Hz, at least 30 Hz, at least 40 Hz, or at least 50 Hz. The controller chip can process scale gauge signal 2912 and send PWM output of the scale gauge reading at a 10 Hz frequency. A controller 1020 can comprise a non-transitory memory and/or a transitory memory, for example, to store instructions for data processing by the controller and/or instructions for operation of one or more sensors 1013 of the slew drive system 1000. In some cases, a processor of a controller 1020 can comprise circuitry for signal processing (e.g., low pass filter(s), high pass filter(s), band pass filter(s), pulse width modulators (PWM), signal rectifiers, etc.). In some cases, circuitry of controller 1020 can comprise a Wheatstone bridge architecture, e.g., for processing strain gauge sensor data. A controller 1020 can comprise one or more signal amplifiers 1052 (e.g., analog and/or digital). In some cases, a signal amplifier 1052 of a controller 1020 can amplify sensor data from a low voltage (e.g., between 0 volts and 5 volts) to a voltage readable by a processor 1050 of controller 1020 (e.g., 5 volts).

In some cases, a controller 1020 (e.g., a “local” controller) can comprise an input or input/output terminal (e.g., a 3-pin input/output terminal shown in FIG. 29). The 3-pin input can comprise and input to board and output to on-site DAQ 2908. The 3-pin output 2916 can be for external wiring to a scale gauge. In some cases, an input terminal of a (e.g., “local”) controller 1020 can be used to supply power to controller 1020 and/or to one or more sensors 1013 (e.g., via a wired connection). In some cases, an input/output terminal can be used to send data (e.g., raw and/or processed sensor data) to an external controller 1066. In some cases, an input/output terminal can be used to receive programming code for a processor of controller 1020. A controller 1020 (e.g., a “local” controller) can comprise a voltage regulator 2910 (e.g., a five volt regulator), which can accept power at a higher voltage (e.g., 6.5 Volts to 20 Volts) and step the voltage down to an amplitude usable by the controller 1020 and/or one or more sensors 1013 of the slew drive system. The voltage regulator can be bypassed if the regulated power supply is available on-site.

FIG. 30 shows a diagram of a sensor data processing system of a slew drive system 1000. In some cases, a sensor 1013 (e.g., a force or strain sensor) can send measured data to a signal amplifier 1052 of controller 1020 (e.g., via wiring 1032 or via a wireless connection). In some cases, data from one or more sensors 1013 can be sent to an analog-to −digital converter 1054 from the sensor 1013 or the signal amplifier 1052. In some cases, data from one or more sensors 1013 can be sent to a processor 1050 (e.g., microprocessor), which can be located on controller 1020 from sensor 1013, signal amplifier 1052, and/or analog-to −digital converter 1054. In some cases, a temperature sensor 1048 (e.g., on board controller 1020 or connected to controller 1020 via a wired or wireless connection) can send measured data to an analog-to −digital converter and/or to a processor 1050 of controller 1020. In some cases, processor 1050 can execute instructions stored (e.g., as programmable code) on a non-transitory memory 1064 of controller 1020 or on an external memory in communication with microprocessor 1050 to perform functions 1060 related to data processing functions (e.g., data signal processing) and/or to control operation of one or more sensors 1013. In some cases, functions 1060 performed by processor 1050 can improve data stream performance. In some cases, instructions stored upon non-transitory memory 1064 can comprise calibration data, recorded data, and/or user settings. In some cases, a controller 1020 comprises a crystal oscillator 1056, e.g., for governing the frequency of sensor data collection and/or data output. In some cases, data can be converted by a processor 1050 to a second format (e.g., RS485 format for transmission). In some cases, processor 1050 can transmit data (e.g., comprising raw or processed sensor data) to and/or from a transceiver 1058 (e.g., an RS485 transceiver such as a MAX485 transceiver) for transmission to and/or from an external controller 1066 (e.g., via wireless communication). Additional storage, analysis, and/or processing of transmitted data can be performed by external controller 1066. In some cases, instructions (e.g., instructions for storage on non-transitory memory 1064 and/or execution by processor 1050) can be received from external controller 1066 via transceiver 1058.

### Slew Drive Systems

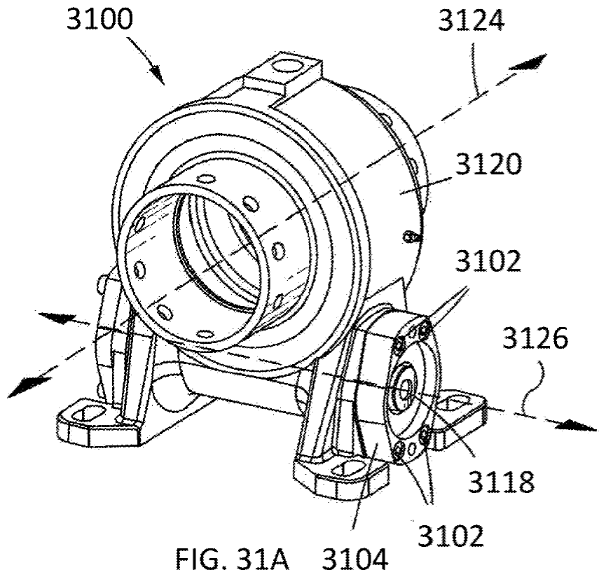

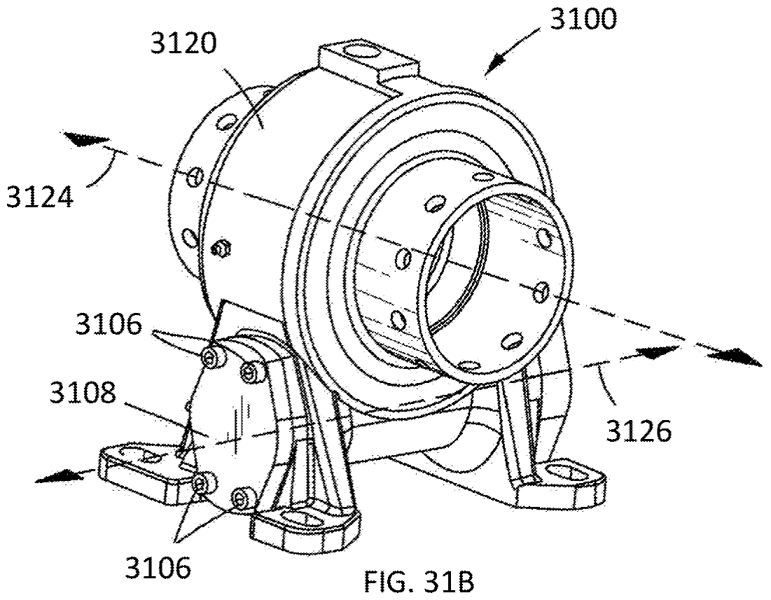

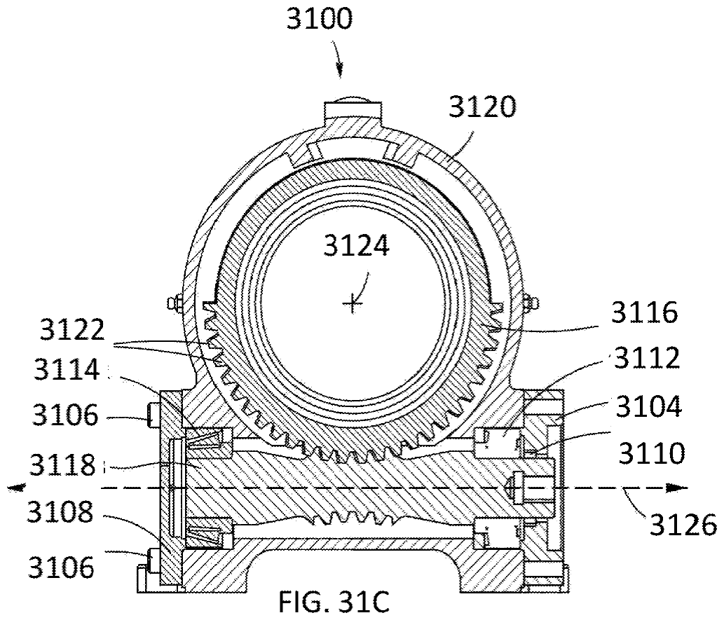

FIG. 31A depicts a left perspective view of the front side of a slew drive 3100 which includes a housing 3120 having an end plate 3104 which is secured to the housing 3120 utilizing four bolts 3102. The end plate 3104 includes a circular hole where an end section of a worm gear 3118 partially protrudes out of the hole to be driven by a reducer assembly and a motor (not shown). In some cases, slew drive 3100 can be similar to slew drive 1000 as described above and may likewise be used alongside various sensors and sensor carriers as described herein.

FIG. 31B depicts a right perspective view of the front side of the slew drive 3100 shown in FIG. 31A where a second end plate 3108 is secured to the housing 3120 using four bolts 3106. The end plates 3104 and 3108 are commonly made from steel which add considerable weight to the slew drive 3100. In addition to adding unwanted weight to the slew drive 3100, the end plates 3104 and 3108 require eight bolts, i.e., bolts 3102 and 3106, to couple with the housing 3120, adding considerable labor to the total assembly and/or disassembly of the slew drive 3100.

FIG. 31C depicts a front cross-sectional front view of the slew drive 3100 shown in FIG. 31A and FIG. 31B, where the worm gear 3118 is engaged with a worm wheel 3116. Specifically, a central threaded section of the worm gear 3118 engages worm-wheel teeth 3122 of the worm wheel 3116. The worm gear 3118 rotates along its axial axis 3126 which in turn rotates the worm wheel 3116 along its axial axis 3124. A motor and reducer assembly are used to drive the worm gear 3118 which in turn drives the worm wheel 3116. The axes 3124 and 3126 are ordinarily perpendicular but can be oriented at a different angle depending on the application.

In this configuration, two tapered roller bearings 3112 and 3114 are fitted into both ends of the housing 3120. The worm gear 3118 is fitted into the inner races of the bearings 3112 and 3114. The end plates 3104 and 3108 abut the housing 3120 and the bearings 3112 and 3114. The bolts 3102 (not visible in this cross-sectional view) and bolts 3106 are used to secure the worm gear in the axial direction while imparting an axial compressive force on the worm gear 3118 to enhance and improve teeth engagement between the worm gear 3118 and worm wheel 3116. A seal 3110 is disposed within the end plate 3104 to prevent the lubricant from exiting the housing 3120.

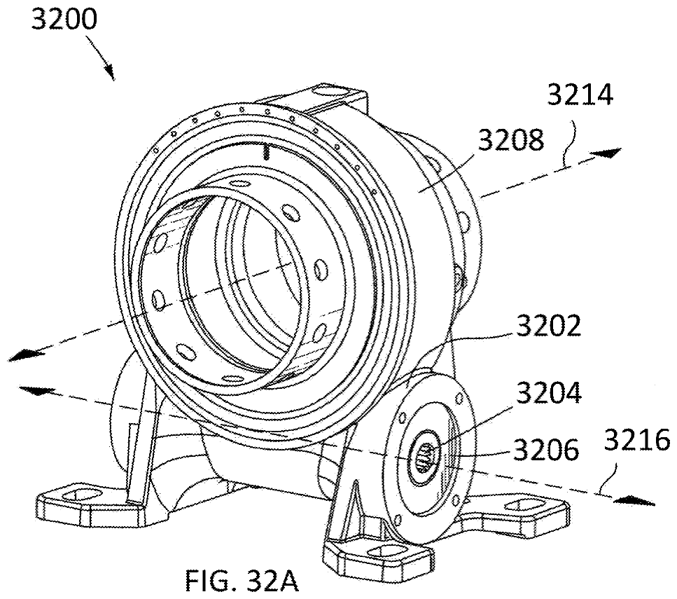

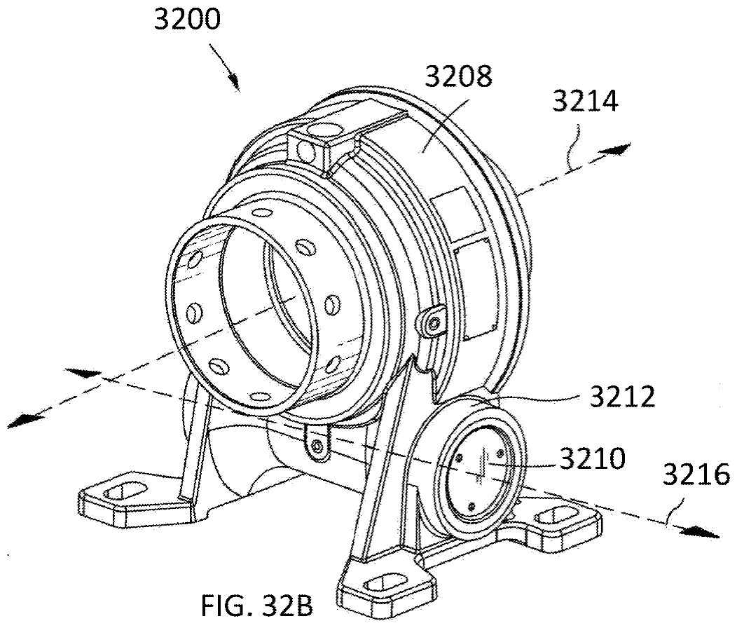

FIG. 32A depicts a left perspective view of the front side of an embodiment of an integrated slew drive 3200 illustrating a distal housing section 3202 of a housing 3208 included in the slew drive 3200. In some cases, slew drive 3200 can be similar to slew drive 1000 as described above and may likewise be used alongside various sensors and sensor carriers as described herein. A worm gear 3204 partially protrudes out of a hole that has been cut into an oil seal 3206, the latter being used to seal the lubricants within the housing 3208. Comparing the slew drive 3200 with that of the slew drive 3100, it can readily be seen that the integrated slew drive 3200 does not require an end plate such as the end plate 3104 and bolts such as the bolts 3102, used in the slew drive 3100, thereby, reducing the overall weight of the slew drive 3200 and the labor to assemble it.

FIG. 32B depicts a right perspective view of the rear side of the integrated slew drive 3200 shown in FIG. 32A. Another distal housing section 3212 of the housing 3208 of the slew drive 3200 is used to receive a threaded plug 3210. Comparison of this side of the slew drive 3200 with the corresponding side of the slew drive 3100 shows the elimination of the end plate 3108 and bolts 3106, further reducing the total weight of the slew drive 3200 and the labor required for its assembly.

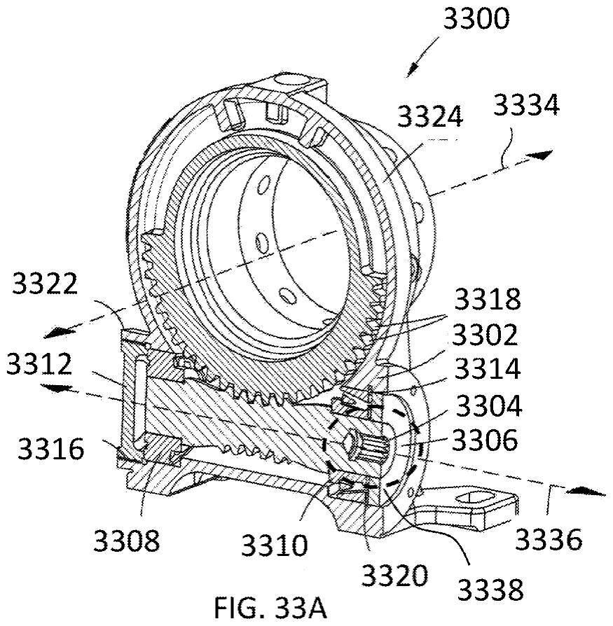

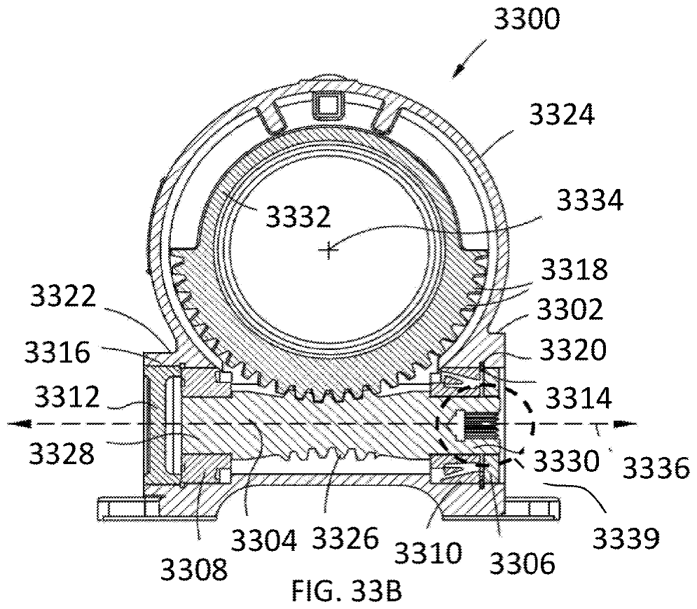

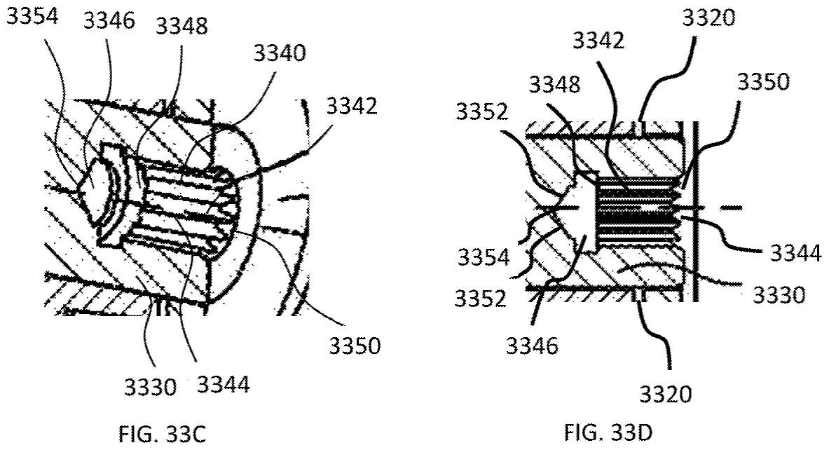

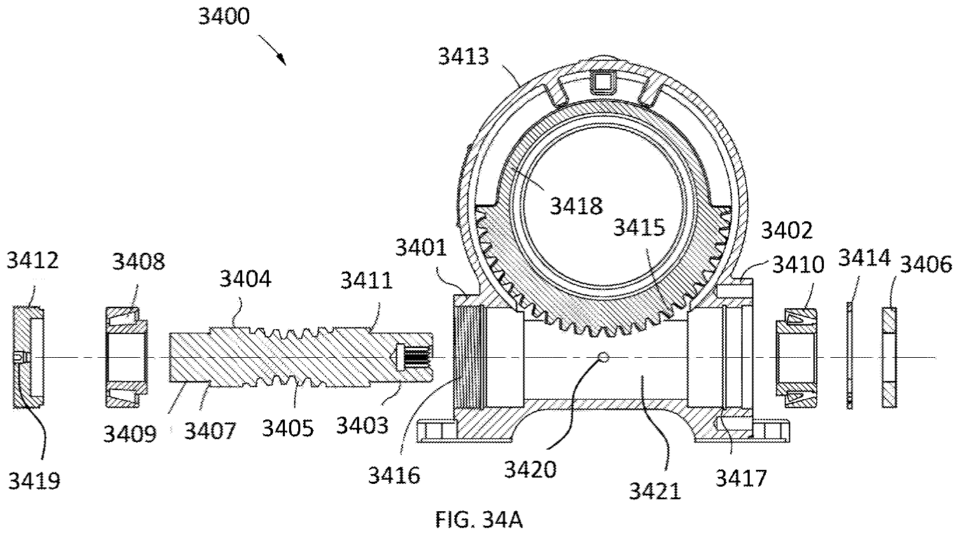

FIG. 33A depicts a left perspective cross-sectional view of an embodiment of an integrated slew drive 3300. In some cases, slew drive 3300 can be similar to slew drive 1000 as described above and may likewise be used alongside various sensors and sensor carriers as described herein. The slew drive 3300 comprises a housing 3324 which comprises a first distal housing section 3322 having a threaded section 3316. The housing 3324 further includes a second distal housing section 3302 having a groove 3320. The first distal housing section 3322 receives a threaded plug 3312 that threads into the threaded section 3316. The groove 3320 is machined into the second distal housing section 3302 to receive a retaining ring 3314. In one instance, the retaining ring 3314 is a circlip.

A worm gear 3304 can be secured to the slew drive housing 3324 by a first bearing 3308 and a second bearing 3310. The first bearing 3308 and the second bearing 3310 may be selected from a variety of bearings depending on the application. For instance, roller bearings and/or ball bearings can be utilized to secure the worm gear 3304 to the housing 3324. Roller bearings may be any one of a tapered roller bearing, a cylindrical roller bearing, a spherical roller bearing, and a needle roller bearing. Ball bearings may be any one of a deep groove ball bearing, an angular ball bearing, and a thrust ball bearing. In some embodiments, the first bearing 308 and the second bearing 3310 can both be tapered roller bearings.

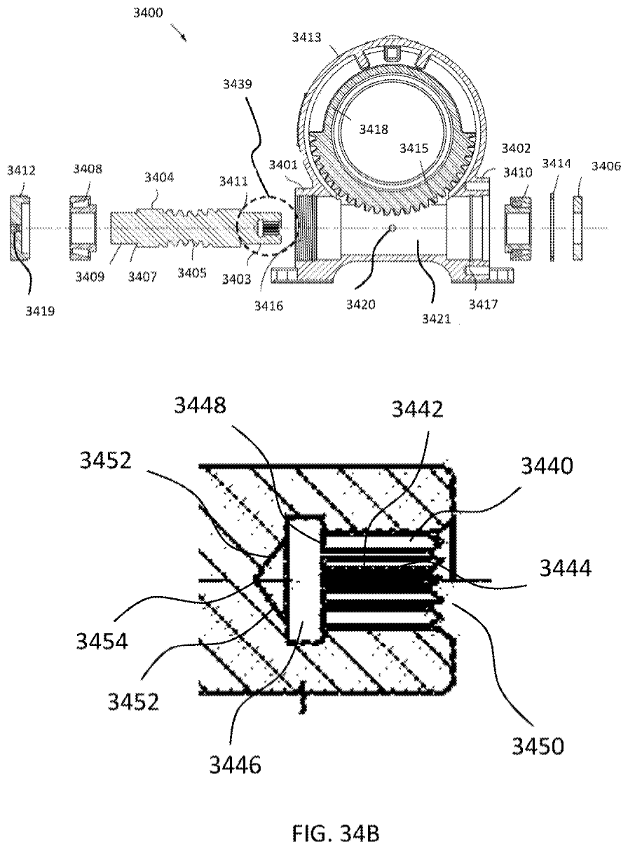

FIG. 33B depicts a front cross-sectional view of the front side of the slew drive 3300 shown in FIG. 33A. The worm gear 3304 comprises a central threaded section 3326, a first distal shaft section 3328 having a first shoulder (see FIG. 34A), and a second distal shaft section 3330 having a second shoulder (see FIG. 34A). The central threaded section 3326 of the worm gear 3304 engages worm-wheel teeth 3318 of a worm wheel 3332. The worm gear 3304 rotates around its axial axis 3336 and rotates the worm wheel 3332 around its axial axis 3334. FIG. 33C shows a magnified view of the section denoted by 3338 in FIG. 33A, and FIG. 33D shows a magnified view of the section denoted by 3339 in FIG. 33B. Referring to FIG. 33C and FIG. 33D, the second distal shaft section 3330 can include a bore 3340 having internal splines 3342. The internal splines 3342 can extend longitudinally along the bore 3340. The second distal shaft section 3330 can further comprises an interior hollow section 3346 adjacent to the bore 3340. The bore 3340 can comprise a first opening 3348 extending to the interior hollow section 3346. The bore 3340 can also comprise a second opening 3350 located at a distal end of the second distal shaft section 3330. The interior hollow section 3346 can comprise an annular cutout 3347, and a tapered portion 3351 having sloping interior sidewalls 3352. The annular cutout 3347 can be located between the tapered portion 3351 and the bore 3340. An outer diameter d1 of the annular cutout 3347 may be greater than a diameter d2 of the second opening 3350. The sloping interior sidewalls 3352 can taper inward and converge at a point 3354 located on a longitudinal central axis of the worm gear 3304. The sloping interior sidewalls 3352 can also taper outward to the annular cutout 3347. The bore 3340 and the interior hollow section 3346 can be located between the second shoulder and a distal end of the second distal shaft section. The internal splines 3342 of the bore 3340 may not extend into the interior hollow section 3346 of the second distal shaft section 3330. In some cases, the system can be configured to rotate the worm wheel 3332 around its axial axis 3334 at a rate of from 0.05 degrees per second to 0.5 degrees per second.

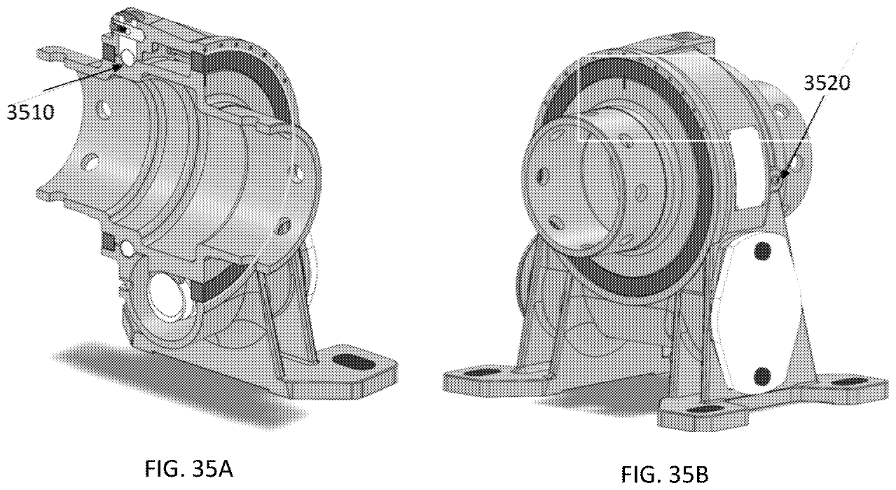

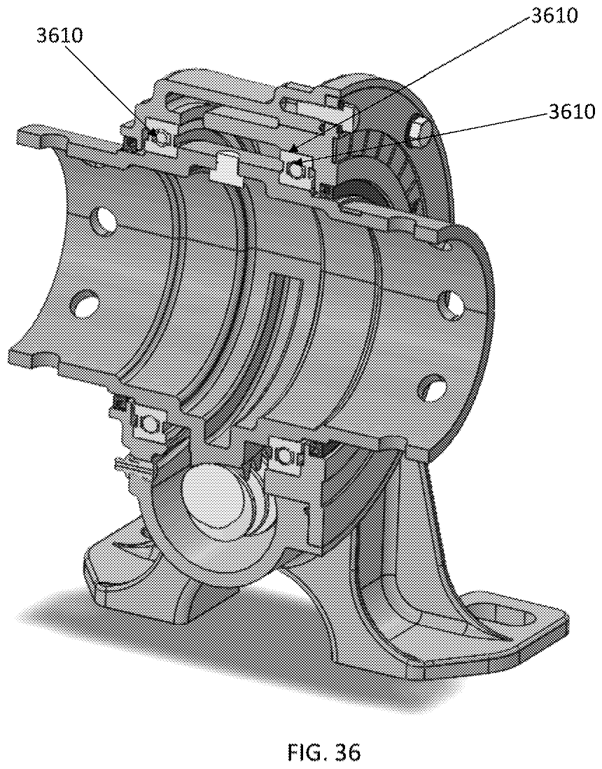

In some cases, a slew drive can utilize a single ball bearing (e.g., wherein the bottom race is integrated as part of the worm gear and the top race is part of the housing), for example, as shown in FIG. 35A. In some cases, a slew drive comprising such a ball bearing (e.g., for securing the worm gear to the slew drive housing), can also comprise a hole 3520 (e.g., a grease zerk), which can be on the exterior of the housing and may be used to add grease to the ball bearing race, e.g., as shown in FIG. 35B. In some cases, a slew drive can comprise a plurality (e.g., two) ball bearings 3510 (e.g., wherein the bottom race is integrated as part of the worm gear and the top race is part of the housing), for example, as shown in FIG. 36. In some cases, the two ball bearings 3510 can be one either side of the worm gear, e.g., as shown in FIG. 36. In some cases, a slew drive comprising a plurality of ball bearings (e.g., for securing the worm gear to the slew drive housing) can comprise a plurality of holes (e.g., for adding a lubricant to each ball bearing track).

In some cases, a slew drive can comprise a ball bearing having a raceway with a diameter of at least 100 mm, 150 mm, 200 mm, 250 mm, 300 mm, 350 mm, 400 mm, 450 mm, 500 mm, 550 mm, 600 mm, 650 mm, 700 mm, 750 mm, 800 mm, or greater than 800 mm. In some cases, a slew drive can comprise a ball bearing having a raceway with a diameter of at least 187 mm and can survive an overturning moment at least 13.5 kN-m (kilonewton-meters) and can have a survivability torque of at least 7.0 kN-m. In some cases, a slew drive can comprise a ball bearing having a raceway with a diameter of at least 229 mm and can survive an overturning moment at least 33.9 kN-m (kilonewton-meters) and can have a survivability torque of at least 39.0 kN-m. In some cases, a slew drive can comprise a ball bearing having a raceway with a diameter of at least 305 mm and can survive an overturning moment at least 54.2 kN-m (kilonewton-meters) and can have a survivability torque of at least 49.9 kN-m. In some cases, a slew drive can comprise a ball bearing having a raceway with a diameter of at least 356 mm and can survive an overturning moment at least 67.8 kN-m and can have a survivability torque of at least 54.4 kN-m. In some cases, a slew drive can comprise a ball bearing having a raceway with a diameter of at least 432 mm can survive an overturning moment at least 135.6 kN-m and can have a survivability torque of at least 65.6 kN-m. In some cases, a slew drive can comprise a ball bearing having a raceway with a diameter of at least 533 mm and can survive an overturning moment at least 203.4 kN-m and can have a survivability torque of at least 81.0 kN-m. In some cases, a slew drive can comprise a ball bearing having a raceway with a diameter of at least 635 mm can survive an overturning moment at least 271.1 kN-m and can have a survivability torque of at least 89.1 kN-m. In some cases, a slew drive can comprise a ball bearing having a raceway with a diameter of at least 711 mm can survive an overturning moment at least 457.5 kN-m and can have a survivability torque of at least 180.7 kN-m.

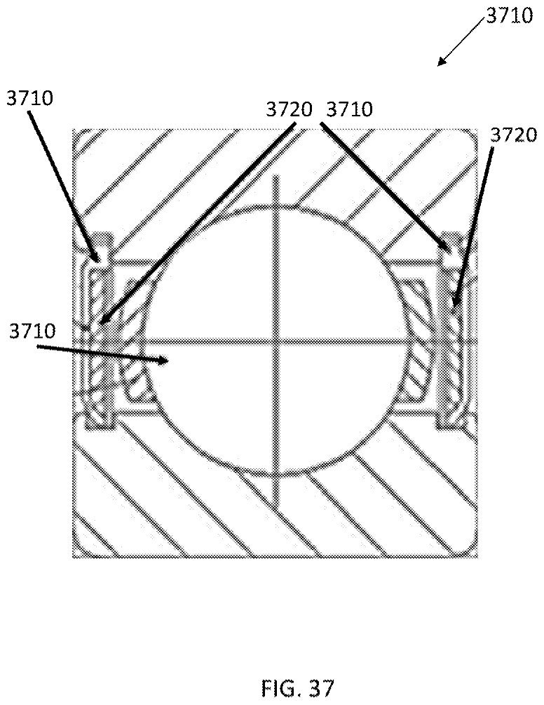

A slew drive can comprise a grease shield 3610, e.g., as shown in FIG. 37. In some cases, a grease shield 3610 can be disposed between the top and bottom races of a ball bearing 3510 (e.g., a deep groove ball bearing). A grease shield 3610 can aid in encouraging grease to stay interior to the bearing during the lifetime of the slew drive. In some cases, a grease shield can comprise one or more grease shield seals 3710. In some cases, a grease shield seal can comprise a plastic or rubber. For instance, a grease shield seal 3710 can comprise nitrile rubber (nitrile butadiene rubber, NBR), hydrogenated nitrile butadiene rubber (HNBR), and/or polyvinyl chloride (PVC). In some cases, a grease shield 3610 can comprise a rigid backing 3720, for example, to add rigidity to the seal of the grease shield. In some cases, a rigid backing 3720 can comprise a metal. In some cases, a rigid backing 3720 can be semi-rigid or flexible. In some cases, a rigid backing 3720 can be inside of the grease shield seal 3710.

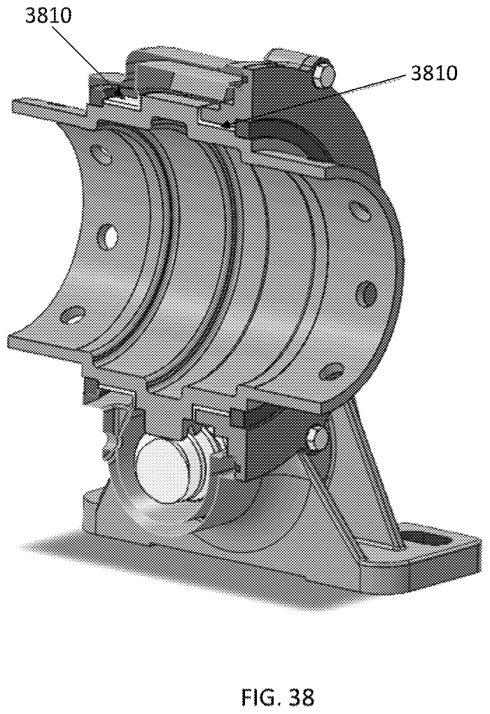

In some cases, a slew drive can comprise one or more dry bearings 3810 (e.g., as shown in FIG. 38), for instance, in place of one or more than ball bearing(s) 3510. In some cases, a dry bearing 3810 can comprise an interface track, which can allow the worm wheel to slide over an inner surface of the housing as it turns (e.g., without the need for lubrication). In some cases, a dry bearing 3810 can comprise (e.g., be made from or be coated fully or partially with) a low-friction material, such as polytetrafluoroethylene (PTFE).

The first tapered roller bearing 3308 is seated on the first distal shaft section 3328, abutting the first shoulder and the plug 3312, and the second tapered roller bearing 3310 is seated on the second distal shaft section 3330, abutting the second shoulder and the retaining ring 3314. The first tapered roller bearing 3308 may be seated on the first distal shaft section 3328 via a variety of fits, such as a clearance fit, a transition fit, and an interference fit. Similarly, the second tapered roller bearing 3310 may be seated on the first distal shaft section 3328 via a variety of fits, such as a clearance fit, a transition fit, and an interference fit. In some cases, incorporation of roller bearing(s) (e.g., tapered roller bearing(s) and/or ball bearing(s)) in a slew drive can aid in improving driveline efficiency of the slew drive. A seal, such as an oil seal, 3306 is seated on the second distal shaft section 3330, abutting the retaining ring 3314 to prevent lubricant from exiting the housing 3324. In some cases, controlling the seal outer diameter relative to the housing inner diameter can help to prevent lubricant leakage, especially in slew drives comprising oil lubricant. In some cases, the tolerance on a seal outer diameter and a mating housing inner diameter can be Φ80(+0.35/+0.2)/Φ80(+0.046/0). In some cases, these surfaces may be unpainted (e.g., bare metal), for example, to help preserve lifetime seal performance. In some cases, controlling the roughness of the worm gear can help to prevent lubricant leakage. In some cases, roughness of the worm is controlled to a range of 0.1 to 0.7, 0.15 to 0.65, or 0.2 to 0.6 (e.g., wherein Ra is the arithmetic average of the absolute values of the profile height deviations from the mean line).

As the threaded plug 3312 is rotated in engagement with the threaded section 3316 of the first distal housing section 3322 of the housing 3324, an axial compressive force is exerted upon the worm gear 3304 through the first tapered roller bearing 3308 to ensure improved engagement between the thread section 3326 of the worm gear 3304 and the worm-wheel teeth 3318 of the worm wheel 3332. The retaining ring 3314 exerts the same magnitude compressive force on the worm gear 3304 but in the opposite direction through the second tapered roller bearing 3310. In some cases, an amount of compression exerted on the worm gear 3118 (e.g., by the tapered roller bearing(s) of the slew drive) can be adjusted by loosening or tightening an end plate, plug, or bolts of the slew drive. In some embodiments, a level of compression on the worm gear 3118 can be achieved by adjusting the fit (e.g., tightness) of an end plate, plug, or bolts of a slew drive to result in a non-loaded starting torque to rotate the worm gear of from 1 N-m to 12 N-m, from 2 N-m to 11 N-m, from 3 N-m to 10 N-m, or within a range greater than 3 N-m and less than 10 N-m.

FIG. 34A depicts an exploded cross-sectional view of an embodiment of an integrated slew drive 3400. In some cases, slew drive 3400 can be similar to slew drive 1000 as described above and may likewise be used alongside various sensors and sensor carriers as described herein. The slew drive 3400 comprises a housing 3413 which includes a first distal housing section 3401 having a threaded section 3416. The housing 3413 further includes a second distal housing section 3402 which includes a groove 3417.

The slew drive 3400 further comprises a threaded plug 3412 and a retaining ring 414. The first distal housing section 3401 receives the threaded plug 3412 that threads into the threaded section 3416. The retaining ring 3414 is disposed in the groove 3417. The slew drive 400 further comprises a worm gear 3404. The worm gear 3404 comprises a central threaded section 3405, a first distal shaft section 3409 having a first shoulder 3407, and a second distal shaft section 3403 having a second shoulder 3411. The slew drive 3400 further comprises a first tapered roller bearing 3408 and a second tapered roller bearing 3410. The worm gear 3404 is secured to the housing 3413 by the first tapered roller bearing 3408 and the second tapered roller bearing 3410. The first tapered roller bearing 3408 is seated on the first distal shaft section 3409, abutting the first shoulder 3407 and the plug 3412. The second tapered roller bearing 3410 is seated on the second distal shaft section 3403, abutting the second shoulder 3411 and the retaining ring 3414. FIG. 34B shows a magnified view of the section denoted by 439 in FIG. 34A. Referring to FIG. 34B, the second distal shaft section 3403 can include a bore 3440 having internal splines 3442. The internal splines 3442 can extend longitudinally along the bore 3440. In some cases, the second distal shaft section 3403 can comprise grooves 3444. The second distal shaft section 3403 can further comprise an interior hollow section 3446 adjacent to the bore 3440. The bore 3440 can comprise a first opening 3448 extending to the interior hollow section 3446. The bore 3440 also can comprise a second opening 3450 located at a distal end of the second distal shaft section 3403. The interior hollow section 3446 can comprise an annular cutout 3447, and a tapered portion 3451 having sloping interior sidewalls 3452. The annular cutout 3447 can be located between the tapered portion 3451 and the bore 3440. An outer diameter d1 of the annular cutout 3447 can be greater than a diameter d2 of the second opening 3450. The sloping interior sidewalls 3452 can taper inward and converge at a point 3454 located on a longitudinal central axis of the worm gear 3404. The sloping interior sidewalls 3452 can also taper outward to the annular cutout 3447. The bore 3440 and the interior hollow section 3446 can be located between the second shoulder 3411 and a distal end of the second distal shaft section 3403. The internal splines 3442 of the bore 3440 may not extend into the interior hollow section 3446 of the second distal shaft section 3403.

The slew drive 3400 further comprises a worm wheel 3418 having worm-wheel teeth 3415. The central threaded section 3405 of the worm gear 3404 engages the worm-wheel teeth 3415 of the worm wheel 3418. As the threaded plug 3412 is rotated in engagement with the threaded section 3416 of the first distal housing section 3401 of the housing 3413, an axial compressive force is exerted upon, the worm gear 3404 ensuring improved engagement between the threaded section 3405 of the worm gear 3404 and the worm-wheel teeth 3415 of the worm wheel 3418. The slew drive 3400 further comprises an oil seal 3406 which is seated on the second distal shaft section 3403 and abutting the retaining ring 3414 to prevent lubricant from exiting the housing 3413.

In some embodiments, the retaining ring 3414 is disposed in the groove 3417 and the second tapered roller bearing 3410 is disposed within the second distal housing section 3402 and to the left of the retaining ring 3417. In one instance, an interference fit is used to dispose the second tapered roller bearing 3410 within the second distal housing section 3402. The worm gear 3404 is inserted in the inner race of the second tapered roller bearing 3410 such that the second tapered roller bearing 3410 is seated on the second distal shaft section 3403 and abutting the second shoulder 3411. The first tapered roller bearing 3408 is then seated on the first distal shaft section 3409 until it abuts the first shoulder 3407. The worm wheel 3418 is then disposed within the housing 3413 and engages the threaded section 3405 of the worm gear 3404. The oil seal 3406 is then seated on the second distal shaft section 3403 abutting the retaining ring 3414 so as to prevent lubricant from exiting the housing 3413. The plug 3412 is then inserted into the first distal housing section 3401 and rotated in engagement with the threaded section 3416 to impart an axial compressive force upon the worm gear 3404 to improve engagement between the threaded section 3405 of the worm gear 3404 and the worm-wheel teeth 3415 of the worm wheel 3418.

In some cases, a slew drive can utilize a single ball bearing (e.g., wherein the bottom race is integrated as part of the worm gear and the top race is part of the housing), for example, as shown in FIG. 35A. In some cases, a slew drive comprising such a ball bearing (e.g., for securing the worm gear to the slew drive housing), can also comprise a hole 3520 (e.g., a grease zerk), which can be on the exterior of the housing and may be used to add grease to the ball bearing race, e.g., as shown in FIG. 35B. In some cases, a slew drive can comprise a plurality (e.g., two) ball bearings 3510 (e.g., wherein the bottom race is integrated as part of the worm gear and the top race is part of the housing), for example, as shown in FIG. 36. In some cases, the two ball bearings 3510 can be one either side of the worm gear, e.g., as shown in FIG. 36. In some cases, a slew drive comprising a plurality of ball bearings (e.g., for securing the worm gear to the slew drive housing) can comprise a plurality of holes (e.g., for adding a lubricant to each ball bearing track).

In some cases, a slew drive can comprise a ball bearing having a raceway with a diameter of at least 187 mm and can survive an overturning moment at least 13.5 kN-m (kilonewton-meters) and can have a survivability torque of at least 7.0 kN-m. In some cases, a slew drive can comprise a ball bearing having a raceway with a diameter of at least 229 mm and can survive an overturning moment at least 33.9 kN-m (kilonewton-meters) and can have a survivability torque of at least 39.0 kN-m. In some cases, a slew drive can comprise a ball bearing having a raceway with a diameter of at least 305 mm and can survive an overturning moment at least 54.2 kN-m (kilonewton-meters) and can have a survivability torque of at least 49.9 kN-m. In some cases, a slew drive can comprise a ball bearing having a raceway with a diameter of at least 356 mm and can survive an overturning moment at least 67.8 kN-m and can have a survivability torque of at least 54.4 kN-m. In some cases, a slew drive can comprise a ball bearing having a raceway with a diameter of at least 432 mm can survive an overturning moment at least 135.6 kN-m and can have a survivability torque of at least 65.6 kN-m. In some cases, a slew drive can comprise a ball bearing having a raceway with a diameter of at least 533 mm and can survive an overturning moment at least 203.4 kN-m and can have a survivability torque of at least 81.0 kN-m. In some cases, a slew drive can comprise a ball bearing having a raceway with a diameter of at least 635 mm can survive an overturning moment at least 271.1 kN-m and can have a survivability torque of at least 89.1 kN-m. In some cases, a slew drive can comprise a ball bearing having a raceway with a diameter of at least 711 mm can survive an overturning moment at least 457.5 kN-m and can have a survivability torque of at least 180.7 kN-m.

A slew drive can comprise a grease shield 3610, e.g., as shown in FIG. 37. In some cases, a grease shield 3610 can be disposed between the top and bottom races of a ball bearing 3510 (e.g., a deep groove ball bearing). A grease shield 3610 can aid in encouraging grease to stay interior to the bearing during the lifetime of the slew drive. In some cases, a grease shield can comprise one or more grease shield seals 3710. In some cases, a grease shield seal can comprise a plastic or rubber. For instance, a grease shield seal 3710 can comprise nitrile rubber (nitrile butadiene rubber, NBR), hydrogenated nitrile butadiene rubber (HNBR), and/or polyvinyl chloride (PVC). In some cases, a grease shield 3610 can comprise a rigid backing 3720, for example, to add rigidity to the seal of the grease shield. In some cases, a rigid backing 3720 can comprise a metal. In some cases, a rigid backing 3720 can be semi-rigid or flexible. In some cases, a rigid backing 3720 can be inside of the grease shield seal 3710.

In some cases, a slew drive can comprise one or more dry bearings 3810 (e.g., as shown in FIG. 38), for instance, in place of one or more than ball bearing(s) 3510. In some cases, a dry bearing 3810 can comprise an interface track, which can allow the worm wheel to slide over an inner surface of the housing as it turns (e.g., without the need for lubrication). In some cases, a dry bearing 3810 can comprise (e.g., be made from or be coated fully or partially with) a low-friction material, such as polytetrafluoroethylene (PTFE).

In some cases, slew drive 3400 can comprise one or more holes, e.g., for adding a lubricant. In some cases, plug 3412 can comprise a hole 3419, e.g., for adding a lubricant. For example, a plug 3412 can comprise a hole 3419 on a distal end surface of the plug 3412, as shown in FIG. 34A. In some cases, a hole 3420 can be located in a side wall of a worm housing shaft 3421 portion of housing 3413, for example, as shown in FIG. 34A. Inclusion of hole 3419 and hole 3420 in a slew drive 3400 can allow more complete and even lubrication of the worm gear 3404 within the housing 3413. In some cases, inclusion of a plurality of holes (e.g., 3419 and 3420) in a slew drive 3400 can allow targeted lubrication of the system, for example, if a first hole of the plurality of holes is spatially separated from a second hole of the plurality of holes (e.g., as shown in FIG. 34A, see hole 3419 and hole 3420).

In some cases, the lubricant can be oil. In some cases, oil can be added to a slew drive via a hole, e.g., in the housing such as hole 3420 or in a plug 3412, as shown in FIG. 34A. In some cases, a hole (e.g., hole 3419 and/or hole 3420) can comprise an oil fill plug. In some cases, inclusion of oil in a slew drive can render more than one lubricant hole unnecessary. For example, hole 3419 may be omitted from a slew drive 3400 when an oil is used as a lubricant for the slew drive 3400 (e.g., wherein the oil can be added through a single hole, such as hold 3420). In some cases, a slew drive described herein can be configured such that the same oil used to lubricate the worm/gear interface also lubricates the roller bearings.

In some cases, the lubricant can be a grease. In some cases, for example in systems wherein the lubricant is a grease), a hole of a slew drive 3400 (e.g., hole 3419 and/or hole 3420) can comprise a grease zerk. In some cases, a grease can be EP2 grade grease. In some cases, a grease useful in a slew drive 3400 can be a synthetic grease. A grease useful in a slew drive 3400 can be synthetic NLGI grade #00, #0, #1, or #2. In some cases, inclusion of a NLGI (National Lubricating Grease Institute) grade #0 synthetic grease can offer improvement to wear on the slew drive 3400 and/or one or more of its components, for example, compared to the use of a regular grease (e.g., such as Mobil™ SHC 3100 grease). In some cases, use of a grade #0 synthetic grease can increase relative drive-line performance efficiency by from 1% to 30%, from 5% to 25%, from 10% to 25%, from 15% to 25%, or from 15% to 20%. In some cases, use of a grade #0 synthetic grease in a slew drive 3400 can increase relative drive-line performance efficiency by at least 1%, at least 5%, at least 10%, at least 15%, at least 20%, at least 25%, or at least 30%. In some cases, use of a grade #0 grease in a slew drive 3400 can reduce gear wear by from 1% to 70%, from 1% to 66%, from 5% to 66%, from 10% to 66%, from 15% to 66%, from 20% to 66%, from 25% to 66%, from 30% to 66%, from 35% to 66%, from 40% to 66%, from 45% to 66%, from 50% to 66%, from 55% to 66%, from 60% to 66%, or from 65% to 66%. In some cases, use of a grade #0 grease in a slew drive 3400 can reduce gear wear by up to 50%, up to 55%, up to 60%, up to 65%, up to 66%, or up to 70%.

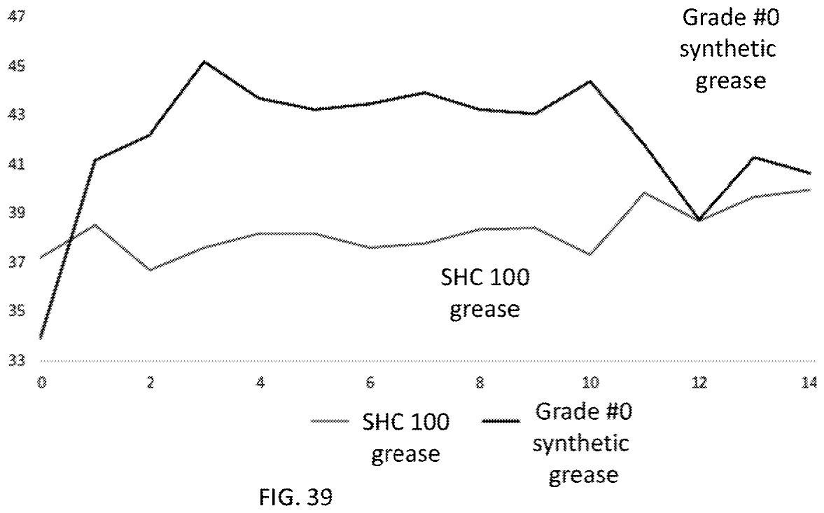

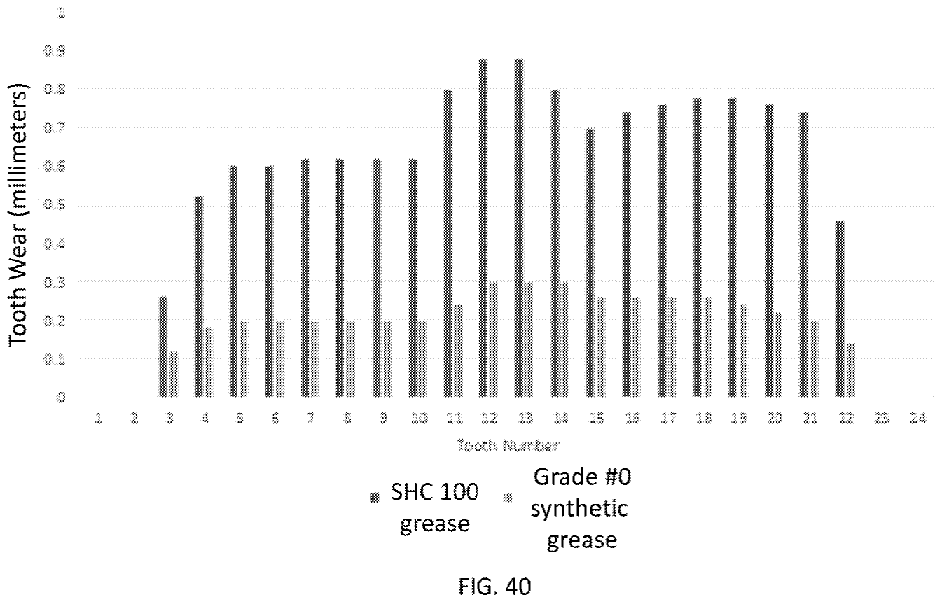

In some cases, use of a NLGI grade #0 synthetic grease can improve drive efficiency, for example, as tested in an accelerate pendulum test. Results from an accelerate pendulum test in which a torque (max 1200 Newton-meters (N-m)) is placed on a slew drive, and the slew drive is run at 0.1 revolutions per minute (RPM) output gear speed in an accelerated fashion are shown in FIG. 39. In particular, accelerate pendulum testing protocol used to obtain data shown in FIG. 39 was: cycle time: 468 seconds(s), (run time: 408 s and stop time: 60 s); oriented in vertical position (0 degree) at start, rotate to negative 60 degrees for 102 s, stop for 30 seconds, rotate to positive 60 degrees for 204 seconds, stop for 30 seconds, rotate to 0 degree position for 102 seconds; drive efficiency was measured every 1,000 cycles. Data shows that slew drives comprising grade #0 synthetic grease consistently improved drive efficiency compared to slew drive systems comprising SHC 3100 grease. Analysis of slew drive wear, measured by disassembling tested slew drives at the end of testing and measuring tooth wear, showed that slew drive systems comprising grade #0 synthetic grease also showed decreased tooth wear compared to systems comprising SHC 3100 grease (FIG. 40).

In some cases, the slew drive is configured to rotate a telecommunications assembly or solar tracker assembly. For example, a slew drive described herein can be used to rotate a telecommunication dish assembly or solar tracker assembly (e.g., in a plane perpendicular to an axial axis of the worm gear 3604). In some cases, rotating the worm gear 3604 can cause a telecommunications assembly or solar tracker assembly (e.g., comprising a telecommunication dish, such as a telecommunication dish that is from 1 kilograms (kg) to 5 kg, 5 kg to 10 kg, 10 kg to 100 kg, from 100 kg to 1,000 kg, from 1,000 kg to 5,000 kg, from 1 kg to 10 kg, from 1 kg to 1,000 kg, from 1 kg to 3,000 kg, or at least 3,000 kg) to rotate in a plane perpendicular to an axial axis of the worm gear 3604. In some cases, a slew drive is configured to support and/or be coupled to a component selected from: a satellite dish, a satellite array, a solar array, a bracket or support (e.g., such as a satellite dish bracket/support or a solar array bracket or support), a crane arm, a lift (e.g., a bucket lift arm), a positioner arm, a robotic arm, a medical imaging device (e.g., an X-ray machine, a mammography machine, or a CT scanner), or an adjustable bed, such as a hospital bed.

In some cases, a slew drive disclosed herein can support an axial load of 1 N (newton) to 1 kN (kilonewtons), 1 kN to 5 kN, 5 kN to 10 kN, 10 kN to 15 kN, 15 kN to 20 kN, 20 kN to 25 kN, 25 kN to 30 kN, or more than 30 kN. In some cases, a slew drive disclosed herein can support an axial load of less than 1 N, at least 1 N, at least 1 kN, at least 5 kN, at least 10 kN, at least 15 kN, at least 20 kN, at least 25 kN, or at least 30 kN.

In some cases, a slew drive disclosed herein can sustain a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, 2,000 N-m to 2,500 N-m, 2,500 N-m to 3,000 N-m, 3,000-N-m to 3,500 N-m, or more than 3,500 N-m. In some cases, a slew drive disclosed herein can sustain a tilting torque (e.g., without failure or overturning) of at least 1 N-m, at least 500 N-m, at least 1,000 N-m, at least 1,500 N-m, at least 2,000 N-m, at least 2,500 N-m, at least 3,000 N-m, or at least 3,500 N-m.

In some cases, a slew drive disclosed herein can sustain a tilting torque (e.g., without failure or overturning) of from about 1 kN-M (kilo newton-meter) to about 14 kN-M. In some cases, a slew drive disclosed herein can sustain a tilting torque (e.g., without failure or overturning) of from about 1 kN-M to about 2 kN-M, about 1 kN-M to about 4 kN-M, about 1 kN-M to about 6 kN-M, about 1 kN-M to about 8 kN-M, about 1 kN-M to about 10 kN-M, about 1 kN-M to about 12 kN-M, about 1 kN-M to about 14 kN-M, about 2 kN-M to about 4 kN-M, about 2 kN-M to about 6 kN-M, about 2 kN-M to about 8 kN-M, about 2 kN-M to about 10 kN-M, about 2 kN-M to about 12 kN-M, about 2 kN-M to about 14 kN-M, about 4 kN-M to about 6 kN-M, about 4 kN-M to about 8 kN-M, about 4 kN-M to about 10 kN-M, about 4 kN-M to about 12 kN-M, about 4 kN-M to about 14 kN-M, about 6 kN-M to about 8 kN-M, about 6 kN-M to about 10 kN-M, about 6 kN-M to about 12 kN-M, about 6 kN-M to about 14 kN-M, about 8 kN-M to about 10 kN-M, about 8 kN-M to about 12 kN-M, about 8 kN-M to about 14 kN-M, about 10 kN-M to about 12 kN-M, about 10 kN-M to about 14 kN-M, or about 12 kN-M to about 14 kN-M. In some cases, a slew drive disclosed herein can sustain a tilting torque (e.g., without failure or overturning) of about 1 kN-M, about 2 kN-M, about 4 kN-M, about 6 kN-M, about 8 kN-M, about 10 kN-M, about 12 kN-M, or about 14 kN-M. In some cases, a slew drive disclosed herein can sustain a tilting torque (e.g., without failure or overturning) of at least about 1 kN-M, about 2 kN-M, about 4 kN-M, about 6 kN-M, about 8 kN-M, about 10 kN-M, or about 12 kN-M. In some cases, a slew drive disclosed herein can sustain a tilting torque (e.g., without failure or overturning) of at most about 2 kN-M, about 4 kN-M, about 6 kN-M, about 8 kN-M, about 10 kN-M, about 12 kN-M, or about 14 kN-M.

In some cases, a slew drive disclosed herein can support an axial load of at least 1 N while sustaining a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, 2,000 N-m to 2,500 N-m, 2,500 N-m to 3,000 N-m, 3,000-N-m to 3,500 N-m, or more than 3,500 N-m. In some cases, a slew drive disclosed herein can support an axial load of at least 1 kN while sustaining a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, 2,000 N-m to 2,500 N-m, 2,500 N-m to 3,000 N-m, 3,000-N-m to 3,500 N-m, at least 3,500 N-m, or more than 3,500 N-m. In some cases, a slew drive disclosed herein can support an axial load of at least 5 kN while sustaining a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, 2,000 N-m to 2,500 N-m, 2,500 N-m to 3,000 N-m, 3,000-N-m to 3,500 N-m, or at least 3,000 N-m. In some cases, a slew drive disclosed herein can support an axial load of at least 10 kN while sustaining a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, 2,000 N-m to 2,500 N-m, up to 2,500 N-m, or at least 2,500 N-m. In some cases, a slew drive disclosed herein can support an axial load of at least 15 kN while sustaining a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, or at least 1,500 N-m. In some cases, a slew drive disclosed herein can support an axial load of at least 20 kN while sustaining a tilting torque (e.g., without failure or overturning) of 1 N-m (newton-meter) to 500 N-m, 500 N-m to 1,000 N-m, 1,000 N-m to 1,500 N-m, or at least 1,000 N-m. In some cases, a slew drive disclosed herein can support an axial load of at least 25 kN while sustaining a tilting torque (e.g., without failure or overturning) of 1 N-m (newton-meter) to 500 N-m, 500 N-m to 1,000 N-m, up to 500 N-m, or at least 500 N-m.

In some cases, a slew drive disclosed herein can support an axial load of from about 1 kN to about 100 kN. In some cases, a slew drive disclosed herein can support an axial load of from about 1 kN to about 10 kN, about 1 kN to about 20 kN, about 1 kN to about 30 kN, about 1 kN to about 40 kN, about 1 kN to about 50 kN, about 1 kN to about 60 kN, about 1 kN to about 70 kN, about 1 kN to about 80 kN, about 1 kN to about 90 kN, about 1 kN to about 100 kN, about 10 kN to about 20 kN, about 10 kN to about 30 kN, about 10 kN to about 40 kN, about 10 kN to about 50 kN, about 10 kN to about 60 kN, about 10 kN to about 70 kN, about 10 kN to about 80 kN, about 10 kN to about 90 kN, about 10 kN to about 100 kN, about 20 kN to about 30 kN, about 20 kN to about 40 kN, about 20 kN to about 50 kN, about 20 kN to about 60 kN, about 20 kN to about 70 kN, about 20 kN to about 80 kN, about 20 kN to about 90 kN, about 20 kN to about 100 kN, about 30 kN to about 40 kN, about 30 kN to about 50 kN, about 30 kN to about 60 kN, about 30 kN to about 70 kN, about 30 kN to about 80 kN, about 30 kN to about 90 kN, about 30 kN to about 100 kN, about 40 kN to about 50 kN, about 40 kN to about 60 kN, about 40 kN to about 70 kN, about 40 kN to about 80 kN, about 40 kN to about 90 kN, about 40 kN to about 100 kN, about 50 kN to about 60 kN, about 50 kN to about 70 kN, about 50 kN to about 80 kN, about 50 kN to about 90 kN, about 50 kN to about 100 kN, about 60 kN to about 70 kN, about 60 kN to about 80 kN, about 60 kN to about 90 kN, about 60 kN to about 100 kN, about 70 kN to about 80 kN, about 70 kN to about 90 kN, about 70 kN to about 100 kN, about 80 kN to about 90 kN, about 80 kN to about 100 kN, or about 90 kN to about 100 kN. In some cases, a slew drive disclosed herein can support an axial load of about 1 kN, about 10 kN, about 20 kN, about 30 kN, about 40 kN, about 50 kN, about 60 kN, about 70 kN, about 80 kN, about 90 kN, or about 100 kN. In some cases, a slew drive disclosed herein can support an axial load of at least about 1 kN, about 10 kN, about 20 kN, about 30 kN, about 40 kN, about 50 kN, about 60 kN, about 70 kN, about 80 kN, or about 90 kN. In some cases, a slew drive disclosed herein can support an axial load of at most about 10 kN, about 20 kN, about 30 kN, about 40 kN, about 50 kN, about 60 kN, about 70 kN, about 80 kN, about 90 kN, or about 100 kN.

The slew drive may have a dynamic (moving) nominal torque capacity. The nominal torque capacity can comprise a torque experienced by the slew drive in the radial X direction, whereas tilting torque can refer to torque experienced by the slew drive in the radial Z direction, radial Y direction, or both. The dynamic nominal torque capacity can be from about 1 kN-m to about 5 kN-m. The dynamic nominal torque capacity can be from about 1 kN-m to about 2 kN-m, about 1 kN-m to about 3 kN-m, about 1 kN-m to about 4 kN-m, about 1 kN-m to about 5 kN-m, about 2 kN-m to about 3 kN-m, about 2 kN-m to about 4 kN-m, about 2 kN-m to about 5 kN-m, about 3 kN-m to about 4 kN-m, about 3 kN-m to about 5 kN-m, or about 4 kN-m to about 5 kN-m. The dynamic nominal torque capacity can be about 1 kN-m, about 2 kN-m, about 3 kN-m, about 4 kN-m, or about 5 kN-m. The dynamic nominal torque capacity can be at least about 1 kN-m, about 2 kN-m, about 3 kN-m, or about 4 kN-m. The dynamic nominal torque capacity can be at most about 2 kN-m, about 3 kN-m, about 4 kN-m, or about 5 kN-m.

In some cases, the dynamic torque capacity can be larger. In some cases, the dynamic torque capacity can be from about 2 kN-m to about 18 kN-m. In some cases, the dynamic torque capacity can be from about 2 kN-m to about 4 kN-m, about 2 kN-m to about 6 kN-m, about 2 kN-m to about 8 kN-m, about 2 kN-m to about 10 kN-m, about 2 kN-m to about 12 kN-m, about 2 kN-m to about 14 kN-m, about 2 kN-m to about 16 kN-m, about 2 kN-m to about 18 kN-m, about 4 kN-m to about 6 kN-m, about 4 kN-m to about 8 kN-m, about 4 kN-m to about 10 kN-m, about 4 kN-m to about 12 kN-m, about 4 kN-m to about 14 kN-m, about 4 kN-m to about 16 kN-m, about 4 kN-m to about 18 kN-m, about 6 kN-m to about 8 kN-m, about 6 kN-m to about 10 kN-m, about 6 kN-m to about 12 kN-m, about 6 kN-m to about 14 kN-m, about 6 kN-m to about 16 kN-m, about 6 kN-m to about 18 kN-m, about 8 kN-m to about 10 kN-m, about 8 kN-m to about 12 kN-m, about 8 kN-m to about 14 kN-m, about 8 kN-m to about 16 kN-m, about 8 kN-m to about 18 kN-m, about 10 kN-m to about 12 kN-m, about 10 kN-m to about 14 kN-m, about 10 kN-m to about 16 kN-m, about 10 kN-m to about 18 kN-m, about 12 kN-m to about 14 kN-m, about 12 kN-m to about 16 kN-m, about 12 kN-m to about 18 kN-m, about 14 kN-m to about 16 kN-m, about 14 kN-m to about 18 kN-m, or about 16 kN-m to about 18 kN-m. In some cases, the dynamic torque capacity can be about 2 kN-m, about 4 kN-m, about 6 kN-m, about 8 kN-m, about 10 kN-m, about 12 kN-m, about 14 kN-m, about 16 kN-m, or about 18 kN-m. In some cases, the dynamic torque capacity can be at least about 2 kN-m, about 4 kN-m, about 6 kN-m, about 8 kN-m, about 10 kN-m, about 12 kN-m, about 14 kN-m, or about 16 kN-m. In some cases, the dynamic torque capacity can be at most about 4 kN-m, about 6 kN-m, about 8 kN-m, about 10 kN-m, about 12 kN-m, about 14 kN-m, about 16 kN-m, or about 18 kN-m.

The slew drive may have an ultimate static torque capacity, beyond which the drive fails physically. This can be the maximum capacity in any vector application of torque (e.g., overturning, axial, etc.). This can also be called a backwards holding torque (BHT). The BHT can be the torque value axially applied at which severe failure (e.g., worm thread shear, gear thread shear, housing fracture, etc.) may be expected to occur. The BHT can comprise a torque experienced by the slew drive in the radial X direction. The static torque capacity can be from about 1 kN-m to about 38 kN-m. The static torque capacity can be from about 1 kN-m to about 2 kN-m, about 1 kN-m to about 5 kN-m, about 1 kN-m to about 10 kN-m, about 1 kN-m to about 15 kN-m, about 1 kN-m to about 20 kN-m, about 1 kN-m to about 25 kN-m, about 1 kN-m to about 30 kN-m, about 1 kN-m to about 35 kN-m, about 1 kN-m to about 38 kN-m, about 2 kN-m to about 5 kN-m, about 2 kN-m to about 10 kN-m, about 2 kN-m to about 15 kN-m, about 2 kN-m to about 20 kN-m, about 2 kN-m to about 25 kN-m, about 2 kN-m to about 30 kN-m, about 2kN-m to about 35 kN-m, about 2 kN-m to about 38 kN-m, about 5 kN-m to about 10 kN-m, about 5 kN-m to about 15 kN-m, about 5 kN-m to about 20 kN-m, about 5 kN-m to about 25 kN-m, about 5 kN-m to about 30 kN-m, about 5 kN-m to about 35 kN-m, about 5 kN-m to about 38 kN-m, about 10 kN-m to about 15 kN-m, about 10 kN-m to about 20 kN-m, about 10 kN-m to about 25 kN-m, about 10 kN-m to about 30 kN-m, about 10 kN-m to about 35 kN-m, about 10 kN-m to about 38 kN-m, about 15 kN-m to about 20 kN-m, about 15 kN-m to about 25 kN-m, about 15 kN-m to about 30 kN-m, about 15 kN-m to about 35 kN-m, about 15 kN-m to about 38 kN-m, about 20 kN-m to about 25 kN-m, about 20 kN-m to about 30 kN-m, about 20 kN-m to about 35 kN-m, about 20 kN-m to about 38 kN-m, about 25 kN-m to about 30 kN-m, about 25 kN-m to about 35 kN-m, about 25 kN-m to about 38 kN-m, about 30 kN-m to about 35 kN-m, about 30 kN-m to about 38 kN-m, or about 35 kN-m to about 38 kN-m. The static torque capacity can be about 1 kN-m, about 2 kN-m, about 5 kN-m, about 10 kN-m, about 15 kN-m, about 20 kN-m, about 25 kN-m, about 30 kN-m, about 35 kN-m, or about 38 kN-m. The static torque capacity can be at least about 1 kN-m, about 2 kN-m, about 5 kN-m, about 10 kN-m, about 15 kN-m, about 20 kN-m, about 25 kN-m, about 30 kN-m, or about 35 kN-m. The static torque capacity can be at most about 2 kN-m, about 5 kN-m, about 10 kN-m, about 15 kN-m, about 20 kN-m, about 25 kN-m, about 30 kN-m, about 35 kN-m, or about 38 kN-m.

Tiling torque can be sustained through the bearings around the center gear and the housing. Nominal torque and BHT can be sustained through one or more of the gear and the worm mesh, the worm bearings, the gear bearings, or the housing.

There can be an inverse relationship between tilting torque (kN-M) and axial load (kN). In some cases, there can be an axial load of about 0 kN when the tilting torque is at a maximum. In some cases, there can be a tilting torque of about 0 when the axial load is at a maximum of about 100 kN.

The worm gear can be coupled to and driven by an input power system. Examples of the input power system can include an electric motor (e.g., direct current (DC) brushed/brushless or alternating current (AC) motors), a hydraulic motor or a hand rotation power. A rotation of the worm gear in turn can drive a rotation of the worm wheel by an engagement between the worm gear and a worm wheel. An external unit or load can be coupled to and driven by the worm wheel. An amplified rotary output torque can drive the external unit or load with a reduced speed of rotation. The output torque of the slew drive can be the value of the input torque multiplied by the worm gear mesh ratio less the drive efficiency losses.

The output torque can be from about 2 kN-m to about 10 kN-m. The output torque can be from about 2 kN-m to about 3 kN-m, about 2 kN-m to about 4 kN-m, about 2 kN-m to about 5 kN-m, about 2 kN-m to about 6 kN-m, about 2 kN-m to about 7 kN-m, about 2 kN-m to about 8 kN-m, about 2 kN-m to about 9 kN-m, about 2 kN-m to about 10 kN-m, about 3 kN-m to about 4 kN-m, about 3 kN-m to about 5 kN-m, about 3 kN-m to about 6 kN-m, about 3 kN-m to about 7 kN-m, about 3 kN-m to about 8 kN-m, about 3 kN-m to about 9 kN-m, about 3 kN-m to about 10 kN-m, about 4 kN-m to about 5 kN-m, about 4 kN-m to about 6 kN-m, about 4 kN-m to about 7 kN-m, about 4 kN-m to about 8 kN-m, about 4 kN-m to about 9 kN-m, about 4 kN-m to about 10 kN-m, about 5 kN-m to about 6 kN-m, about 5 kN-m to about 7 kN-m, about 5 kN-m to about 8 kN-m, about 5 kN-m to about 9 kN-m, about 5 kN-m to about 10 kN-m, about 6 kN-m to about 7 kN-m, about 6 kN-m to about 8 kN-m, about 6 kN-m to about 9 kN-m, about 6 kN-m to about 10 kN-m, about 7 kN-m to about 8 kN-m, about 7 kN-m to about 9 kN-m, about 7 kN-m to about 10 kN-m, about 8 kN-m to about 9 kN-m, about 8 kN-m to about 10 kN-m, or about 9 kN-m to about 10 kN-m. The output torque can be about 2 kN-m, about 3 kN-m, about 4 kN-m, about 5 kN-m, about 6 kN-m, about 7 kN-m, about 8 kN-m, about 9 kN-m, or about 10 kN-m. The output torque can be at least about 2 kN-m, about 3 kN-m, about 4 kN-m, about 5 kN-m, about 6 kN-m, about 7 kN-m, about 8 kN-m, or about 9 kN-m. The output torque can be at most about 3 kN-m, about 4 kN-m, about 5 kN-m, about 6 kN-m, about 7 kN-m, about 8 kN-m, about 9 kN-m, or about 10 kN-m.

In some cases, the torque values described above may be for the slew drive alone or for a net system of a slew drive with its motor.

In some cases, the motor torque alone can be different. The motor torque can be about 100 N-m to about 250 N-m. The motor torque can be about 100 N-m to about 125 N-m, about 100 N-m to about 150 N-m, about 100 N-m to about 175 N-m, about 100 N-m to about 200 N-m, about 100 N-m to about 225 N-m, about 100 N-m to about 250 N-m, about 125 N-m to about 150 N-m, about 125 N-m to about 175 N-m, about 125 N-m to about 200 N-m, about 125 N-m to about 225 N-m, about 125 N-m to about 250 N-m, about 150 N-m to about 175 N-m, about 150 N-m to about 200 N-m, about 150 N-m to about 225 N-m, about 150 N-m to about 250 N-m, about 175 N-m to about 200 N-m, about 175 N-m to about 225 N-m, about 175 N-m to about 250 N-m, about 200 N-m to about 225 N-m, about 200 N-m to about 250 N-m, or about 225 N-m to about 250 N-m. The motor torque can be about 100 N-m, about 125 N-m, about 150 N-m, about 175 N-m, about 200 N-m, about 225 N-m, or about 250 N-m. The motor torque can be at least about 100 N-m, about 125 N-m, about 150 N-m, about 175 N-m, about 200 N-m, or about 225 N-m. The motor torque can be at most about 125 N-m, about 150 N-m, about 175 N-m, about 200 N-m, about 225 N-m, or about 250 N-m.

### Application of a Torque Sensor

A torque sensor as described above may be applied to the slew drive system in a number of ways. In some cases, the torque sensor can comprise a strain gauge sensor. In some cases, the torque sensor can be applied through adhesive methods. In some cases, the sensor can be applied through a sensor carrier. In some cases, the location of the sensor can be similar across different attachment mechanisms. In some cases, the location of the sensor can be different across different attachment mechanisms. In some cases, the sensor can be located at the distal end cap of the slew drive system.

The torque sensor can measure slew drive system actuator health and performance, which can reduce service costs and maximize production. In some cases, the torque sensor can be a partly or fully automatic “smart” torque sensor. In some cases, the smart torque sensor can control and/or analyze the input of a strain gauge sensor. The torque sensor can be a closed-loop system that operates locally and autonomously at the slew drive actuator controller. It can decrease the cost and time employed in reviewing and analyzing Supervisory Control and Data Acquisition (SCADA). When the smart torque sensor detects a fault or issue, it may automatically protect the tracker row and alert the SCADA platform that a fault has occurred.

In some cases, when the torque sensor detects a fault or issue, it may issue an alert by notifying a computer coupled to the sensor or to a separate system. For example, sensor analog data can be sent to a digital circuit board in the enclosure (described below) and then transferred to the computer system coupled to the slew drive system. The torque sensor can be connected to adjacent computing devices with an open RS485 channel. The torque sensor may have a controller that interfaces with other controllers. In some cases, a human overseer of the slew drive system may view an amalgamation of hundreds or thousands of controllers. In some cases, a human overseer of the slew drive system may view a single controller, such that there may be a 1-to-1 ratio of human overseer to device and controller. This can depend on the manufacturing setting.

A torque sensor can be coupled to a deformation element. In some cases, deformation of a deformation element can result from a worm gear or worm interface pin impinging on the sensor, sensor carrier, or other deformation element (e.g., as a result of displacement of the worm gear in an axial direction “z” of the worm gear). In some cases, deformation of a deformation element can be measured or detected by a sensor (e.g., a strain gauge sensor). In some embodiments, the magnitude and/or rate (e.g., over time) of a measured or detected deformation of a deformation element can be used to calculate a displacement of a worm gear (e.g., in an axial direction “z” of the worm gear) and/or a rotation or torque of a worm wheel (e.g., around an axial direction “x” of the worm wheel) with precision. This can be measured by a torque sensor. As such, a torque sensor and a strain gauge sensor can be used to measure similar characteristics.

As discussed above, signals from a strain gauge sensor can be transmitted to a controller for processing and/or analysis via wired or wireless connection. In some cases, a controller (e.g., an “internal” controller) of a slew drive system is “on board” or “local” relative to one or more mechanical components of the slew drive mechanism (e.g., physically coupled to or affixed to one or more components within or directly coupled to the slew drive housing or any of the slew drive plates, plugs, or end caps). For example, a controller can be coupled to (e.g., fastened to) a central area of the slew drive housing. In some cases, a controller (e.g., an external controller) is “remote” relative to one or more mechanical components of the slew drive mechanism (e.g., not housed within (or in some cases coupled to) the slew drive housing or any of the slew drive plates, plugs, or end caps). For example, an external controller can be wirelessly connected to one or more “on board” or “local” sensors of the slew drive system. In some cases, an “on board” controller can be connected (e.g., via a wired or wireless connection) to an external controller.

An actuator motor current may only sense loads when the motor is operating, which can often be less than 2% of the time. As such, 98% of the time, functionality is left undetected. Additionally, currents may fluctuate to combat normal wind loading, which may make it difficult to differentiate a real fault from normal operation. In contrast, the torque sensor can run continuously. The torque sensor also measures direct torque and stresses on the drive, which can decrease or eliminate outside interference such as wind loading. The torque sensor can also directly measure strain on the drive housing, which in turn can be directly correlated with the torque on the slew drive and stresses within the system. The torque sensor can identify when the loads exceed a structure's design limits by measuring strain on the slew drive.

In some cases, the data frequency of the torque sensor may be greater than about 5 Hz, 10 Hz, 15 Hz, 20 Hz, 25 Hz, or 30 Hz. The data frequency may be less than about 30 Hz, 25 Hz, 20 Hz, 15 Hz, 10 Hz, or 5 Hz. Although the sensing element (e.g., the strain gauge) can be polled at nearly an infinitely high frequency limited by the capabilities of the microprocessor polling it, it may be polled at a lower frequency to minimize power consumption and to limit effects of self-heating on the strain gauge.

BHT (backwards holding torque) can comprise a static limit of drive in a given arrangement. For example, the BHT can comprise the amount of torque that may be statically held by a system without system failure. Above BHT, and approaching BHT, the chance of failure can increase. 100% of BHT may cause damage or destruction of a device or system. A separate sensor can be used to determine how close a given torque strain is to approaching BHT. In some cases, the torque range may be about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 99%, or 100% of the BHT of the slew drive. In some cases, the torque range may be from about 1% to about 90%. In some cases, the torque range may be from about 1% to about 5%, about 1% to about 10%, about 1% to about 15%, about 1% to about 20%, about 1% to about 30%, about 1% to about 40%, about 1% to about 50%, about 1% to about 60%, about 1% to about 70%, about 1% to about 80%, about 1% to about 90%, about 5% to about 10%, about 5% to about 15%, about 5% to about 20%, about 5% to about 30%, about 5% to about 40%, about 5% to about 50%, about 5% to about 60%, about 5% to about 70%, about 5% to about 80%, about 5% to about 90%, about 10% to about 15%, about 10% to about 20%, about 10% to about 30%, about 10% to about 40%, about 10% to about 50%, about 10% to about 60%, about 10% to about 70%, about 10% to about 80%, about 10% to about 90%, about 15% to about 20%, about 15% to about 30%, about 15% to about 40%, about 15% to about 50%, about 15% to about 60%, about 15% to about 70%, about 15% to about 80%, about 15% to about 90%, about 20% to about 30%, about 20% to about 40%, about 20% to about 50%, about 20% to about 60%, about 20% to about 70%, about 20% to about 80%, about 20% to about 90%, about 30% to about 40%, about 30% to about 50%, about 30% to about 60%, about 30% to about 70%, about 30% to about 80%, about 30% to about 90%, about 40% to about 50%, about 40% to about 60%, about 40% to about 70%, about 40% to about 80%, about 40% to about 90%, about 50% to about 60%, about 50% to about 70%, about 50% to about 80%, about 50% to about 90%, about 60% to about 70%, about 60% to about 80%, about 60% to about 90%, about 70% to about 80%, about 70% to about 90%, or about 80% to about 90%. In some cases, the torque range may be about 1%, about 5%, about 10%, about 15%, about 20%, about 30%, about 40%, about 50%, about 60%, about 70%, about 80%, or about 90%. In some cases, the torque range may be at least about 1%, about 5%, about 10%, about 15%, about 20%, about 30%, about 40%, about 50%, about 60%, about 70%, or about 80%. In some cases, the torque range may be at most about 5%, about 10%, about 15%, about 20%, about 30%, about 40%, about 50%, about 60%, about 70%, about 80%, or about 90%.

In some cases, the torque range may be between about 50% to about 60% of BHT. In some cases, the torque range may be from about 40% to about 60%. In some cases, the torque range may be from about 40% to about 42%, about 40% to about 44%, about 40% to about 46%, about 40% to about 48%, about 40% to about 50%, about 40% to about 52%, about 40% to about 54%, about 40% to about 56%, about 40% to about 58%, about 40% to about 60%, about 42% to about 44%, about 42% to about 46%, about 42% to about 48%, about 42% to about 50%, about 42% to about 52%, about 42% to about 54%, about 42% to about 56%, about 42% to about 58%, about 42% to about 60%, about 44% to about 46%, about 44% to about 48%, about 44% to about 50%, about 44% to about 52%, about 44% to about 54%, about 44% to about 56%, about 44% to about 58%, about 44% to about 60%, about 46% to about 48%, about 46% to about 50%, about 46% to about 52%, about 46% to about 54%, about 46% to about 56%, about 46% to about 58%, about 46% to about 60%, about 48% to about 50%, about 48% to about 52%, about 48% to about 54%, about 48% to about 56%, about 48% to about 58%, about 48% to about 60%, about 50% to about 52%, about 50% to about 54%, about 50% to about 56%, about 50% to about 58%, about 50% to about 60%, about 52% to about 54%, about 52% to about 56%, about 52% to about 58%, about 52% to about 60%, about 54% to about 56%, about 54% to about 58%, about 54% to about 60%, about 56% to about 58%, about 56% to about 60%, or about 58% to about 60%. In some cases, the torque range may be about 40%, about 42%, about 44%, about 46%, about 48%, about 50%, about 52%, about 54%, about 56%, about 58%, or about 60%. In some cases, the torque range may be at least about 40%, about 42%, about 44%, about 46%, about 48%, about 50%, about 52%, about 54%, about 56%, or about 58%. In some cases, the torque range may be at most about 42%, about 44%, about 46%, about 48%, about 50%, about 52%, about 54%, about 56%, about 58%, or about 60%.

The specific torque range notwithstanding, the sensor itself can, and may be specifically configured for, sensing the full 0% to 100% range of BHT. While the drive itself may experience permanent damage before the BHT limit, these damages may not affect the sensor's ability to measure torque.

The sensor can sense different functional ranges of BHT. From a BHT of 0% to about 20%, the sensor can sense the dynamic range of the drive (e.g., the amount of torque that can be turned by the motor). From a BHT of 0% to about 60%, the sensor can sense the functional range of the drive before permanent damage occurs. For BHTs greater than about 60%, the sensor can sense the damaging torque. This may be beneficial to sense for warranty purposes, asset monitoring, maintenance indicators, and other purposes.

The torque sensor may use a RS-485 communication system. The operating voltage can be 9-40 VDC. The working current can be less than about 10 mA at about 24 VDC. The working current can vary with frequency. The electrical life of the torque sensor can be greater than 10,000 hours, 20,000 hours, 50,000 hours, 75,000 hours, 100,000 hours, 125,000 hours, 150,000 hours, 175,000 hours, 200,000 hours, 225,000 hours, or greater than 250,000 hours. This can allow for longevity of use alongside a longer-lived slew drive. This longevity can be used alongside tracker controllers with greater than 20, 25, or 30 year lifespans.

The electrical life of the torque sensor can be less than 10,000 hours, 20,000 hours, 50,000 hours, 75,000 hours, 100,000 hours, or 125,000 hours. There may be value in shorter-life, low cost, disposable sensors. Shorter-life sensors can attach to shorter-life slew drives which may be designed to be replaced or undergo significant maintenance after a relatively short period of time. Shorter life sensors can also be used such that their replacement or maintenance interval aligns with other tracker maintenance intervals such as, but not limited to, battery changes on the tracker controller. Shorter-life sensors may also comprise self-powered sensors that may be non-functional once the energy source is depleted. This can be beneficial in early life structure analysis or tracker analysis.

The torque sensor can have a protection enclosure rating of IP65 or greater. The torque sensor can have a protection enclosure rating of at least IP65, IP66, IP67, IP68, or IP69.The operating temperature can be from about −50 C to about 100 C. The operating temperature can be from about −40 C to about 85 C. The operating temperature can be from about −40 C to about −20 C, about −40 C to about 0 C, about −40 C to about 20 C, about −40 C to about 40 C, about −40 C to about 60 C, about −40 C to about 85 C, about −20 C to about 0 C, about −20 C to about 20 C, about −20 C to about 40 C, about −20 C to about 60 C, about −20 C to about 85 C, about 0 C to about 20 C, about 0 C to about 40 C, about 0 C to about 60 C, about 0 C to about 85 C, about 20C to about 40 C, about 20 C to about 60 C, about 20 C to about 85 C, about 40 C to about 60 C, about 40 C to about 85 C, or about 60 C to about 85 C. The operating temperature can be about −40 C, about −20 C, about 0 C, about 20 C, about 40 C, about 60 C, or about 85 C. The operating temperature can be at least about −40 C, about −20 C, about 0 C, about 20 C, about 40 C, or about 60 C. The operating temperature can be at most about −20 C, about 0 C, about 20 C, about 40 C, about 60 C, or about 85 C.

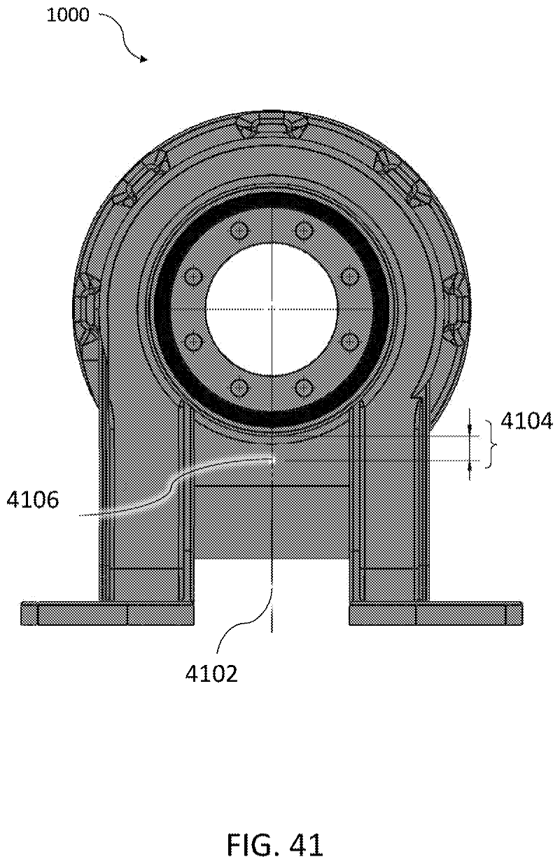

In some cases, the sensors, including but not limited to the strain gauge sensor, can be attached to a long side of the slew drive on the flat portion of the housing (see 4106 of FIG. 41). In some cases, the housing can comprise a single piece, two pieces, three pieces, or more than three pieces. In some cases, the housing can comprise a single piece that covers the bearing, the worm wheel, and the worm gear shaft. In some cases, the housing can comprise two pieces with a cover plate for the worm wheel and a separate one for the worm gear shaft. In some cases, the housing can comprise two pieces for the worm wheel (e.g., one for the top approximately half of the wheel and one for the bottom approximately half of the wheel). In some cases, for example, when the housing comprises two pieces for the worm wheel, the housing can comprise a third piece for the worm gear shaft. In some cases, the housing can comprise multiple soldered, welded, ironed, adhered, or otherwise coupled sections of housing. At least one of those sections can cover the worm wheel and another can cover the worm gear shaft. The long side can be the rear or the front of the slew drive. The sensors can be located at approximately the centerline 4102 of the slew drive along the X-axis. The sensors can be located at approximately the centerline 4102 of the worm gear shaft and worm wheel along the X-axis.

Centering the sensors and sensor carrier can have multiple benefits. Centering can reduce assembly complexity. It can be a single piece that is spot welded to the drive. This can be a simple manual process that can also be fully automated, decreasing the chance for a faulty sensor installation or variation in signal due to human error.

Centering the sensors and sensor carrier also helps with direct measurement of forces on the slew drive. When located off-center, the sensors can measure deflection of the worm as a proxy for torque on the slew drive. The centered concept can measure actual strain on the drive housing, offering a more direct measurement of torque on the drive.

Centering the sensors and sensor carrier can help with the sensor signal's relation to temperature. When centered, there may be little or no change in sensor signal due to temperature. This can improve signal quality and also decrease the frequency or benefits of temperature testing on the unit to determine a ‘temperature compensation factor’ to determine actual signal from measured signal.

Centering the sensors and sensor carrier can help with the sensor's ability to equally measure forces on the drive in both clockwise and counterclockwise rotation directions. Centering can lend itself to increased accuracy and potentially decreased requirements for system calibration and testing. Testing time can decrease by at least 10%, at least 20%, at least 30%, at least 40%, or at least 50%.

Locating the sensors off-center can be appropriate for devices comprising a removable end cap or threaded plug. The centered sensors on the side of the housing can be applied regardless of slew drive type.

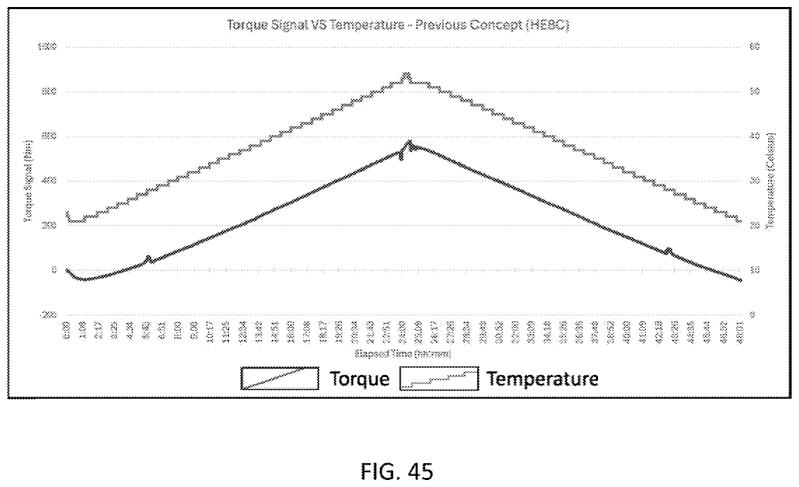

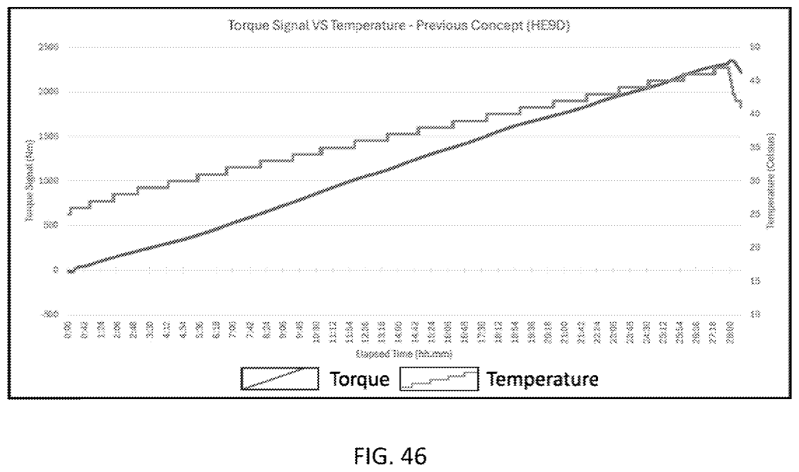

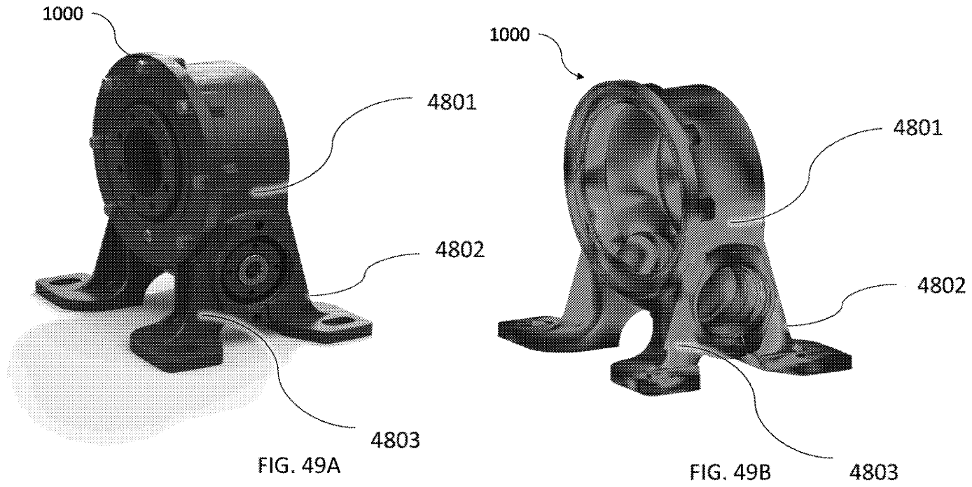

Locating the sensors in high-stress areas on the drive housing (FIG. 49B at 4801, 4802, 4803) can diminish the relationship observed between torque and drive temperature (FIGS. 45-46). By diminishing this relationship, the costly temperature tests on each drive can be done less frequently or not at all. In some cases, the temperature correlation can be non-existent or small enough to the point it falls into an acceptable margin of error, in which case temperature testing can be eliminated.

There can be more flexibility in the vertical location of the sensors and sensor carrier. The sensors can be located at from about 10 mm to about 20 mm below the circular face of the housing along the Y-axis of the slew drive, as shown by 4104. The sensors can be located at from about 10 mm to about 12 mm, about 10 mm to about 15 mm, about 10 mm to about 18 mm, about 10 mm to about 20 mm, about 12 mm to about 15 mm, about 12 mm to about 18 mm, about 12 mm to about 20 mm, about 15 mm to about 18 mm, about 15 mm to about 20 mm, or about 18 mm to about 20 mm below the circular face of the housing. The sensors can be located at about 10 mm, about 12 mm, about 15 mm, about 18 mm, or about 20 mm below the circular face of the housing. The sensors can be located at least about 10 mm, about 12 mm, about 15 mm, or about 18 mm below the circular face of the housing. The sensors can be located at most about 12 mm, about 15 mm, about 18 mm, or about 20 mm below the circular face of the housing in the Y-axis. The exact location in the Y-direction may change depending on the slew drive model.

In some cases, misalignment or variation in sensor placement can change the results of the signal output. In some cases, a variation of a few millimeters or a variation of a few degrees off of the vertical may result in a variation in signal on the order of 100 s of newton-meters. However, with modifications to the drive housing to include alignment features, the sensor placement can be consistent enough such that this variation may not be a major factor in the overall sensor accuracy.

### Sensor Adhesion

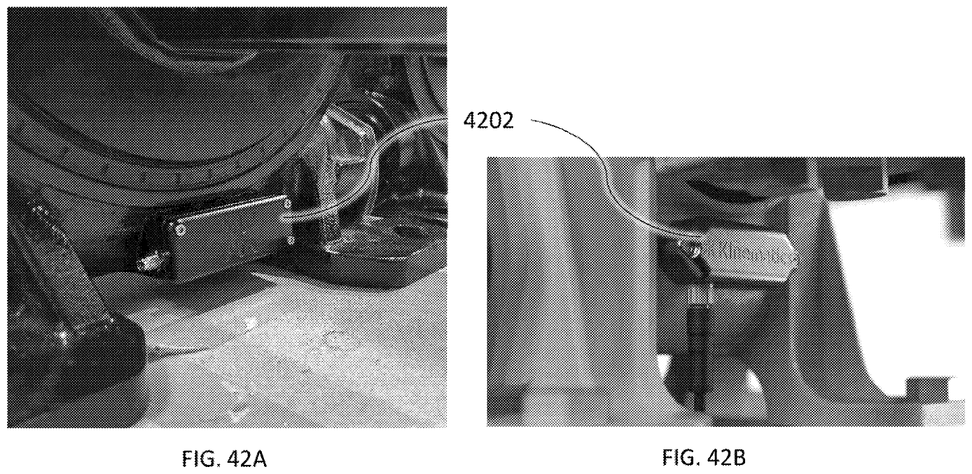

The sensors (e.g., strain gauge sensors) can be coupled to the slew drive system via adherence. The surface of the intended location of the sensors (approximately at the center line and about 10 mm to about 20 mm below the slew drive, as discussed above) can be prepared. The sensor (e.g., strain gauge) can be applied with adhesive. The strain gauge can be routed into a small circuit board which may be protected by a small enclosure 4202 directly connected to the slew drive, as shown in FIG. 42.

In some cases, the adhesive used can be epoxy adhesives. The epoxy can be water-based, solvent-based, or solids-based. In some cases, it can comprise a multi-part mixture. In some cases, it can comprise a 2-part mixture. In some cases, it can comprise a 1-part mixture comprising phenolic resin. The mixture can be cured under heat and pressure. The epoxy adhesive can have a number of advantageous properties. It can have a wide temperature range between about −196 C to about 250 C. It can be usable for high strains of 6%. There can be flexibility in the specific adhesives used and exact adhesive properties may vary to accommodate lower cost, higher performance, availability in country of sensor assembly, etc.

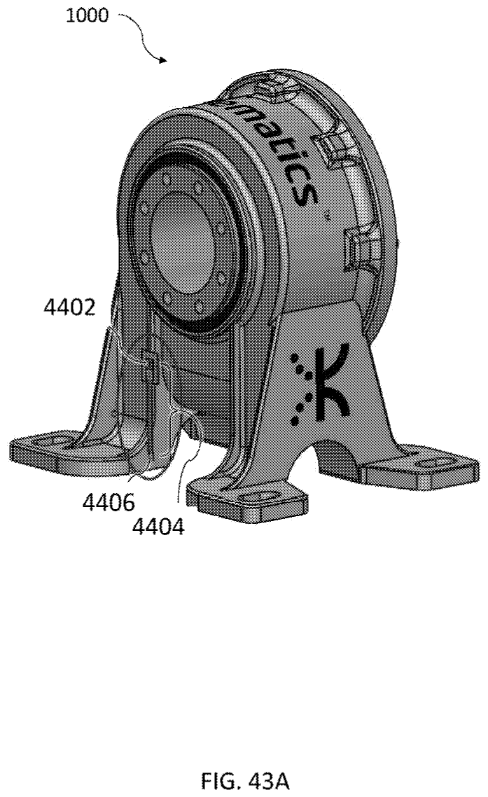

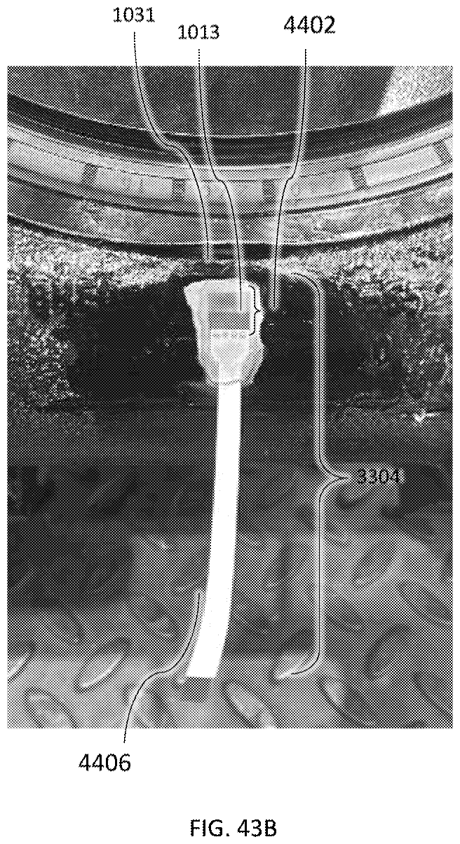

In some cases, the adhesive method of applying the sensor can be considered to have a sensor carrier. The enclosure 4202 can be the sensor carrier if the sensor and the deformation element are inside the enclosure or if the enclosure 4202 itself comprises the sensor carrier. The enclosure can enclose the entirety of 4304 in FIG. 43B. In some cases, enclosure 4202 can enclose the flex cable 4306. In some cases, the enclosure can comprise anodized aluminum or other materials based on environmental factors and cost restrictions. In some cases, the enclosure can comprise other metallic derivatives (e.g., stainless steel, other aluminums, ductile iron, etc.). Some metals or metallic derivatives may lend additional benefits such as one or more of the ability to easily weld or bond the enclosure to the slew drive, visual compatibility between the enclosure and slew drive, or the ability to have the slew drive itself act as a part of the enclosure. In the latter case, having the same material between the enclosure and the slew drive may be beneficial for manufacturing, bonding, weathering, and other purposes. In some cases, the silicone RTV encapsulant used to protect the sensor carrier may be construed as the enclosure. For example, in a low-cost version of the sensor carrier, it may be possible to remove the enclosure altogether and just have the silicone RTV act as the enclosure. In some cases, the silicone RTV may enclose the sensor carrier or it may enclose both the sensor carrier and the PCB.

In some cases, the epoxy substrate itself may be construed as a sensor carrier. Any portion of the epoxy substrate which can allow for deformation or flexing may be construed as a deformation element as described above.

### Sensor Carrier

Slew drive sensors, including but not limited to torque sensors, can be delicate. They may benefit from protection from the weather when in an external location, such as centered on the worm gear shaft. The sensors can be protected via a carrier. The sensors (e.g., strain gauge sensors) can be coupled to the slew drive system via a sensor carrier. The strain gauge can be applied to a thin metal “carrier.” The strain gauge can be welded to a thin metal carrier. The strain gauge can be soldered to a thin metal carrier. The carrier material can comprise stainless steel. The carrier can be welded to the slew drive housing in the same physical location as the adhesive attached gauge (see FIG. 41). This may be a faster manufacturing process than the adhesive process described above. Welding methods can improve manufacturability and have negligible differentiation of function relative to adhesive-bonding methods. Welding the sensor carrier to the slew drive can allow for sensor scalability in production. Welding methods can be more repeatable and more reliable than adhesive-based attachments. Welding can be done with less-skilled labor. Welding can allow for less yield loss, as adhesive-bonded gauges may result in more damaged or destroyed sensors due to their delicate nature when trying to adhere to the drive. Welding can also enable the use of more reliable and long-lasting heat cure adhesives to bond the sensor to the carrier since the small carriers can more easily be cured in ovens and temp chambers whereas the slew drives may be large and carry significant thermal mass. The slew drives may thus be more difficult to use heat cure adhesives on. In some cases, the carrier metal can comprise Inconel (e.g., Inconel 600). In some cases, the strain gauge may be adhered to the metal carrier similarly to the method described above.

A width of the carrier may be from about 10 mm to about 30 mm. A width of the carrier may be from about 10 mm to about 15 mm, about 10 mm to about 20 mm, about 10 mm to about 25 mm, about 10 mm to about 30 mm, about 15 mm to about 20 mm, about 15 mm to about 25 mm, about 15 mm to about 30 mm, about 20 mm to about 25 mm, about 20 mm to about 30 mm, or about 25 mm to about 30 mm. A width of the carrier may be about 10 mm, about 15 mm, about 20 mm, about 25 mm, or about 30 mm. A width of the carrier may be at least about 10 mm, about 15 mm, about 20 mm, or about 25 mm. A width of the carrier may be at most about 15 mm, about 20 mm, about 25 mm, or about 30 mm.

A length of the carrier may be from about 10 mm to about 30 mm. A length of the carrier may be from about 10 mm to about 15 mm, about 10 mm to about 20 mm, about 10 mm to about 25 mm, about 10 mm to about 30 mm, about 15 mm to about 20 mm, about 15 mm to about 25 mm, about 15 mm to about 30 mm, about 20 mm to about 25 mm, about 20 mm to about 30 mm, or about 25 mm to about 30 mm. A length of the carrier may be about 10 mm, about 15 mm, about 20 mm, about 25 mm, or about 30 mm. A length of the carrier may be at least about 10 mm, about 15 mm, about 20 mm, or about 25 mm. A length of the carrier may be at most about 15 mm, about 20 mm, about 25 mm, or about 30 mm.

In some cases, the carrier's dimensions may be about 20 mm×25 mm. However, the dimensions of the carrier may vary to accommodate different designs. The thickness of the carrier can be about 5 thou (0.005″). The thickness of the carrier may change depending on welding method (e.g., laser welding may use a thicker or thinner carrier).

In some cases, the type of welds may be spot welds, such as from a capacitive discharge welder. The welder may use 20 Watt-seconds (Ws) weld energy. The welder may use 30 Watt-seconds (Ws) weld energy. The welder may use from about 10 Ws to about 40 Ws weld energy. The welder may use from about 10 Ws to about 15 Ws, about 10 Ws to about 20 Ws, about 10 Ws to about 25 Ws, about 10 Ws to about 30 Ws, about 10 Ws to about 35 Ws, about 10 Ws to about 40 Ws, about 15 Ws to about 20 Ws, about 15 Ws to about 25 Ws, about 15 Ws to about 30 Ws, about 15 Ws to about 35 Ws, about 15 Ws to about 40 Ws, about 20 Ws to about 25 Ws, about 20 Ws to about 30 Ws, about 20 Ws to about 35 Ws, about 20 Ws to about 40 Ws, about 25 Ws to about 30 Ws, about 25 Ws to about 35 Ws, about 25 Ws to about 40 Ws, about 30 Ws to about 35 Ws, about 30 Ws to about 40 Ws, or about 35 Ws to about 40 Ws weld energy. The welder may use about 10 Ws, about 15 Ws, about 20 Ws, about 25 Ws, about 30 Ws, about 35 Ws, or about 40 Ws weld energy. The welder may use at least about 10 Ws, about 15 Ws, about 20 Ws, about 25 Ws, about 30 Ws, or about 35 Ws weld energy. The welder may use at most about 15 Ws, about 20 Ws, about 25 Ws, about 30 Ws, about 35 Ws, or about 40 Ws weld energy. In some cases, laser welding may be used. The weld energy may differ in laser welding. This may be a CNC (Computer Numerical Control) laser welder where a machine performs the welding for fast, strong, and highly repeatable welds.

During routing, a flexible printed circuit (FPC) can be soldered to the strain gauge pads. In some cases, rather than soldering, other methods can be used to attach the FPC to the strain gauge pads, including but not limited to conductive epoxy, pins (e.g., metal pins), welding, or any other coupling method. Silicone RTV can be used to secure the FPC to the carrier and provide strain relief and environmental protection. In some cases, part of the FPC can be in electrical contact with the metal carrier. In some cases, no part of the FPC is in electrical contact with the metal carrier, although a grounding pad on the FPC may be implemented. This can be a metal pad on the FPC that is welded or soldered directly to the carrier and may function as a circuit ground to the printed circuit board (PCB) and the FPC shield layer. In some cases, an alternate electrical connection can be used such as, but not limited to, one or more of ribbon cable, multi-conductor cable, or flat flexible cable (FFC).

In some cases, one or more sensors can be coupled to a sensor carrier by one or more fasteners. Fasteners can include a screw, a rivet, a grommet a hook, a threaded nut (and, optionally, a nut), a pin, a nail, a latch, a clamp, a staple, a strap or tie, a tape, a clamp, a button, a flange, a retainer such as a retaining ring, or a biasing element such as a clip.

FIGS. 43A-43B show the sensor disposed on the slew drive. FIG. 43A shows the location of the sensor with respect to the entire slew drive 100. FIG. 43B shows an expanded view of the same. The sensor can be located on the end wall of slew drive housing over gear shaft 1031 and sensor carrier system 4304 comprising sensors 1013, epoxy 4302, and deformation element 4306. In some cases, the sensors 1013 or sensors and epoxy 4302 can be encapsulated with an encapsulant covering. In some cases, epoxy 4302 can be located below the sensors. In some cases, silicone can be located above the sensors. The encapsulant can comprise silicone (e.g., silicone RTV). The deformation element 4306 can comprise a cantilevered deformation element. The deformation element 4306 can comprise a non-cantilevered deformation element. The non-cantilevered deformation element can be attached directly to the body of the slew drive and measure the strain on the body. The sensor carrier system 4304 can comprise a frame. To install the torque sensor, a cavity can be opened in the housing of the slew drive. In some cases, the deformation element 4306 can comprise a cable (e.g., a flex cable or a flexible printed circuit (FPC) cable). The flex cable can be mounted to a sensor. The cable 4306 can be soldered to the strain gauge via one or more solder pads. The cable 4306 can be soldered to the strain gauge via four solder pads. On the other end, the cable 4306 can be coupled to the printed circuit board (PCB) of the controller. The cable 4306 can be coupled to the PCB via a zero insertion force (ZIF) connector for easy insertion. In some cases, the cable 4306 can comprise polyamide.

The slew drive can be machined or cast in such a way that the sensor location is already built into the drive and the carrier can simply be placed into a recessed pocket, making placement and alignment of the sensor quick, easy, and precise. The consistency in placement of the sensor may therefore be determined by the limitations of the machining or casting tolerances on the drive.

### Alternative Locations of the Torque Sensor

In addition to sensors located within the worm gear shaft or centered on the outside of the worm gear shaft as described above, a torque sensor may alternatively, or in addition, be placed on one or both ends of the housing. FIGS. 49A-49B show a perspective view and a finite element analysis of various locations on the ends of the housing where the torque sensor can be located. Finite element analysis can be performed on the drive housing to determine areas of high stress and strain on the drive for possible sensor locations.

In some cases, a torque sensor may be placed on the housing of the worm wheel above and near the shoulder or distal end of the worm gear shaft. In some cases, the torque sensor can be placed on the worm wheel housing on level with the vertical center of the worm wheel. In some cases, the torque sensor can be placed on the worm wheel housing lower than the vertical center of the worm wheel. In some cases, the torque sensor can be placed on the worm wheel housing below the upper edge of the worm gear shaft housing, such that the torque sensor is hidden between the worm wheel housing and the worm gear shaft housing. In some cases, the torque sensor is about 1 inch, about 2 inches, about 3 inches, about 4 inches, about 5 inches, about 6 inches, about 7 inches, about 8 inches, about 9 inches, or about 10 or more inches above the worm gear shaft housing. This location can be represented by 4801.

In some cases, a torque sensor may be placed on one or both legs of the slew drive housing (e.g., the legs that keep the worm gear shaft and worm wheel above the ground). The torque sensors can be placed in line with, below, or above the bottom of the worm gear shaft housing shoulder. The torque sensor can be placed closer to the outside (e.g., further away from the worm wheel), the inside (e.g., closer to the center of the side profile of the worm wheel), or the center of the legs. In some cases, these areas may be near the motor mount. These areas can be high stress or strain areas. These locations can be represented by 4802 and 4803.

When placed near the electric motor, the slew drive system can have geometric colocation of sensor and motor. Both of these devices have electrical elements that can be bundled, which can make manufacturing easier.

In some cases, the sensor can be located in a metal carrier or otherwise attached to these various areas along the housing, such that the housing is coupled to the metal carrier which contains and is coupled to the strain gauge.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers, and also represent an amount close to the stated amount that still performs a desired function or achieves a desired result. The term “about” or “approximately” may mean within an acceptable error range for the particular value, which will depend in part on how the value is measured or determined, e.g., the limitations of the measurement system. For example, the terms “approximately”, “about”, and “substantially” may refer to an amount that is within less than 10% of, within less than 5% of, within less than 1% of, within less than 0.1% of, and within less than 0.01% of the stated amount. For example, “about” may mean within 1 or more than 1 standard deviation, per the practice in the art. Alternatively, “about” may mean a range of up to 20%, up to 10%, up to 5%, or up to 1% of a given value. As used herein, the term “about” a number refers to that number plus or minus 10% of that number. The term “about” a range refers to that range minus 10% of its lowest value and plus 10% of its greatest value. Where particular values are described in the application and claims, unless otherwise stated the term “about” meaning within an acceptable error range for the particular value may be assumed.

As used in the specification and claims, the singular forms “a”, “an” and “the” include plural references unless the context clearly dictates otherwise. For example, the term “a sample” includes a plurality of samples, including mixtures thereof.

The terms “determining,” “measuring,” “evaluating,” “assessing,” “assaying,” and “analyzing” are often used interchangeably herein to refer to forms of measurement. The terms include determining if an element is present or not (for example, detection). These terms can include quantitative, qualitative or quantitative and qualitative determinations. Assessing can be relative or absolute. “Detecting the presence of” can include determining the amount of something present in addition to determining whether it is present or absent depending on the context.

The section headings used herein are for organizational purposes only and are not to be construed as limiting the subject matter described.

### EXAMPLES

### Example 1

### Decreased Wobble Due to Sensor Carrier

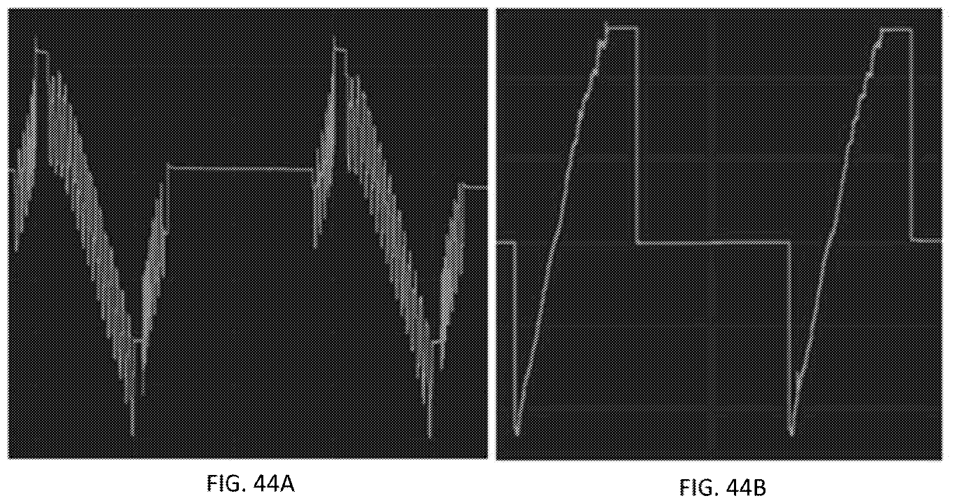

FIGS. 44A-44B show comparative data between a sensor located within the worm gear shaft as in FIG. 4 (FIG. 44A) and a sensor located in a central location on the worm gear shaft as shown in FIGS. 41 and 43A-43B (FIG. 44B).

When located within the worm gear shaft, the sensor experienced worm pin wobble (e.g., torque wobble) in which the sensor signal oscillated based on the worm wheel rotation angle (see FIG. 44A). The sensor was measuring the actual rotational position of the worm. The cantilevered sensor was being pressed upon by the worm interface pin.

In contrast, in FIG. 44B the centralized location on the worm gear shaft mitigated the worm pin wobble. The sensor was adhesive-bonded to the slew drive housing. Additionally, sensors in the location on the worm gear shaft did not suffer from temperature-related signal drift, and therefore may not need testing in an environmental chamber or any software compensation to account for variation in signal due to temperature.

### Example 2

Sensor Location Affects the Relationship between Torque and Temperature

There may exists a relationship between torque from the spinning drive and its temperature. Each drive may have its own unique torque-temperature dependencies, as exemplified by the differing plots for each drive. Revising the placement of the torque sensor can have dramatic impacts on this dependency. FIGS. 45-46 show data recorded from slew drives constructed with the sensor located in the worm gear shaft as in FIG. 4. FIGS. 45-46 show two graphs of torque signal versus temperature. Torque signal was measured in Newton-meters (Nm) on the left vertical axis and temperature was measured in Celsius on the right vertical axis. Elapsed time, in an hour: minute format, is shown on the horizontal axis. As shown in FIG. 45, the curves of the torque and the temperature line (jagged line) were similar, indicating a significant temperature dependency in the sensor signal. However, there was less direct correlation between the torque and temperature lines in FIG. 46. Between each sample during testing, temperature dependency was significantly different and varied by 1000 s of newton-meters. Some slew drives showed almost no temperature dependency, some showed upwards of 2000-3000 Nm of dependency in the torque signal over the temperature range of our testing. This variation can be seen in the differences between FIG. 45 and FIG. 46. Each individual drive may be tested for temperature dependency and calibrated with a compensation factor prior to shipment. This can be a prolonged and difficult process, considering that slew drives have significant thermal mass and use a slow temperature test to properly test which can last a minimum of 12 hours.

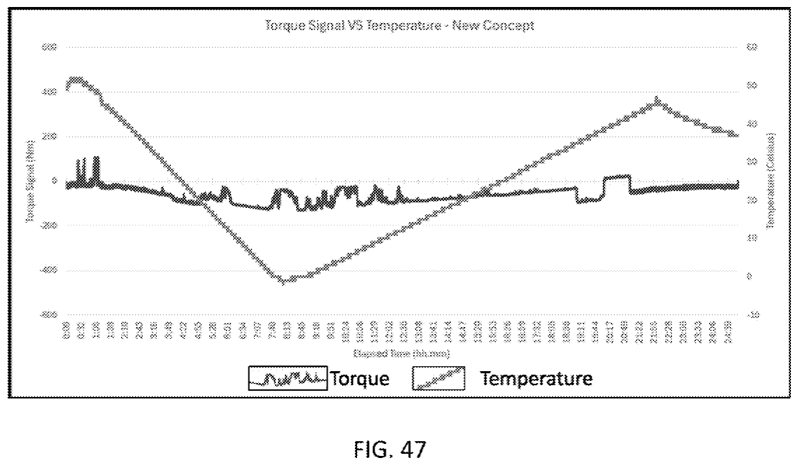

FIG. 47 shows data recorded from slew drives constructed with the torque sensor located in a central location on the outside of the worm gear shaft as in FIG. 41 and FIG. 43A., as shown in FIG. 47. Torque signal was measured in Newton-meters (Nm) on the left vertical axis and temperature was measured in Celsius on the right vertical axis. Elapsed time, in an hour: minute format, is shown on the horizontal axis. Even with temperature variation in both directions (increases and decreases in temperature) shown on the temperature graph (jagged line), the torque graph (solid line) stayed fairly consistent. This indicated that locating the torque sensor in a central location on the outside of the worm gear shaft can have little temperature dependency, which can decrease or eliminate the temperature calibration testing process on each slew drive.

### Example 3

### Strain Hot Spots to Determine Location for Torque Sensor

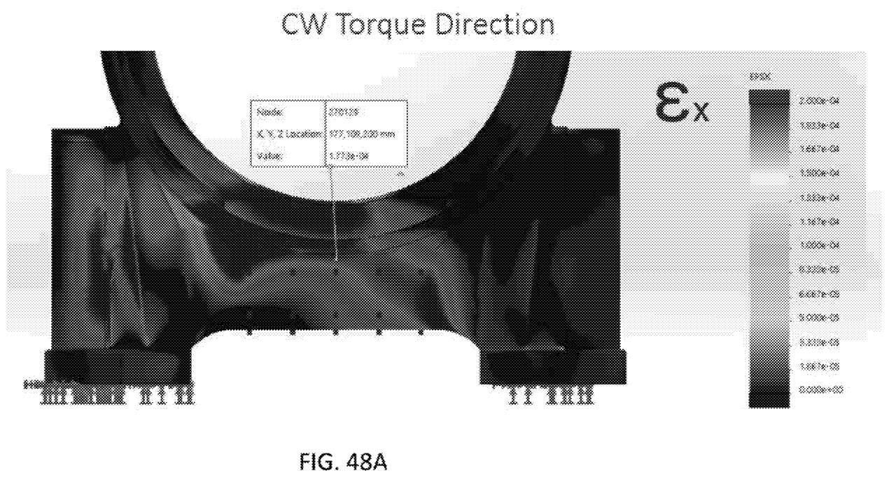

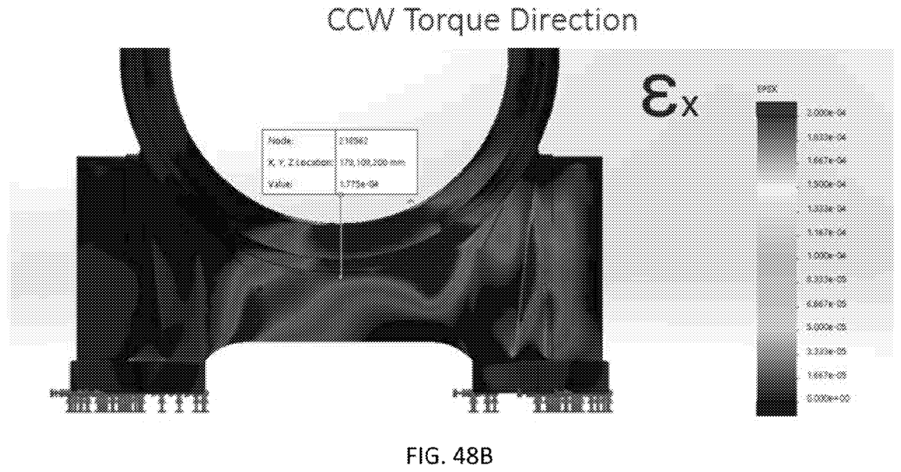

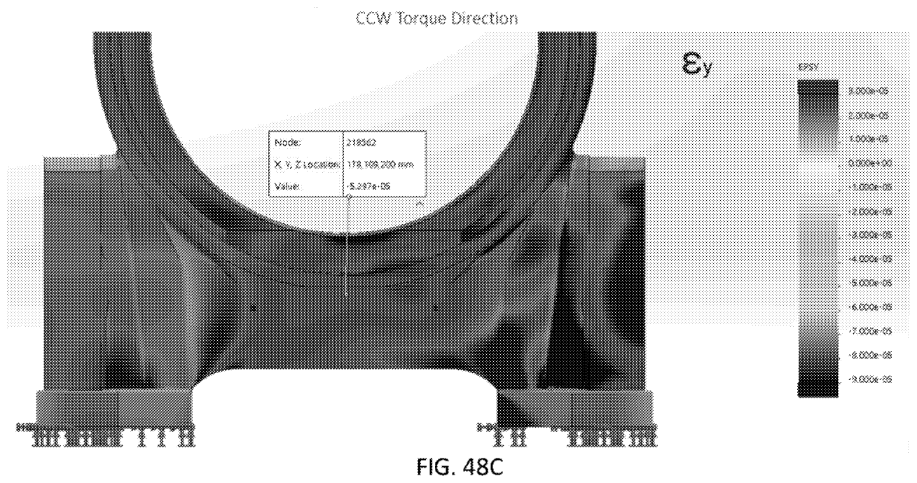

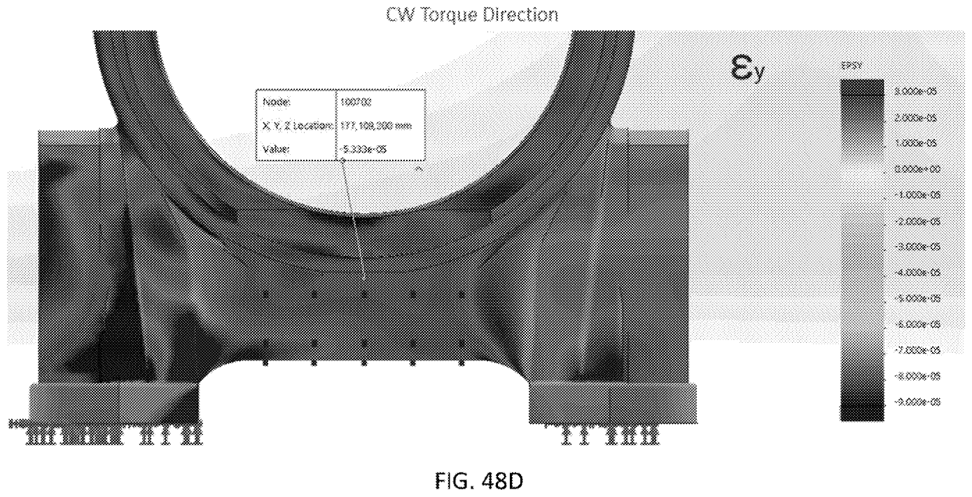

In determining where to place a torque sensor, it can be beneficial to determine locations of high strain on the slew drive when functioning. Tests were run to determine areas of high strain when the worm wheel rotated clockwise and counterclockwise. FIG. 48A shows a finite element analysis of the strain on the slew drive in the X-direction, specifically the drive housing, when the worm wheel was torqued in a clockwise direction. FIG. 48B shows a finite element analysis of the strain on the slew drive in the X-direction, specifically the drive housing, when the worm wheel was torqued in a counterclockwise direction. As can be seen when comparing the two images, the strain coloration is close to a mirror of the other image, with the clockwise torque direction having a higher strain area near the bottom left of the worm wheel and the counterclockwise torque direction having a higher strain area near the bottom right of the worm wheel. It was determined that, between the two figures, the node at approximately 177-178 millimeters in the X-direction, 109 mm in the Y-direction, and 200 mm in the Z-direction captured substantially equivalent strain on the drive housing from both directions of torque. The strain value in FIG. 48A was 1.77e-04, whereas the strain value in FIG. 48B was 1.775 e-04.

FIG. 48C shows a finite element analysis of the strain on the slew drive in the Y-direction, specifically the drive housing, when the worm wheel was torqued in a counterclockwise direction. FIG. 48D shows a finite element analysis of the strain on the slew drive in the Y-direction, specifically the drive housing, when the worm wheel was torqued in a clockwise direction. While the strain magnitude is smaller than the X-direction, it may still be important to consider, because the combination of the X and Y strain directions result in the final sensor signal. There can be consistent and symmetric results between the strain values in the clockwise and counterclockwise rotation directions. This is supported by the strain value at the indicated node at approximately 177-178 millimeters in the X-direction, 109 mm in the Y-direction, and 200 mm in the Z-direction. The strain value in FIG. 48C was −5.297 e-05, whereas the strain value in FIG. 48D was −5.333e-05.

Likewise, FIGS. 49A-49B show alternate hotspots located on the ends of the housing, rather than the central part of the housing. FIG. 49B shows a finite element analysis of the strain on the slew drive with the lighter areas indicated by 4801, 4802, and 4803 being areas of higher strain where the torque sensor may be placed.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations, or equivalents. It is intended that the following claims define the scope of the disclosure and that methods and structures within the scope of these claims and their equivalents be covered thereby.

What is claimed is:

1. An actuation system comprising:
a solar tracker operably coupled to a slew drive, wherein the slew drive is configured to sustain a torque ranging from about 3.5 kN-m to about 40 kN-m without failing or overturning, wherein the slew drive comprises:
a threaded plug;
a housing comprising a first distal housing section and a second distal housing section, wherein the first distal housing section includes a threaded section operative to receive the threaded plug, wherein the second distal housing section includes an oil seal;
a worm gear comprising a central threaded section, a first distal shaft section including a first shoulder, and a second distal shaft section including a second shoulder, wherein the second distal shaft section comprises a bore with internal splines extending longitudinally along the bore, wherein the bore is disposed between the second shoulder and a distal end of the second distal shaft section;
a first bearing seated on the first distal shaft section and abutting the first shoulder and the threaded plug;
a second bearing seated on the second distal shaft section and abutting the second shoulder;
a worm wheel coupled to the solar tracker, wherein the worm wheel comprises worm wheel teeth operative to engage the central threaded section of the worm gear;
whereby upon rotating the threaded plug in engagement with the threaded section, a compressive force is exerted upon the worm gear.

2. An actuation system comprising:
a slew drive that is configured to sustain a torque ranging from about 3.5 kN-m to about 40 kN-m without failing or overturning and further configured to be operably coupled to a component selected from the group consisting of a telecommunication dish, a radar dish, a solar array, and a solar tracker, wherein the slew drive comprises:
a threaded plug;
a housing comprising a first distal housing section and a second distal housing section, wherein the first distal housing section includes a threaded section operative to receive the threaded plug, wherein the second distal housing section includes an oil seal;
a worm gear comprising a central threaded section, a first distal shaft section including a first shoulder, and a second distal shaft section including a second shoulder, wherein the second distal shaft section comprises a bore with internal splines extending longitudinally along the bore, wherein the bore is disposed between the second shoulder and a distal end of the second distal shaft section;
a first bearing seated on the first distal shaft section and abutting the first shoulder and the threaded plug;
a second bearing seated on the second distal shaft section and abutting the second shoulder;
a worm wheel coupled to the component, wherein the worm wheel comprises worm wheel teeth operative to engage the central threaded section of the worm gear;
whereby upon rotating the threaded plug in engagement with the threaded section, a compressive force is exerted upon the worm gear.

3. The system of claim 2, wherein the slew drive is configured to rotate the component at a speed of 0.05 degrees per second to 0.5 degrees per second.

4. The system of claim 3, wherein the component has a weight ranging from 1 kg to 3,000 kg.

5. The system of claim 2, wherein the component is rotated along a plane that is perpendicular to an axial axis of the worm gear.

6. The system of claim 2, wherein at least one of the first bearing and the second bearing comprises one of a roller bearing or a ball bearing.

7. The system of claim 6, wherein the roller bearing comprises one of a tapered roller bearing, a cylindrical roller bearing, a spherical roller bearing, and a needle roller bearing.

8. The system of claim 6, wherein the ball bearing comprises one of a deep groove ball bearing, an angular ball bearing, and a thrust ball bearing.

9. The system of claim 2, wherein the first bearing is seated on the first distal shaft section via one of a clearance fit, a transition fit, and an interference fit.

10. The system of claim 2, further comprising at least one of thread lock and sealant applied on the threaded section of the first distal housing section.

11. The system of claim 2, further comprising a first wheel ball bearing disposed at a first axial end of the worm wheel, wherein the worm wheel comprises a first race of the first wheel ball bearing and the housing comprises a second race of the first wheel ball bearing.

12. The system of claim 11, further comprising a second wheel ball bearing disposed at a second axial end of the worm wheel, wherein the worm wheel comprises a first race of the second wheel ball bearing and the housing comprises a second race of the second wheel ball bearing.

13. The system of claim 12, wherein the first wheel ball bearing is disposed on a first side of the worm wheel and the second wheel ball bearing is disposed on a second side of the worm wheel.

14. The system of claim 11, wherein the first wheel ball bearing comprises a grease shield.

15. The system of claim 2, wherein the housing comprises a hole configured to receive oil lubricant to lubricate the worm wheel and roller bearings, wherein the hole is located directly below the worm wheel and faces a same direction as a bore of the worm wheel.

16. The system of claim 2, wherein the second distal shaft section further comprises an interior hollow section adjacent to the bore with internal splines, wherein the bore with internal splines comprises a first opening extending to the interior hollow section and a second opening at a distal end of the second distal shaft section.

17. The system of claim 16, wherein the internal splines of the bore do not extend into the interior hollow section.

18. The system of claim 2, wherein the slew drive is configured to support an axial load ranging from about 1 kN to about 30 kN.

19. The system of claim 2, wherein the slew drive is configured to support an axial load greater than about 30 kN and sustain a tilting torque greater than about 3500 N-m.

20. The system of claim 2, wherein one or more of the first bearing or the second bearing are configured to survive an overturning moment ranging from 13.5 kN-m to about 457.5 kN-m.

21. The system of claim 2, wherein one or more of the first bearing or the second bearing have a raceway with a diameter ranging from about 187 mm to about 711 mm.

22. The system of claim 2, wherein one or more of the first bearing or the second bearing have a survivability torque ranging from about 7 kN-m to about 180 kN-m.

23. The system of claim 2, wherein the slew drive is configured to sustain a tilting torque ranging from about 500 N-m to about 3500 N-m.

24. A method comprising:
(a) providing a slew drive that comprises:
a threaded plug;
a housing comprising a first distal housing section and a second distal housing section, wherein the first distal housing section includes a threaded section operative to receive the threaded plug, wherein the second distal housing section includes an oil seal;
a worm gear comprising a central threaded section, a first distal shaft section including a first shoulder, and a second distal shaft section including a second shoulder, wherein the second distal shaft section comprises a bore with internal splines extending longitudinally along the bore, wherein the bore is disposed between the second shoulder and a distal end of the second distal shaft section;
a first bearing seated on the first distal shaft section and abutting the first shoulder and the threaded plug;
a second bearing seated on the second distal shaft section and abutting the second shoulder; and
a worm wheel comprising worm-wheel teeth operative to engage the central threaded section of the worm gear;
wherein the slew drive is configured to sustain a torque ranging from about 3.5 kN-m to about 40 kN-m without failing or overturning;
(b) coupling the worm wheel of the slew drive to the component; and
(c) rotating the threaded plug in engagement with the threaded section to thereby exert a compressive force upon the worm gear.
